(19) United States
(12) Patent Application Publication
(10) Pub. No.: US 2009/0233672 A1
(43) Pub. Date: Sep. 17, 2009

(54) Playing Method of Card Game and Game Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/399,537

(22) Filed: Mar. 6, 2009

Related U.S. Application Data
(60) Provisional application No. 61/034,658, filed on Mar. 7, 2008.
(60) Provisional application No. 61/034,677, filed on Mar. 7, 2008.
(60) Provisional application No. 61/034,725, filed on Mar. 7, 2008.
(60) Provisional application No. 61/035,574, filed on Mar. 11, 2008.

(51) Int. Cl. A63F 9/24; A63F 13/00

(52) U.S. Cl. 463/13; 463/25; 463/30

(57) ABSTRACT

A game machine of the present invention has: a plurality of display devices provided corresponding to respective ones of a plurality of players; and a controller for controlling the display device. The controller is programmed to: execute a basic game; display a predetermined number of player's cards on a first display device corresponding to a first player, from among the plurality of display device, and display a predetermined number of banker's cards on a banker's display device, while in the basic game; execute a process of determining a winner or loser, by comparing hands of the player's cards with hands of the banker's cards, while in the basic game; execute a side game in a case where a predetermined condition is met while in the side game; display a special card on the first display device, the special card being displayed while in the side game performed by a second player on a second display device corresponding to the second player, from among the plurality of display devices, while in the side game; and perform a payout according to a combination of: the player's cards and the banker's cards; and the special card.

This application claims priority of U.S. Provisional Application No. 61/034,658 filed on Mar. 7, 2008, U.S. Provisional Application No. 61/034,677 filed on Mar. 7, 2008, U.S. Provisional Application No. 61/035,574 filed on Mar. 11, 2008, and U.S. Provisional Application No. 61/034,725 filed on Mar. 7, 2008. The contents of these applications are incorporated herein by reference in their entirety.

### BACKGROUND OF THE INVENTION

1. Field of the Invention

The present invention relates to a method of playing card games and a game machine.

2. Description of the Related Art

Conventionally, card games such as poker, blackjack, and baccarat, have been known which a plurality of players enjoy in gaming places such as casinos. These card games are generally performed between players and a dealer actually using betting chips.

The above-mentioned card games include: live-type card games in which players compete against a real dealer; and video-type, table-type card games in which players compete against a virtual dealer displayed on a video display. The video-type card games employs a game system in which the video display device displays an image of the virtual dealer who takes action to deal cards and deliver chips, and then, game programs are processed and implemented, as if card games were performed between each of the players and the real dealer.

For example, US Published Patent Application No. 2005/0035548 discloses a table game system, including: a video display device, which displays a virtual dealer and game cards; and a plurality of player stations provided integrally with a dealer table so as to accept a game start operation such as BET from players and surround the dealer table.

In this game system, the video display device serves to display cards automatically shuffled by a computer while displaying the virtual dealer by way of image, so that a plurality of players at a plurality of player stations perform card games.

The abovementioned conventional game system has been disadvantageous in that the dealer and the plurality of players at the plurality of player stations can perform card games, whereas there is no chance to perform games among the plurality of players. Therefore, a need exists for the advent of gaming methods and machines with new entertainability. The present invention has been made in view of the above-described circumstance. It is an object of the invention to provide a novel gaming method and machine by enhancing the entertainability of card games among the plurality of players.

### SUMMARY OF THE INVENTION

A first aspect of the present invention is a game machine, including: a plurality of first display devices provided corresponding to respective ones of a plurality of players; a second display device provided in common to the plurality of players; and a controller for controlling the first display devices and the second display device, the controller being programmed to: (a) perform a basic game; (b) display a predetermined number of players' cards on the first display devices and a plurality of banker's cards on the second display device, while in the basic game; (c) pay out to a player a payment determined by comparing the players' cards and the banker's cards that are displayed in the step (b), while in the basic game; (d) perform a side game in a case where a predetermined condition is met while in the basic game; (e) display, on the first display devices, the plurality of cards dealt to the plurality of players, and display, on the second display device, the plurality of cards displayed on the first display device and possessed by the respective players, from among plural kinds of cards, while in the side game; and (f) pay out to a player a payment determined by comparing the plurality of cards possessed by the players, the cards being displayed on the first display device, while in the side game.

According to the game machine constituted as set forth above, a plurality of cards dealt to a plurality of players are displayed on a common display device, while in a side game, and a payment is paid out according to a card combination. Therefore, for example, five cards dealt to each of five players are displayed on a common display device, and a payment is paid out to a player who realized the strongest card combination, thus making it possible to enhance entertainability of card games among the plurality of players.

A second aspect of the present invention is the game machine of the first aspect, wherein: the controller is programmed to accept, from the input device, entry of a side BET which is different from a normal BET, and wherein: the controller accepts, from the input device, the entry of the side BET which is different from a normal BET, and pays out a payment to only a player having entered the side BET in the process (f).

According to the game machine constituted as set forth above, a plurality of cards dealt to a plurality of players are displayed on a common display device in a side game, and a payment is paid out to only a player having entered a side BET. Therefore, for example, five cards dealt to each of five players are displayed on a common display device, and a payment is paid out to a player who realized the strongest card combination, from among the players having entered the side BETs, thus making it possible to enhance entertainability of card games among the plurality of players.

A third aspect of the present invention is the game machine of the first aspect, wherein: the controller distributes and pays out a payment among all of the players having entered the side BETs, in the process (f).

According to the game machine constituted as set forth above, a plurality of cards dealt to a plurality of players are displayed on a common display device, while in a side game, and a payment is distributed and paid out among all of the players having entered side BETs. Therefore, for example, five cards dealt to each of five players are displayed on a common display device, and a payment, based upon a card combination, can be distributed among the five players, thus making it possible to enhance entertainability of card games among the plurality of players.

A fourth aspect of the present invention is the game machine of the first aspect, wherein the controller is programmed to: (h) execute a process of determining a player to whom a payment is given, from among the plurality of players; and wherein: the controller, in the process (f), pays out a payment to the player determined in the process (h).

According to the game machine constituted as set forth above, a plurality of cards dealt to a plurality of players are displayed on a common display device, while in a side game, and a player to whom a payment is paid out is determined from among the players having entered side BETs. Therefore, for example, five cards dealt to each of five players are displayed on the common display device, and a player to whom a payment is randomly paid out is determined from among the players having entered the side BETs, thus making it possible to enhance entertainability of card games among the plurality of players.

A fifth aspect of the present invention is a game machine, including: a plurality of first display devices provided corresponding to respective ones of a plurality of players; a second display device provided in common to the plurality of players; and a controller for controlling the first display devices and the second display device, the controller being programmed to: (a) perform a basic game; (b) accept, from the input device, entry of a side BET which is different from a normal BET; (c) display a predetermined number of players' cards on the first display devices and a plurality of banker's cards on the second display device, while in the basic game; (d) pay out to a player a payment determined by comparing the players' cards and the banker's cards that are displayed in the step (b), while in the basic game; (e) perform a side game in a case where a predetermined condition is met while in the basic game; (f) display, on the first display devices, the plurality of cards dealt to the plurality of players, and display, on the second display device, the plurality of cards displayed on the first display device and possessed by the respective players, from among plural kinds of cards, while in the side game; and (g) distribute and payout a payment among all of the pictures having entered the side BET, the payment being determined by comparing the plurality of cards possessed by the players, the cards being displayed on the first display device, while in the side game.

According to the game machine constituted as set forth above, a plurality of cards dealt to a plurality of players are displayed on a common display device, while in a side game, and a payment is paid out to only a player having entered a side BET. Therefore, for example, five cards dealt to each of five players are displayed on a common display device, and a payment is paid out to a player who realized the strongest card combination, from among the players having entered side BETs, thus making it possible to enhance entertainability of card games among the plurality of players.

A sixth aspect of the present invention is the game machine of the fifth aspect, wherein: the controller, in the process (g), distributes and pays out a payment among all of the players having entered the side BETs.

According to the game machine constituted as set forth above, a plurality of cards dealt to a plurality of players are displayed on a common display device, while in a side game, and a payment is distributed and paid out among all of the players having entered side BETs. Therefore, for example, five cards dealt to each of five players are displayed on the common display, and a payment, based upon a card combination, can be distributed among the players having entered the side BETs, thus making it possible to enhance entertainability of card games among the plurality of players.

A seventh aspect of the present invention is the game machine of the fifth aspect, wherein the controller is programmed to (h) perform a process of determining a player to whom a payment is given, from among the plurality of players, and wherein: the controller, in the process (g), pays out a payment to the player determined in the process (h).

According to the game machine constituted as set forth above, a plurality of cards dealt to a plurality of players are displayed on a common display device, and a player to whom a payment is paid out is determined from among players having entered side BETs. Therefore, for example, five cards dealt to each of five players are displayed on the common display device, and a player to whom a payment is randomly paid out is determined from among the players having entered the side BETs, thus making it possible to enhance entertainability of card games among the plurality of players.

An eighth aspect of the present invention is a game machine, including: a plurality of first display devices provided corresponding to respective ones of a plurality of players; a second display device provided in common to the plurality of players; and a controller for controlling the first display devices and the second display device, the controller being programmed to: (a) perform a basic game; (b) accept, from the input device, entry of a side BET which is different from a normal BET; (c) display a predetermined number of players' cards on the first display devices and a plurality of banker's cards on the second display device, while in the basic game; (d) pay out a payment to a player, the payment being determined by comparing the players' cards and the banker's cards that are displayed in the step (b), while in the basic game; (e) perform a side game in a case where a predetermined condition is met while in the basic game; (f) display, on the first display devices, the plurality of cards dealt to the plurality of players, and display, on the second display device, the plurality of cards displayed on the first display device and possessed by the respective players, from among plural kinds of cards, while in the side game; and (g) distribute and payout a payment among all of the pictures having entered the side BET, the payment being determined by comparing the plurality of cards possessed by the players, the cards being displayed on the first display device, while in the side game.

According to the game machine constituted as set forth above, a plurality of cards dealt to a plurality of players are displayed on a common display device, while in a side game, and a payment is distributed and paid out among all of the players having entered side BETs. Therefore, for example, five cards dealt to each of five players are displayed on the common display device, and a payment, based upon a card combination, can be distributed among the players having entered the side BETs, thus making it possible to enhance entertainability of card games among the plurality of players.

A ninth aspect of the present invention is a game method, including: the steps of: (a) dealing a predetermined number of cards to players as players' cards and dealing a predetermined number of cards to a banker as banker's cards, while in the basic game; (b) paying out a payment to a player the payment being determined by comparing the players' cards with the banker's cards, while in the basic game; (c) dealing a plurality of cards, respectively, to the plurality of players, from among plural kinds of cards, while in a side game; (d) arranging the plurality of cards possessed by the plurality of players to the plurality of players, while in the side game, in a state in which the kinds of the plurality of cards are identifiable; (e) determining a payment according to a winning combination of cards included in a plurality of cards of each of the players, the cards being arranged while in the side game; and (f) paying out to a player the payment determined in the step (e).

According to the above-mentioned game method, a plurality of cards dealt to a plurality of players in a side game are arranged in a state in which their kinds are identifiable, and a payment is paid out according to a card combination. Therefore, for example, five cards dealt to each of five players are arranged in a state in which their kinds are identifiable, and then, a payment is paid out to a player who realized the strongest card combination, thus making it possible to enhance entertainability of card games among the plurality of players.

A tenth aspect of the present invention is the game method of the ninth aspect, further including the step of (g) accepting a side BET which is different from a normal BET, wherein the step (f) includes the step of paying out a payment to only the players having performed the side BETs.

According to the above-mentioned game method, a plurality of cards dealt to a plurality of players are arranged in a side game in a state in which their kinds are identifiable, and then, a payment is paid out to only a player having entered a side BET. Therefore, for example, five cards dealt to each of five players are arranged in a state in which their kinds are identifiable, and a payment is paid out to a player who realized the strongest card combination, from the players having entered the side BETs, thus making it possible to enhance entertainability of card games among the plurality of players.

An eleventh aspect of the present invention is the game method of the ninth aspect, wherein the step (f) includes the step of distributing and paying out a payment among all of the players having performed the side BETs in the step (g).

According to the abovementioned game method, a plurality of cards dealt to a plurality of players in a side game are arranged in a state in which their kinds are identifiable, and a payment is distributed and paid out among all of the players having entered side BETs. Therefore, for example, five cards dealt to each of five players are arranged in a state in which their kinds are identifiable, and a payment, based upon a card combination, can be distributed among the players having entered side BETs, thus making it possible to enhance entertainability of card games among the plurality of players.

A twelfth aspect of the present invention is the game method of the ninth aspect, further including the step of (h) determining a player to whom a payment is given, from among the plurality of players, wherein: the step (f) includes the step of paying out a payment to the player determined in the step (h).

According to the abovementioned game method, a plurality of cards dealt to a plurality of players in a side game are arranged so that their kinds are identifiable, and a player to whom a payment is paid out is determined from among the players having entered side BETs. Therefore, for example, five cards dealt to each of five players are arranged while their kinds are identifiable, and a player to whom a payment is randomly paid out is determined from among the players having entered the side BETs, thus making it possible to enhance entertainability of card games among the plurality of players.

A thirteenth aspect of the present invention is a card game playing method, for performing a basic game and a side game, including the steps of: (a) accepting a side BET which is different from a normal BET; (b) dealing a predetermined number of cards to players as players' cards and dealing a predetermined number of cards to a banker as banker's cards, while in the basic game; (c) paying out a payment to a player the payment being determined by comparing the players' cards with the banker's cards, while in the basic game; (d) dealing a plurality of cards, respectively, to the plurality of players, from among plural kinds of cards, while in a side game; (e) arranging the plurality of cards possessed by the plurality of players to the plurality of players, while in the side game, in a state in which the kinds of the plurality of cards are identifiable; (f) determining a payment according to a winning combination of cards included in a plurality of cards of each of the players, the cards being arranged while in the side game; and (g) paying out a payment to only a player having performed the side BET, the payment being determined in the step (f).

According to the above-mentioned game method, a plurality of cards dealt to a plurality of players in a side game are arranged in a state in which their kinds are identifiable, and a payment is paid out only to a player having entered a side BET. Therefore, for example, five cards dealt to each of five players are arranged in a state in which their kinds are identifiable, and a payment is paid out to a player who realized the strongest card combination, from among the players having entered side BETs, thus making it possible to enhance entertainability of card games among the plurality of players.

A fourteenth aspect of the present invention is the game method of the thirteenth aspect, wherein the step (g) includes the step of distributing and paying out a payment among all of the players having performed the side BET.

According to the above-mentioned game method, a plurality of cards dealt to a plurality of players in a side game are arranged in a state in which their kinds are identifiable, and a payment is distributed and paid out among all of the players having entered side BETs. Therefore, for example, five cards dealt to each of five players are arranged in an identifiable state, and a payment, based upon a card combination, can be distributed among the players having entered side BETs, thus making it possible to enhance entertainability of card games among the plurality of players.

A fifteenth aspect of the present invention is the game method of the thirteenth aspect, further including the step of (h) the step of determining a player to whom a payment is given, from among the plurality of players, wherein: the step (f) includes the step of paying out a payment to the player determined in the step (h).

According to the above-mentioned game method, a plurality of cards dealt to a plurality of players in a side game, are arranged in a state in which their kinds are identifiable. Therefore, for example, five cards dealt to each of five players are arranged in a state in which their kinds are identifiable, thus making it possible to enhance entertainability of card games among the plurality of players.

A sixteenth aspect of the present invention is a game machine, including: a plurality of first display devices provided corresponding to respective ones of a plurality of players; a second display device provided in common by the plurality of players; and a controller for controlling the first display devices and the second display device, the controller being programmed to: (a) execute a basic game; (b) display a predetermined number of players' cards on the first display devices and a predetermined number of banker's cards on the second display device while in the basic game; (c) pay out to the players a payment determined by comparing the players' cards with the banker's cards displayed in the process (b) while in the basic game; (d) execute a side game in a case where a predetermined condition is met while in the basic game; (e) randomly determine a combination of cards, in which a payment is to be paid out, from among plural kinds of cards while in the side game, and then, display the randomly determined combination of cards on at least either of each of the first display devices and the second display device; (f) display, on the first display devices, a plurality of cards after dealt to the plurality of players from among plural kinds of cards, and then, display, on the second display device, the plurality of cards that are displayed on the first display devices and owned by the players, while in the side game; and (g) pay out a payment, based upon a combination of the cards displayed in the process (e) in a case where the combination of the cards randomly determined and displayed in the process (e) is included in the plurality of cards owned by the players while in the side game.

According to the game machine constituted as set forth above, a combination of cards, in which a payment is to be paid out in a side game, is displayed. Further, the payment is paid out in a case where combinations of a plurality of cards after dealt to a plurality of players, which were displayed on a common display device, include a combination of cards, in which a payment is to be paid out. Thus, in a case where a combination of cards “one pair” is displayed on a display device when the side game is started, for example, five cards after dealt to each of the five players are displayed on the common display device. Further, the payment is paid out to a player who realized the combination of cards “One Pair” that might be included in the displayed cards dealt to each of the players. This allows the game machine to enhance entertainability in card games among the plurality of players.

A seventeenth aspect of the present invention is the game machine of the sixteenth aspect, further comprising an input device for accepting operation of the players, the controller being programmed to: (h) accept entry of a side BET, which is different from a normal BET, from the input device, and then, pay out a payment to only players having entered the side BET in the process (g).

According to the game machine constituted as set forth above, a combination of cards, in which a payment is to be paid out in a side game, is displayed. Further, the payment is paid out in a case where combinations of a plurality of cards after dealt to a plurality of players, which were displayed on a common display device, include a combination of cards, in which a payment is to be paid out. Thus, in a case where a combination of cards “Two Pairs” are displayed on a display device when the side game is started, for example, five cards after dealt to each of the five players are displayed on the common display. Further, the payment is paid out to only a player having entered a side BET from among players who realized the combination of cards “Two Pairs” that might be included in the displayed five cards after dealt to each of the players. This allows the game machine to enhance entertainability of card games among the plurality of players.

A eighteenth aspect of the present invention is the game machine of the sixteenth aspect, wherein the controller distributes and pays out a payment among all of the players having entered the side BET in the process (g).

According to the game machine constituted as set forth above, a combination of cards, in which a payment is to be paid out in a side game, is displayed. Further, a payment is distributed and paid out among the players having entered side BETs, in a case where combinations of a plurality of cards after dealt to a plurality of players, which are displayed on the common display device, include a combination of cards, in which a payment is to be paid out. Thus, in a case where a combination of cards “One Pair” is displayed on the display device when the side game is started, for example, five cards after dealt to each of the five players are displayed on the common display device. Further, in a case where the displayed five player's cards include the combination of cards “One Pair”, the payment is distributed among the players having entered side BETs. This allows the game machine to enhance entertainability of card games among the plurality of players.

A nineteenth aspect of the invention is the game machine of the sixteenth aspect, wherein the controller is programmed to (i) execute processing of determining a player to whom a payment is to be paid out, from among the plurality of players; and the controller, in the process (g), pays out a payment to the players determined in (i).

According to the game machine constituted as set forth above, a combination of cards, in which a payment is to be paid out in a side game, is displayed. Further, player to whom the payment is to be paid out is determined from among the players having entered side BETs in a case where combinations of plurality of cards after dealt to the plurality of players, which were displayed on the common display, include a combination of cards, in which the payment is to be paid out. Thus, in a case where a combination of cards “Three of a Kind” is displayed on a display device when the side game is started, for example, five cards after dealt to each of the five players are displayed on the common display device. Further, a player to whom the payment is to be randomly paid out is determined from among the players having entered side BETs for the combination of cards “Three of a Kind” included in the displayed five player's cards. This allows the game machine to enhance entertainability of card games among the plurality of players.

A twentieth aspect of the present invention is a game machine, including: a plurality of first display devices provided corresponding to respective ones of a plurality of players; a second display device provided in common by the plurality of players; an input device for accepting operation of the players; and a controller for controlling the first display devices and the second display device, the controller being programmed to: (a) execute a basic game; (b) accept entry of a side BET, which is different from a normal BET, from the input device; (c) display a predetermined number of players' cards on the first display devices and a predetermined number of banker's cards on the second display device while in the basic game; (d) pay out to the players a payment determined by comparing the players' cards with the banker's cards displayed in the process (b) while in the basic game; (e) execute a side game in a case where a predetermined condition is met while in the basic game; (f) randomly determine a combination of cards, in which a payment is to be paid out, from among plural kinds of cards while in the side game, and then, display the randomly determined combination on at least either of each of the first display devices and the second display device; (g) display, on the first display devices, a plurality of cards after dealt to the plurality of players from among plural kinds of cards, and then, display, on the second display device, the plurality of cards that are displayed on the first display devices and owned by the players, while in the side game; and (h) pay out a payment to only the players having entered the side BET, based upon a combination of the cards displayed in the process (g) in a case where the combination of the cards randomly determined and displayed in the process (f) is included in the plurality of cards owned by players while in the side game.

According to the game machine constituted as set forth above, a combination of cards, in which a payment is to be paid out in a side game, is displayed. Further, the payment is paid out to only a player having entered a side BET in a case where plural combinations of cards after dealt to a plurality of players, which were displayed on the common display device, include a combination of cards, in which the payment is to be paid out. Thus, in a case where a combination of cards “Two Pairs” is displayed on a display device when the side game is started, for example, five cards after dealt to each of five players are displayed on the common display device. Further, the payment is paid out to only the player having entered a side BET from among the players who realized the combination of cards “Two Pairs” that might be included in the displayed five player's cards. This allows the game machine to enhance entertainment of card games among the plurality of players.

A twenty-first aspect of the present invention is the game machine of the twentieth aspect, wherein the controller distributes and pays out a payment among all of the players having entered the side BET in the process (h).

According to the game machine constituted as set forth above, a combination of cards, in which a payment is to be paid out in a side game, is displayed. Further, the payment is distributed and paid out to the players having performed side BETs, in a case where combinations of a plurality of cards after dealt to the plurality of players, which were displayed on the common display, include a combination of cards, in which the payment is to be paid out. Thus, in a case where a combination of cards “One Pair” is displayed on the display device when the side game is started, for example, five cards after dealt to each of the five players are displayed on the common display device. Further, the payment is distributed among the players having entered the side BETs in a case where the combination of cards “One Pair” is included in the displayed five cards after dealt to each of the five players. This allows the game machine to enhance entertainability of card games among the plurality of players.

A twenty-second aspect of the present invention is the game machine of the twentieth aspect, wherein the controller is programmed to (i) execute processing of determining a player to whom a payment is to be paid out, from among the plurality of players; and the controller, in the process (h), pays out a payment to the player determined in the process (i).

According to the game machine constituted as set forth above, a combination of cards, in which a payment is to be paid out in a side game, is displayed. A player to whom the payment is to be paid out is determined from among the players having entered side BETs, in a case where combinations of a plurality of cards after dealt to the plurality of players, which were displayed on the common display device, include a combination of cards, in which the payment is to be paid out. Thus, in a case where a combination of cards “Three of a Kind” is displayed when the side game is started, for example, five cards after dealt to each of the five players are displayed on the common display device. Further, a player to whom the payment is to be randomly paid out is determined from among the players having entered side BETs on the combination of cards “Three of a Kind” in the displayed five cards after dealt to each of the players. This allows the game machine to enhance entertainability of card games among the plurality of players.

An twenty-third aspect of the present invention is a game machine, including: a plurality of first display devices provided corresponding to respective ones of a plurality of players; a second display device provided in common by the plurality of players; an input device for accepting operation of the players; and a controller for controlling the first display devices and the second display device, the controller being programmed to: (a) execute a basic game; (b) accept entry of a side BET, which is different from a normal BET, from the input device; (c) display a predetermined number of players' cards on the first display device and a predetermined number of banker's cards on the second display device while in the basic game; (d) pay out to the players a payout determined by comparing the players' cards with the banker's cards displayed in the process (b) while in the basic game; (e) execute a side game in a case where a predetermined condition is met while in the basic game; (f) randomly determine a combination of cards, in which a payment is to be paid out, from among plural kinds of cards while in the side game, and then, display the randomly determined combination of cards on at least either of each of the first display devices and the second display device; (g) display, on the first display devices, a plurality of cards after dealt to the plurality of players from among plural kinds of cards, and display, on the second display device, the plurality of cards displayed on the first display devices and owned by the players, while in the side game; and (h) pay out a payment among only the players having entered the side BET, based upon a combination of the cards displayed in the process (g) in a case where the combination of the cards randomly determined and displayed in the process (f) is included in the plurality of cards owned by players while in the side game.

According to the game machine constituted as set forth above, a combination of cards, in which a payment is to be paid out in a side game, is displayed. Further, the payment is distributed and paid out to the players having entered side BETs, in a case where plural combinations of cards after dealt to the plurality of players displayed on the common display device include a combination of cards, in which the payment is to be paid out. Thus, in a case where a combination of cards “One Pair” is displayed on the display device when the side game is started, for example, five cards after dealt to each of the five players are displayed on the common display. Further, the payment is distributed among the players having entered side BETs, in a case where the combination of cards “One Pair” is included in the displayed five cards after dealt to each of the players. This allows the game machine to enhance entertainability of card games among the plurality of players.

A twenty-fourth aspect of the present invention is a card game playing method, for performing a basic game and a side game, the method including the steps of: (a) dealing to players a predetermined number of cards as players' cards and dealing to a banker a predetermined number of cards as banker's cards, in the basic game; (b) paying out to players a payment determined by comparing the players' cards with the banker's cards, in the basic game; (c) determining a combination of cards, in which a payment is to be paid out, from among plural kinds of cards, in the side game; (d) dealing a plurality of cards to a plurality of players from among the plural kinds of cards, in the side game; (e) arranging a plurality of cards owned by a plurality of players in a state in which kinds of the plural cards are identified by the plurality of players, in the side game; and (f) paying out a payment to a player, based upon a combination of cards, in which the payment has been determined to be paid out in the step (c), in a case where a combination of cards included in a plurality of the arranged player's cards in the side game includes a combination of the cards, in which the payment has been determined to be paid out in the step (c).

According to the game method set forth above, a combination of cards, in which a payment is to be paid out in a side game, is determined, and then, a plurality of cards after dealt to a plurality of players are arranged in a state in which their kinds are identified. Further, the payment is paid out in a case where plural combinations of cards after dealt to the plurality of players include a combination of cards, in which the payment is to be paid out. Thus, in a case where a combination of cards “One Pair” is determined when the side game is started, for example, five cards after dealt to each of the five players are arranged in a state in which their kinds are identified. Further, the payment is paid out to a player who realized the combination of cards “One Pair” included in the five cards after dealt to each of the players. This allows the game machine to enhance entertainability of card games among the plurality of players.

A twenty-fifth aspect of the present invention is the game method of the twenty-fourth aspect, further including the step of (g) accepting a side BET which is different from a normal BET, wherein the step (f) includes the step of paying out a payment to only the players having performed the side BETs.

According to the game method set forth above, a combination of cards, in which a payment is to be paid out in a side game, is determined, and then, a plurality of cards after dealt to a plurality of players are arranged in a state in which their kinds are identified. Further, the payment is paid out to only the players having entered the side BETs, in a case where plural combinations of cards after dealt to the plurality of players include a combination of cards, in which the payment is to be paid out. Thus, in a case where a combination of cards “Two Pairs” is determined when the side game is started, for example, five cards after dealt to each of the five players are arranged in a state in which their kinds are identified. Further, the payment is paid out to only the players having performed the side BETs from the players who realized the combination of cards “Two Pairs” that might be included in the five cards after dealt to each of the players. This allows the game method to enhance entertainability of card games among the plurality of players.

An twenty-sixth aspect of the present invention is the game method of the twenty-fourth aspect, wherein the step (f) includes the step of distributing and paying out a payment among all of the players having performed the side BETs in the step (g).

According to the game method set forth above, a combination of cards, in which a payment is to be paid out in a side game, is determined, and then, a plurality of cards after dealt to a plurality of players are arranged in a state in which their kinds are identified. Further, the payment is distributed and paid out to the players having entered the side BETs, in a case where plural combinations of cards include a combination of cards, in which the payment is to be paid out. Thus, in a case where a combination of cards “One Pair” is determined when the side game is started, for example, five cards after dealt to each of the five players are arranged in a state in which their kinds are identified. Further, the payment is distributed among the players having entered the side BETs, in a case where the five cards after dealt to each of the players include the combination of cards “One Pair”. This allows the game method to enhance entertainability of card games among the plurality of players.

A twenty-seventh aspect of the present invention is the game method of the twenty-fourth aspect, further including the step of (h) determining a player to whom a payment is to be paid out, from among the plurality of players, wherein the step (f) includes the step of paying out a payment to the player determined in the step (h).

According to the game machine set forth above, a combination of cards, in which a payment is to be paid out in a side game, is determined, and then, a plurality of cards after dealt to a plurality of players are arranged in a state in which their kinds are identified. Further, a player to whom the payment is to be paid out is determined from among the players having entered side BETs, in a case where plural combinations of cards include a combination of cards, in which the payment is to be paid out. Thus, in a case where a combination of cards “Three of a Kind” is determined when the side game is started, for example, five cards after dealt to each of the five players are arranged in a state in which their kinds are identified. Further, a player to whom the payment is to be randomly paid out is determined from among the players having entered side BETs for the combination of cards “Three of a Kind” in the five cards after dealt to each of the players. This allows the game method to enhance entertainability of card games among the plurality of players.

A twenty-eighth aspect of the present invention is a card game playing method, for performing a basic game and a side game, the method including the steps of: (a) accepting a side BET which is different from a normal BET; (b) dealing to players a predetermined number of cards as players' cards and dealing to a banker a predetermined number of cards as banker's cards, in the basic game; (c) paying out to players a payment determined by comparing the players' cards with the banker's cards, in the basic game; (d) determining a combination of cards in which a payment is to be paid out, from among plural kinds of cards, in the side game; (e) dealing a plurality of cards to a plurality of players from among the plural kinds of cards, in the side game; (f) arranging a plurality of cards owned by a plurality of players in a state in which kinds of the plural cards are identified by the plurality of players, in the side game; and (g) paying out a payment to only a player having performed the side BET, based upon a combination of cards, in which the payment has been determined to be paid out in the step (d), in a case where a combination of the cards included in the plurality of the arranged player's cards in the side game includes a combination of the cards, in which the payment has been determined to be paid out in the step (d).

According to the card game playing method set forth above, a combination of cards, in which a payment is to be paid out in a side game, is determined, and then, a plurality of cards after dealt to a plurality of players are arranged in a state in which their kinds are identified. Further, the payment is paid out to only the players having entered side BETs, in a case where plural combinations of cards after dealt to the plurality of players include a combination of cards, in which the payment is to be paid out. Thus, in a case where a combination of cards “Two Pairs” is determined when the side game is started, for example, five cards after dealt to each of the five players are arranged in a state in which their kinds are identified. Further, the payment is paid out to only the players having entered side BETs from among the players who realized the combination of cards “Two Pairs” that might be included in the five cards deal to each of the five players. This allows the game method to enhance entertainability of card games among the plurality of players.

A twenty-ninth aspect of the present invention is the game method of the twenty-eighth aspect, wherein the step (g) includes the step of distributing and paying out a payment among all of the players having performed the side BET.

According to the game method set forth above, a combination of cards, in which a payment is to be paid out in a side game, is determined, and then, a plurality of cards after dealt to a plurality of players are arranged in a state in which their kinds are identified. Further, the payment is distributed and paid out to the players having entered side BETs, in a case where plural combinations of cards include a combination of cards, in which the payment is to be paid out. Thus, in a case where a combination of cards “One Pair” is determined when the side game is started, for example, five cards after dealt to each of the five players are arranged in a state in which their kinds are identified. Further, the payment is distributed among the players having entered side BETs, in a case where the five cards after dealt to each of the players include the combination of cards “One Pair”. This allows the game method to enhance entertainability of card games among the plurality of players.

A thirtieth aspect of the present invention is the game method of the twenty-eighth aspect, further including the step of (h) determining a player to whom a payment is to be paid out, from among the plurality of players, wherein the step (g) includes the step of paying out the payment determined in the step (h).

According to the game method set forth above, a combination of cards, in which a payment is to be paid out in a side game, is determined, and then, a plurality of cards after dealt to a plurality of players are arranged in a state in which their kinds are identified. Further, a player to whom the payment is to be paid out is determined from among the players having entered side BETs, in a case where plural combinations of cards include a combination of cards, in which the payment is to be paid out. Thus, in a case where a combination of cards “Three of a Kind” is determined when the side game is started, for example, five cards after dealt to each of the five players are arranged in a state in which their kinds are identified. Further, a player to whom the payment is to be randomly paid out is determined from among the players having entered side BETs on the combination of cards “Three of a Kind” in the five cards after dealt to each of the five players. This allows the game method to enhance entertainability of card games among the plurality of players.

A thirty-first aspect of the present invention is a game machine, including: a plurality of first display devices provided corresponding to respective ones of a plurality of players; a second display device provided in common to the plurality of players; a memory for storing first card set data including plural kinds of card data and second card set data including card data that are identical to the card data included in the first card data set; and a controller for controlling the first display devices, the second display, and the memory, the controller being programmed to: (a) execute a basic game; (b) display a plurality of players' cards on the first display devices and a plurality of banker's cards on the second display device, from among plural kinds of cards included in the first card set data, while in the basic game; (c) pay out to the players a payment determined by comparing the players' cards and the banker's cards displayed in the process (b), while in the basic game; (d) execute a side game in a case where a predetermined condition is met while in the basic game; (e) display the players' cards on the first displays and the second display while in the side game; (f) determine at least one special card dealt to each of the plurality of players, from the plural kinds of cards contained in the second card set data stored in the memory, and display the special cards dealt to each of the players on at least the first display devices of the corresponding players or the second display device; and (g) pay out a payment to a player having a special card constituting a combination of the cards, in a case where combinations between the players' cards of the plurality of players displayed on the second display and the special cards of the players displayed on the second display include a predetermined card combination.

According to the game machine constituted as set forth above, players' cards dealt to a plurality of players and special cards are displayed in a basic game, and a payment is paid out according to combinations of the players' cards and the special cards. Thus, in a case where five player's cards are dealt to each of the players, for example, the common display serves to display five groups of 25 cards dealt to the five players, each of which consists of four common cards and one special card dealt to each of the players, thus making it possible to enhance entertainability of card games among the plurality of players.

A thirty-second aspect of the present invention is the game machine of the thirty-first aspect, wherein the controller is programmed to (h) determine a common card displayed in a predetermined region of the second display, from plural kinds of cards contained in the first card set; and (i) display the determined common cards in the predetermined region of the second display device, and the controller pays out a payment to a player having a special card which realizes a combination with a high payment, from among combinations of the cards, in a case where combinations between the special card and the common cards, owned by the plurality of players, include a predetermined card combination, in the process (g).

According to the game machine constituted as set forth above, the common display serves to display common cards other than the players' cards dealt to a plurality of players while in a game and a special card dealt to each of the players, and a payment is paid out according to a combination of the common cards and special card. In other words, the common display serves to display four common cards and one special card of each of the players, for example. Among players who realized a combination of the four common cards and one special card, a payment is paid out to a player that realized a combination with the highest payment. If a special card is selected from one card set consisting of 52 cards, therefore, a maximum of 52 players can perform a game at the same time, thus making it possible to enhance entertainability of card games among the plurality of players.

A thirty-third aspect of the present invention is the game machine of the thirty-first aspect, further including: an input device for accepting a side BET different from a normal BET from a player, wherein: the controller determines the special cards dealt to both of a player not having accepted the side BET and a player having accepted the side BET, in the process (f); and pays out a payment in order from a combination with a highest payment, from among combinations of the special card and the plurality of cards to the player having accepted the side BET from among the players having the special cards constituting combinations of the cards, in the process (g).

According to the game machine constituted as set forth below, while in a game, the common display serves to display players' cards and special cards dealt to all of a plurality of players who participate in the game. Among players who realize a combination of the players' cards and the special cards, a payment is paid out to only a player having performed a side BET. Thus, in a case where five player's cards are dealt to each of the players, for example, the common display serves to display five groups of 25 cards dealt to five players, each of which consists of four common cards and one special card which were dealt to each of the players. Among the players who realized a special-card combination and performed the side BET, a payment is paid out in order of players who realized a combination with a high payment, thus making it possible to enhance entertainability of card games among the plurality of players.

A thirty-fourth aspect of the present invention is a game machine, including: a plurality of first display devices provided corresponding to respective ones of a plurality of players; a second display device provided in common to the plurality of players; a memory for storing first card set data including plural kinds of card data and second card set data including card data that are identical to the card data included in the first card data set; and a controller for controlling the first display devices, the second display, and the memory, the controller being programmed to: (a) execute a basic game; (b) display a plurality of players' cards on the first display devices and a plurality of banker's cards on the second display device, from among plural kinds of cards contained in the first card set data, while in the basic game; (c) pay out to the players a payment determined by comparing the players' cards and the banker's cards displayed in the process (b), while in the basic game; (d) execute a side game in a case where a predetermined condition is met while in the basic game; (e) display the players' cards on the first displays and the second display while in the side game; (f) determine common cards displayed in a predetermined region of the second display device, from among plural kinds of cards contained in the first card set, and display the determined common cards in the predetermined region of the second display device; (g) determine at least one special card dealt to each of the plurality of players, from among the plural kinds of cards contained in the second card set data stored in the memory, and display the special cards dealt to the players on at least the first display device of the corresponding players or the second display device; and (h) pay out a payment to the player having the special card, in a case where combinations between the players' cards of the plurality of players displayed on the second display device and the special cards of the players displayed on the second display device include a predetermined card combination and/or, in a case where said combinations include a combination between the common cards and the special card displayed on the second display device.

According to the game machine constituted as set forth above, while in a basic game, the common display serves to display high hand cards and common cards dealt to a plurality of players and special cards selected from card set data different from those from which high hand cards and common cards were selected, and/or a payment is paid out according to a combination between the common cards and the special card. Thus, in a case where five player's cards are dealt to each of the players, for example, the common display serves to display five groups of 25 high hand cards dealt to five players, each of which consists of four common cards and one special card which were dealt to each of the players. A predetermined combination is realized in five groups of 25 cards, each of which consists of five cards including one special card. Among the players who realized a combination of four common cards and one special card, a payment is given to a player who realized a combination with the highest payment, thus making it possible to enhance entertainability of card games among the plurality of players.

A thirty-fifth aspect of the present invention is a game machine of the thirty-fourth aspect, further including an input device for accepting a side BET different from a normal BET from a player, wherein: the controller determines the special cards to dealt to both of a player not having accepted the side BET and a player having accepted the side BET, in the process (g); and pays out a payment in order from a combination with a highest payment, from among combinations of the special card and the plurality of cards to the player having accepted the side BET, from among the players having the special cards constituting combinations of the cards, in the process (h).

According to the game machine constituted as set forth below, the common display serves to display high hand cards and common cards dealt to a plurality of players and special cards selected from those different from card set data from which high hand cards and common cards were selected, and/or, among the players who realized a combination of the player's cards and special card, a payment is paid out to only a player having performed a side BET. Thus, in a case where five cards are dealt to each of the players, for example, the common display serves to display five groups of 25 cards dealt to five players, each of which consists of four common cards and one special card which were dealt to each of the players. A predetermined combination is realized in five groups of 25 cards, each of which consists of four common cards and one special card. Among the players who realized a combination with a special card and performed a side BET, a payment is paid out in order from the player who realized a combination with the highest payment, thus making it possible to enhance entertainability of card games among the plurality of players.

A thirty-sixth aspect of the present invention is a game machine, including: a plurality of first display devices provided corresponding to respective ones of a plurality of players; a second display device provided in common to the plurality of players; a memory for storing first card set data including card data and second card set data including plural kinds of card data that are identical to the card data included in the first card data set; and a controller for controlling the first display devices, the second display, and the memory, an input device for accepting a side BET different from a normal BET from a player, the controller being programmed to: (a) execute a basic game; (b) display a plurality of players' cards on the first display devices and a plurality of banker's cards on the second display device, from among plural kinds of cards contained in the first card set data, while in the basic game; (c) pay out to the players a payment determined by comparing the players' cards and the banker's cards displayed in the process (b), while in the basic game; (d) execute a side game in a case where a predetermined condition is met while in the basic game; (e) display the players' cards on the first displays and the second display while in the side game; (f) determine common cards displayed in a predetermined region of the second display device, from among plural kinds of cards contained in the first card set data, to display the determined common cards in the predetermined region of the second display device; (g) determine at least one special card which were dealt to each of the plurality of players, from plural kinds of cards contained in the second card set data stored in the memory, and deal the special cards to both of a player not having accepted the side BET and a player having accepted the side BET and display the dealt special cards on at least the first display devices of the corresponding players or the second display device; and (h) pay out a payment to the player having accepted the side BET from among the players having the special cards, in a case where combinations between the players' cards of the plurality of players displayed on the second display device and the special cards of the players displayed on the second display device include a predetermined card combination and/or, in a case where said combinations include a combination of the common cards and the special cards displayed on the second display device.

According to the game machine constituted as set forth above, while in a basic game, the common display serves to display: high hand cards and common cards dealt to a plurality of players; and special cards selected from card set data different from those from which high hand cards and common cards were selected, and/or, among the players who realized a combination of the player's cards and special card, a payment is paid out to only a player having performed a side BET. Thus, in a case where five player's cards are dealt to each of the players, for example, the common display serves to display five groups of 25 cards dealt to five players, each of which consists of four common cards and one special card which were dealt to each of the players. A predetermined combination is realized in five groups of 25 cards, each of which consists of four common cards and one special card. Among the players who realized a combination with a special card and performed a side BET, a payment is paid out in order from the player who realized a combination with the highest payment, thus making it possible to enhance entertainability of card games among the plurality of players.

A thirty-seventh aspect of the present invention is a game machine, including: a plurality of first display devices provided corresponding to respective ones of a plurality of players; a second display device provided in common to the plurality of players; a memory for storing first card set data including a plural kinds of card data and second card set data including card data that are identical to the card data included in the first card data set; and a controller for controlling the first display devices, the second display, and the memory, the controller being programmed to: (a) execute a basic game; (b) display a plurality of players' cards on the first display devices and a plurality of banker's cards on the second display device, from among plural kinds of cards contained in the first card set data, while in the basic game; (c) pay out to the players a payment determined by comparing the players' cards and the banker's cards displayed in the process (b), while in the basic game; (d) execute a side game in a case where a predetermined condition is met, while in the basic game; (e) determine common cards from among the plural kinds of cards contained in the first card set data, and display the determined common cards in a predetermined region of the second display device, while in the side game; (f) determine at least one special card dealt to each of the plurality of players, from among the plural kinds of cards contained in the second card set data stored in the memory, and display the special cards dealt to the players on at least the first display devices of the corresponding players or the second display device; and (g) pay out a payment to a player having a special card which realizes a combination with a high payment, from among combinations of the cards, in a case where combinations between the common cards displayed on the second display device and the special cards of the players displayed on the second display device include a predetermined card combination.

According to the game machine constituted as set forth above, while in a basic game, the common display serves to display: common cards dealt to a plurality of players; and special cards selected from card set data different from those from which the common cards were selected. A payment is paid out to a player who realized a combination of the common cards and special card. In other words, the common display serves to display four common cards and one special card which were dealt to each of the players, for example. A payment is paid out in order from a player who realized a combination of four common cards and one special card and realized a combination with a high payment. If 52 cards are dealt in a card set for selecting special cards, therefore, a maximum of 52 players can perform card games, thus making it possible to enhance entertainability of the card games among a plurality of players.

An thirty-eighth aspect of the present invention is the game machine of the thirty-seventh aspect, further including an input device for accepting a side BET different from a normal BET from a player, wherein: the controller determines the special cards dealt to both of a player not having accepted the side BET and a player having accepted the side BET, in the process (f); and pays out a payment in order from a combination with a highest payment, from among combinations of the special card and the plurality of cards to the player having accepted the side BET, from among the players having the special cards constituting combinations of the cards, in the process (g).

According to the game machine constituted as set forth above, while in a basic game, the common display serves to display common cards and special cards dealt to a plurality of players. Among the players who realized a combination of common cards and a special card, a payment is paid out to only a player having performed a side BET. Thus, four common cards and one special card, which were dealt to each of the players, are displayed on the common display, for example. Among the players who realized a combination of four common cards and one special card, the players having performed a side BET, a payment is paid out in order from a player who realized a combination with the highest combination, thus making it possible to enhance entertainability of card games among the plurality of players.

A thirty-ninth aspect of the present invention is a card game playing method of the present invention, including the steps of: (a) determining a plurality of cards dealt to a plurality of players, from among a first card set including plural kinds of cards; (b) dealing to each of the plurality of players the plurality of cards determined in the step (a); (c) determining at least one special card dealt to each of the plurality of players from among a second card set including the cards identical to those of the first card set; (d) dealing the determined special card to each of the plurality of players; (e) arranging the plurality of cards that are based upon the first card set and the special card that is based upon the second card set to the plurality of players in a state in which kinds of the cards are identifiable; and (f) paying out a payment to a player having a special card constituting a combination of the cards, in a case where combinations between the arranged special cards of the players and all of the plurality of cards of the plurality of players include a predetermined card combination.

According to the card game playing method constituted as set forth above, while in a basic game, the common display serves to display, in arranged manner, a plurality of cards dealt to a plurality of players and special cards selected from card set data different from those from which high hand cards and common cards were selected. A payment is paid out according to a combination of the player's cards and a special card. Thus, in a case where five cards are dealt to each of the players, for example, the common display serves to display five groups of 25 cards dealt to five players, each of which consists of four common cards and one special card which were dealt to each of the players. A payment is paid out to a player who realized a predetermined combination of four common cards and one special card contained in each of the five groups of 25 cards, thus making it possible to enhance entertainability of card games among the plurality of players.

A fortieth aspect of the present invention is the card game playing method of the thirty-ninth aspect, further including the steps of: (g) determining common cards commonly available to the plurality of players, from among plural kinds of cards contained in the second card set; and (h) arranging the determined common cards in a predetermined region, wherein the step (f) includes the step of paying out a payment to a player having a special card which realizes a combination with a highest payment, from among combinations of the cards, in a case where combinations between the special cards and the common cards, owned by the plurality of players, include a predetermined card combination.

According to the card game playing method constituted as set forth above, the common display serves to display, in an arranged manner, common cards other than a plurality of cards dealt to a plurality of players while in a game, a plurality of cards dealt to the players, and special cards selected from card set data different from those from which the common cards were selected. A payment is paid out according to a combination of the common cards and special card. In other words, the common display serves to display four common cards and one special card of each of the players, for example. Among the players who realized a special card combination, a payment is paid out to a player who realized a combination with the highest payment, thus making it possible to enhance entertainability of card games among the plurality of players.

An forty-first aspect of the present invention is a card game playing method of the thirty-ninth aspect, further including the step of accepting a side BET different from a normal BET from a player, wherein: in the step (c), the special cards are determined to be dealt to both of the player not having accepted the side BET and the player having accepted the side BET; and wherein: in the step (f), a payment is paid out in order from a combination with a highest payment, from among combinations of the special card and the plurality of cards dealt to the player having accepted the side BET, from among the players having the special cards constituting combinations of the cards.

According to the card game playing method constituted as set forth above, while in a game, the common display serves to display players' cards and special cards dealt to all of a plurality of players participating in the game. Among the players who realized a combination of the player's cards and special card, a payment is paid out to only a player having performed a side BET. Thus, in a case where seven cards are dealt to each of the players, for example, the common display serves to display five groups of 35 cards dealt to five players, each of which consists of six common cards and one special card dealt to each of the players, for example. Among players who realized a special card combination, the players having performed a side BET, a payment is paid out in order from a player who realized a combination with a high payment, thus making it possible to enhance entertainability of card games among the plurality of players.

A forty-second aspect of the present invention is a game machine, including: a plurality of display devices provided corresponding to respective ones of a plurality of players; and a controller for controlling the display devices, the controller being programmed to: (a) execute a basic game; (b) display a predetermined number of player's cards on a first display device corresponding to a first player, and display a predetermined number of banker's cards on a banker's display device, from among the plurality of display devices, while in the basic game; (c) execute a process of determining a winner or loser, by comparing hands of the player's cards with hands of the banker's cards, while in the basic game; (d) execute a side game in a case where a predetermined condition is met while in the basic game; (e) display a special card on the first display device, the special card being displayed while in the basic game performed by a second player on a second display device corresponding to the second player, from among the plurality of display devices, while in the side game; and (f) perform a payout according to a combination, in a case where the combination of: a predetermined number of cards, respectively, from among the player's cards and the banker's cards; and the special card displayed on the first display device, is a predetermined combination.

According to the game machine constituted as set forth above, a payment is paid out according to a combination between cards displayed while in a side game and a special card displayed while in a basic game. Thus, in a case where a combination of two cards dealt to a banker, two cards dealt to a player, and one special card is realized as “Flush”, for example, the payment is paid out according to the combination “Flush”. This makes it possible to enhance entertainability of card games and to provide a novel game machine.

A forty-third aspect of the present invention is the game machine of the forty-second aspect, further including an input device for accepting a player's operation, the controller being programmed to: (g) accept entry of a side BET which is different from a normal BET from the input device, and execute the side game on condition that the entry of the side BET has been accepted from the input device, in the process (d).

According to the game machine constituted as set forth above, on condition that entry of a side BET has been accepted, a special card is dealt while in a basic game, and a payment is paid out according to a combination between cards displayed while in a side game and a special card displayed while in the side game. Thus, in a case where a combination of two cards dealt to a banker, two cards dealt to a player, and one special card is realized as “Flush”, for example, the payment is paid out according to the combination “Flush”. This makes it possible to enhance entertainability of card games and to provide a novel game machine.

A forty-fourth aspect of the present invention is the game machine of the forty-second aspect, wherein the controller pays out one progressive payment from among a plurality of progressive payments, according to a kind of combination of: two of the player's cards and two of the banker's cards; and the special card displayed on the first display device, in the process (f).

According to the game machine constituted as set forth above, on condition that entry of a side BET has been accepted, a special card is dealt while in a basic game, and one progressive payment is paid out from among a plurality of progressive payments, according to a kind of combination of cards displayed while in the side game and the special card displayed while in the side game. Thus, in a case where a combination of two cards dealt to a banker and two cards dealt to a player; and one special card is realized as “Flush”, for example, the progressive payment is paid out according to the combination “Flush”. This makes it possible to enhance entertainability of card games and to provide a novel game machine.

A forty-fifth aspect of the present invention is a game machine, including: a plurality of display devices provided corresponding to respective ones of a plurality of players; an input device for accepting a player's operation; and a controller for controlling the input device and the display device, the controller being programmed to: (a) execute a basic game; (b) display a predetermined number of player's cards on a first display device corresponding to a first player, and display a predetermined number of banker's cards on a banker's display device, from among the plurality of display devices, while in the basic game; (c) determine a winner or loser, by comparing hands of the player's cards with hands of the banker's cards, while in the basic game; (d) execute a side game on condition that an entry of a side BET has been accepted from the input device, while in the basic game; (e) display a special card on the first display device, the special card being displayed while in the basic game performed by a second player on a second display device corresponding to the second player, from among the plurality of display devices, while in the side game; and (f) perform a payout according to a combination, in a case where the combination of: a predetermined number of cards, respectively, from among the player's cards and the banker's cards; and the special card displayed on the first display device, is a predetermined combination.

According to the game machine constituted as set forth below, on condition that entry of a side bet is accepted, special cards are delivered while in a basic game, and a payment is paid out according to a combination between the cards displayed while in a side game and the special cards displayed in a basic game. For example, if a combination between the two cards delivered to a banker, the two cards delivered to a player, and one special card is “Flush”, the payment is paid out according to the combination “FLUSH”. Therefore, entertainability of card games can be enhanced, and a novel game machine can be provided.

A forty-sixth aspect of the present invention is the game machine of the forty-fifth aspect, wherein the controller pays out one progressive payment from among a plurality of progressive payments, according to a kind of combination of: two of the player's cards and two of the banker's cards; and the special card displayed on the first display device, in the process (f).

According to the game machine constituted as set forth above, on condition that entry of a side BET has been accepted, a special card is dealt while in a basic game, and one progressive payment is paid out from among a plurality of progressive payments, according to a kind of combination between cards displayed while in a side game and the special card displayed while in the side game. Thus, in a case where a combination of two cards dealt to a banker, two cards dealt to a player, and one special card is realized as “Flush”, for example, the progressive payment is paid out according to the combination “Flush”. This makes it possible to enhance entertainability of card games and to provide a novel game machine.

A forty-seventh aspect of the present invention is a game machine, including a plurality of display devices provided corresponding to respective ones of a plurality of players; an input device for accepting a player's operation; and a controller for controlling the input device and the display device, the controller being programmed to: (a) execute a basic game; (b) display a predetermined number of player's cards on a first display device corresponding to a first player, and display a predetermined number of banker's cards on a banker's display device, from among the plurality of display device, while in the basic game; (c) execute a process of determining a winner or loser, by comparing hands of the player's cards with hands of the banker's cards, while in the basic game; (d) execute a side game on condition that an entry of a side BET different from a normal BET has been accepted from the input device, while in the basic game; (e) display a special card on the first display device, the special card being displayed while in the basic game performed by a second player on a second display device corresponding to a second player, from among the plurality of display devices, while in the side game; and (f) pay out one progressive payment from among a plurality of progressive payments, according to a kind of combination of: two of the player's cards and two of the banker's cards; and the special card displayed on the first display device.

According to the game machine constituted as set forth above, on condition that entry of a side BET has been accepted, a special card is dealt while in a basic game, and one progressive payment is paid out from among a plurality of progressive payments, according to a kind of combination between cards displayed while in a side game and the special card displayed while in the side game. Thus, in a case where a combination of two cards dealt to a banker, two cards dealt to a player, and one special card is realized as “Flush”, for example, the progressive payment is paid out according to the combination “Flush”. This makes it possible to enhance entertainability of card games and to provide a novel game machine.

A forty-eighth aspect of the present invention is a card game playing method, for performing a basic game and a side game, the method including the steps of: (a) executing a basic game; (b) dealing a predetermined number of player's cards to a first player, from among the plurality of players, and dealing a predetermined number of banker's cards to a banker, from among the plurality of display devices, while in the basic game; (c) determining a winner or loser, by comparing hands of the player's cards with hands of the banker's cards, while in the basic game; (d) executing a basic game in a case where a predetermined condition is met while in the basic game; (e) dealing a special card to the first player, the special card being dealt to a second player from among the plurality of players, while in the side game; and (f) performing a payout according to a combination, in a case where a predetermined number of cards, respectively, from among the player's cards dealt to the first player and the banker's cards; and the special card dealt to the first player, is a predetermined combination.

According to the card game playing method set forth above, a payment is paid out according to a combination between cards dealt while in a side game and a special card dealt while in a basic game. Thus, in a case where a combination of two cards dealt to a banker, two cards dealt to a player, and one special card is realized as “Flush”, for example, the payment is paid out according to the combination “Flush”. This makes it possible to enhance entertainability of card games and to provide a novel card game playing method.

An forty-ninth aspect of the present invention is the card game playing method of the forty-eighth aspect, wherein the step (d) includes the step of executing the side game for only a player having accepted a side BET which is different from a normal BET.

According to the card game playing method set forth above, on condition that entry of a side BET has been accepted, a special card is dealt while in a basic game, and a payment is paid out according to a combination between cards dealt in the side BET and the special card dealt while in the side game. Thus, in a case where a combination of two cards dealt to a banker, two cards dealt to a player, and one special card is realized as “Flush”, for example, the payment is paid out according to the combination “Flush”. This makes it possible to enhance entertainability of card games and to provide a novel card game playing method.

A fiftieth aspect of the present invention is the card game playing method of the forty-ninth aspect, wherein the step (f) includes the step of paying out one progressive payment from among a plurality of progressive payments, according to a kind of combination of: a predetermined number of cards, respectively, from among the player's cards and the banker's cards; and the special card dealt to the first player.

According to the card game playing method set forth above, on condition that entry of a side BET has been accepted, a special card is dealt while in a basic game, and one progressive payment is paid out from among a plurality of progressive payments, according to a kind of combination of cards dealt while in the side game and the special card dealt while in the side game. Thus, in a case where a combination of two cards dealt to a banker, two cards dealt to a player, and one special card is realized as “Flush”, for example, the payment is paid out according to the combination “Flush”. This makes it possible to enhance entertainability of card games and to provide a novel card game playing method.

A fifty-first aspect of the present invention is a card game playing method, for performing a basic game and a side game, the method including the steps of: (a) executing a basic game; (b) dealing a predetermined number of player's cards to a first player, from among the plurality of players, and dealing a predetermined number of banker's cards on a banker's display device, while in the basic game; (c) determining a winner or loser, by comparing hands of the player's cards with hands of the banker's cards, while in the basic game; (d) executing the side game for only a player having accepted a side BET which is different from a normal BET; (e) dealing a special card to the first player, the special card being dealt to a second player from among the plurality of players, while in the side game; and (f) performing a payout according to a combination, in a case where a predetermined number of cards, respectively, from among: the player's cards dealt to the first player and the banker's cards; and the special card dealt to the first player, is a predetermined combination.

According to the card game playing method set forth above, on condition that entry of a side BET has been accepted, a special card is dealt while in a basic game, and a payment is paid out according to a combination of cards dealt while in the side game and the special card dealt while in the side game. Thus, in a case where a combination of two cards dealt to a banker, two cards dealt to a player, and one special card is realized as “Flush”, for example, the payment is paid out according to the combination “Flush”. This makes it possible to enhance entertainability of card games and to provide a novel card game playing method.

An fifty-second aspect of the present invention is the card game playing method of the fifty-first aspect, wherein the step (f) includes the step of paying out one progressive payment from among a plurality of progressive payments, according to a kind of combination of a predetermined number of cards, respectively, from among: the player's cards and the banker's cards; and the special card dealt to the first player.

According to the card game playing method set forth above, on condition that entry of a side BET has been accepted, a special card is dealt while in a basic game, and one progressive payment is paid out from among a plurality of progressive payments, according to a kind of combination of cards dealt while in the side game and the special card dealt while in the side game. Thus, in a case where a combination of two cards dealt to a banker, two cards dealt to a player, and one special card is realized as “Flush”, for example, the payment is paid out according to the combination “Flush”. This makes it possible to enhance entertainability of card games and to provide a novel card game playing method.

### BRIEF DESCRIPTION OF THE DRAWINGS

FIG. 1 is a view showing an exemplary image displayed on a front panel display device in a side game according to a first embodiment;

FIG. 2 is a perspective view schematically depicting the game machine according to the first embodiment;

FIG. 3 is a perspective view schematically depicting an appearance and a configuration of each of the stations included in the game machine shown in FIG. 2 according to the first embodiment;

FIG. 4 is a view showing an exemplary image displayed on a front panel display included in the game machine according to the first embodiment;

FIG. 5 is a view showing an exemplary image displayed on a liquid crystal display included in each of the stations, according to the first embodiment;

FIG. 6 is a block diagram depicting the game machine shown in FIG. 2;

FIG. 7 is a block diagram depicting an internal configuration of the station included in the game machine shown in FIG. 2;

FIG. 8 is a view showing an exemplary image displayed on the front panel display of the game machine according to the first embodiment;

FIG. 9A is a view showing an exemplary image displayed on the liquid crystal display included in each of the stations, while in a side game, according to the first embodiment;

FIG. 9B is a view showing an exemplary image displayed on the liquid crystal display included in each of the stations, while in a side game, according to the first embodiment;

FIG. 10A is a view showing an exemplary image displayed on the liquid crystal display included in each of the stations, while in a side game, according to the first embodiment;

FIG. 10B is a view showing an exemplary image displayed on the liquid crystal display included in each of the stations, while in a side game, according to the first embodiment;

FIG. 11A is a flowchart showing main control unit processing executed at a main control unit included in the game machine according to the first embodiment;

FIG. 11B is a flowchart showing main control unit processing executed at a main control unit included in the game machine according to the first embodiment;

FIG. 12A is a flowchart showing a subroutine of station processing executed at the stations according to the first embodiment;

FIG. 12B is a flowchart showing a subroutine of station processing executed at the stations according to the first embodiment;

FIG. 13 is a view showing an exemplary image displayed on a front panel display device in a side game according to a second embodiment;

FIG. 14A is a flowchart showing main control unit processing executed at the main control unit included in a game machine according to a second embodiment; and

FIG. 14B is a flowchart showing main control unit processing executed at the main control unit included in the game machine according to the second embodiment.

FIG. 15 is a view showing an exemplary image displayed on a front panel display device in a side game according to a third embodiment;

FIG. 16 is a perspective view schematically depicting a game machine according to a third embodiment;

FIG. 17 is a perspective view schematically depicting an appearance and configuration of stations included in the game machine shown in FIG. 16;

FIG. 18 is a view showing an exemplary image displayed on a front panel display included in the game machine according to the third embodiment;

FIG. 19 is a view showing an exemplary image displayed on a liquid crystal display included in each of the stations according to the third embodiment;

FIG. 20 is a block diagram depicting an internal configuration of the game machine shown in FIG. 16;

FIG. 21 is a block diagram depicting an internal configuration of the station included in the game machine shown in FIG. 16;

FIG. 22 is a view showing an exemplary image displayed on the front panel display of the game machine according to the third embodiment;

FIG. 23 is a view showing an exemplary combination payout table in the side game according to the third embodiment;

FIG. 24A is a view showing an exemplary image displayed on a liquid crystal display included in each of the stations while in a side game according to the third embodiment;

FIG. 24B is a view showing an exemplary image displayed on a liquid crystal display included in each of the stations while in a side game according to the third embodiment;

FIG. 24C is a view showing an exemplary image displayed on a liquid crystal display included in each of the stations while in a side game according to the third embodiment;

FIG. 25A is a flowchart showing a main control unit processing executed at a main control unit included in the game machine according to the third embodiment;

FIG. 25B is a flowchart showing a main control unit processing executed at a main control unit included in the game machine according to the third embodiment;

FIG. 26A is a flowchart showing a subroutine of station processing executed at the stations according to the third embodiment;

FIG. 26B is a flowchart showing a subroutine of station processing executed at the stations according to the third embodiment;

FIG. 27 is a view showing an exemplary image displayed on a front panel display device in a side game according to a fourth embodiment;

FIG. 28A is a flowchart showing a main control unit processing executed at the main control unit included in a game machine according to a fourth embodiment; and

FIG. 28B is a flowchart showing a main control unit processing executed at the main control unit included in the game machine according to the fourth embodiment.

FIG. 29 is a view showing an exemplary image displayed on a front panel display device in a side game according to a fifth embodiment;

FIG. 30 is a perspective view schematically depicting a game machine according to a fifth embodiment;

FIG. 31 is a perspective view schematically depicting an appearance and configuration of stations included in the game machine shown in FIG. 30;

FIG. 32 is a view showing an exemplary image displayed on a front panel display included in the game machine according to the fifth embodiment;

FIG. 33 is a view showing an exemplary image displayed on a liquid crystal display included in each of the stations according to the fifth embodiment;

FIG. 34 is a block diagram depicting an internal configuration of the game machine shown in FIG. 30;

FIG. 35 is a block diagram depicting an internal configuration of the station included in the game machine shown in FIG. 30;

FIG. 36 is a view showing an exemplary image displayed on the front panel display of the game machine according to the fifth embodiment;

FIG. 37A is a view showing an exemplary image displayed on a liquid crystal display device included in each of the stations according to the fifth embodiment;

FIG. 37B is a view showing an exemplary image displayed on a liquid crystal display included in each of the stations according to the fifth embodiment;

FIG. 38 is a view showing an exemplary image displayed on the front panel display in the side game according to the fifth embodiment;

FIG. 39A is a flowchart showing a main control unit processing executed at a main control unit included in the game machine according to the fifth embodiment;

FIG. 39B is a flowchart showing a main control unit processing executed at a main control unit included in the game machine according to the fifth embodiment;

FIG. 40A is a flowchart showing a subroutine of station processing executed at the stations according to the fifth embodiment;

FIG. 40B is a flowchart showing a subroutine of station processing executed at the stations according to the fifth embodiment;

FIG. 41 is a view showing an exemplary image displayed on a front panel display device in a side game according to a sixth embodiment;

FIG. 42A is a view showing an exemplary image displayed on a liquid crystal display included in each of the stations in the side game according to the sixth embodiment;

FIG. 42B is a view showing an exemplary image displayed on a liquid crystal display included in each of the stations in the side game according to the sixth embodiment;

FIG. 43 is a view showing an exemplary image displayed on the front panel display in the side game according to the sixth embodiment;

FIG. 44 is a flowchart showing main control processing executed at a main control unit included in the game machine according to the sixth embodiment;

FIG. 45 is a flowchart showing a subroutine of station processing executed at each of the stations according to the sixth embodiment;

FIG. 46 is a view showing an exemplary image displayed on a front panel display in a side game according to a seventh embodiment;

FIG. 47 is a view showing an exemplary image displayed on the front panel display in the side game according to the seventh embodiment;

FIG. 48 is a view showing an exemplary image displayed on the front panel display in the side game according to the seventh embodiment; and

FIG. 49 is a flowchart showing main control unit processing executed at a main control unit included in a game machine according to the seventh embodiment.

FIG. 50A is a view showing an exemplary image displayed on a liquid crystal display included in a station while in a side game;

FIG. 50B is a view showing an exemplary image displayed on a front panel display while in the side game according to the eighth embodiment;

FIG. 51 is a perspective view schematically depicting a game machine according to the eighth embodiment;

FIG. 52 is a perspective view schematically depicting an appearance and configuration of a station included in the game machine shown in FIG. 51;

FIG. 53 is a view showing an exemplary image displayed on the front panel display included in the game machine according to the eighth embodiment;

FIG. 54 is a view showing an exemplary image displayed on the liquid crystal display included in the station according to the eighth embodiment;

FIG. 55 is a block diagram depicting an internal configuration of the game machine shown in FIG. 51;

FIG. 56 is a block diagram depicting an internal configuration of the station included in the game machine shown in FIG. 51;

FIG. 57 is a view showing an exemplary image displayed on the front panel display of the game machine according to the eighth embodiment;

FIG. 58 is a view showing an example of a progressive payment determination table while in the side game according to the eighth embodiment;

FIG. 59A is a view showing an exemplary image displayed on the liquid crystal display included in the station while in the side game according to the eighth embodiment;

FIG. 59B is a view showing an exemplary image displayed on the liquid crystal display included in the station while in the side game according to the eighth embodiment;

FIG. 60A is an exemplary image displayed on the front panel display while in the side game according to the eighth embodiment;

FIG. 60B is an exemplary image displayed on the front panel display while in the side game according to the eighth embodiment;

FIG. 61A is an exemplary image displayed on the front panel display while in the side game according to the eighth embodiment;

FIG. 61B is an exemplary image displayed on the front panel display while in the side game according to the eighth embodiment;

FIG. 62A is a flowchart showing main control unit processing executed at a main control unit include in the game machine according to the eighth embodiment;

FIG. 62B is a flowchart showing main control unit processing executed at a main control unit include in the game machine according to the eighth embodiment;

FIG. 63A is a flowchart showing a subroutine of station processing executed at the station according to the eighth embodiment; and

FIG. 63B is a flowchart showing a subroutine of station processing executed at the station according to the eighth embodiment.

### DESCRIPTION OF THE PREFERRED EMBODIMENTS

### 1. First Embodiment

Hereinafter, a game machine 1 according to a first embodiment will be described in detail with referring to the drawings. The embodiments that follow describe in detail a case in which a payment is to be paid out according to a combination of cards after dealt to a plurality of players if a trigger for a side game is established according to a plural combinations of cards in a PAIGOW poker while in action.

First, the rules of the PAIGOW poker will be described in detail. In the PAIGOW poker of the embodiments, one or more players compete against a banker with the use of one set of trump cards (52 cards) excluding a joker.

Seven cards are dealt to each of the persons consisting of a banker and the players. Each of them divides seven cards into two groups of five cards and of two cards. At this time, a hand of five cards (a high hand) must be as strong as or must be stronger than that of two cards (a low hand).

Next, it is judged as to which one of the players' hands is strong or weak after comparing the five cards of each of the banker's and players' hands with each other. Similarly, it is judged as to which one of the players' hands is strong or weak after comparing the two cards of each of the banker's and players' hands with each other. In a case where the banker's hands are stronger in both of the two groups of five and two cards, it is judged to be the banker's win. In a case where one of the players' hands is stronger in both of the two groups of five and two cards, it is judged to be the player's win. In a case where the player's hands are stronger in one of the two groups consisting of five cards and two cards, and the banker's hand is stronger in the other one, it is judged to be “draw”. In addition, in a case where the player's hand and the banker's hand are identical to each other in strength with respect to both of the two groups of five and two cards, it is judged to be the banker's win.

The hands of five cards include “Royal Flush”, “Straight Flush”, “Four of a Kind”, “Full House”, “Straight”, “Three of a Kind”, “Two of a Kind”, and “No Pair” in order of strength. The hands of two cards include “One Pair” and “No Pair” in strength.

In addition, in a case where the player's and banker's hands are identical to each other, it is judged as to which one of the players' hands is strong or weak after comparing the numbers or alphabets drawn in cards constituting the hands with each other. The cards' numbers and alphabets include “A”, “K”, “Q”, “J”, “10”, “9”, “8”, “7”, “6”, “5”, “4”, “3”, and “2” in sequential order from the strongest combination of the five cards.

In the embodiments that follow, a PAIGOW poker accepting a normal BET and a side BET is executed. The normal BET is to be performed for the play of the PAIGOW poker, and the side BET is stored in an accumulative manner as a jackpot (hereinafter, referred to as a JP) at a predetermined rate included in a betted currency value (50% in the embodiments of the present invention). The following embodiments describe a case in which a dealer takes over a banker.

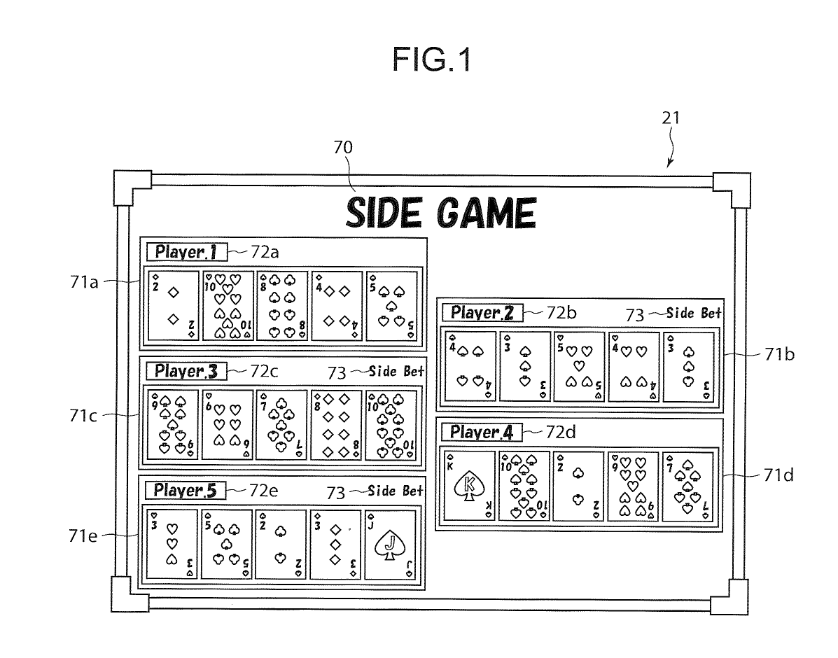

FIG. 1 is a view showing an exemplary image displayed on a front panel display in a side game according to the first embodiment. As shown in FIG. 1, during a basic game, a side game is executed without consuming a gaming value in a case where a predetermined condition is met during the basic game. In addition, five cards are dealt to respective ones of a plurality of players from among plural kinds of cards, and the dealt cards are displayed on the front panel display 21 in a state in which the kinds of cards possessed by the plurality of players are identifiable. Card images 71a to 71e dealt to players 1 to 5 are displayed, respectively, and player display sections 72a to 72e are displayed indicating that five players 1 to 5 are performing a sub-game. Further, a side BET display image 73 is displayed for players having accepted side BETs, and then, a payment is determined and paid out according to a combination of cards included in the five cards possessed by the players, the cards being displayed on the front panel display 21.

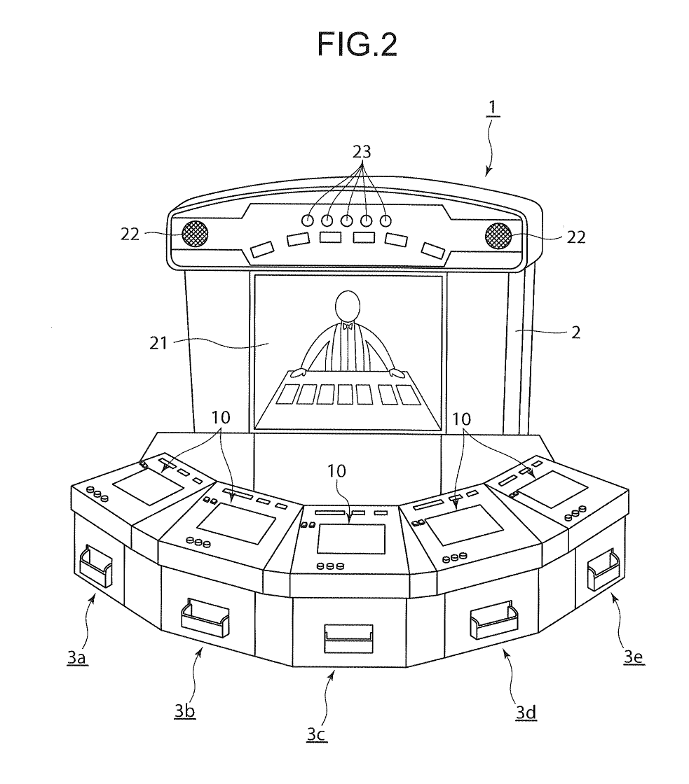

FIG. 2 is a perspective view schematically depicting an appearance and a configuration of the game machine according to the first embodiment of the present invention. As shown in FIG. 2, the game machine 1 is basically made up of a main monitor 2 and five stations 3 (stations 3a to 3e). While the present embodiment describes in detail a case in which the game machine 1 is provided with a plurality of stations 3 (five stations), the game machine may include over five stations in the present invention.

A front panel display 21 is provided at the center part of a main monitor 2, and an image indicative of a dealer and cards is displayed. The front panel display 21 is equivalent to a display device of the present invention. In addition, provided at the upper side of the main monitor 2 are: a speaker 22 for outputting music or effect sounds in accordance with the progress of a game executed by the game machine 1; and an LED23 that is lit at the time of various effects.

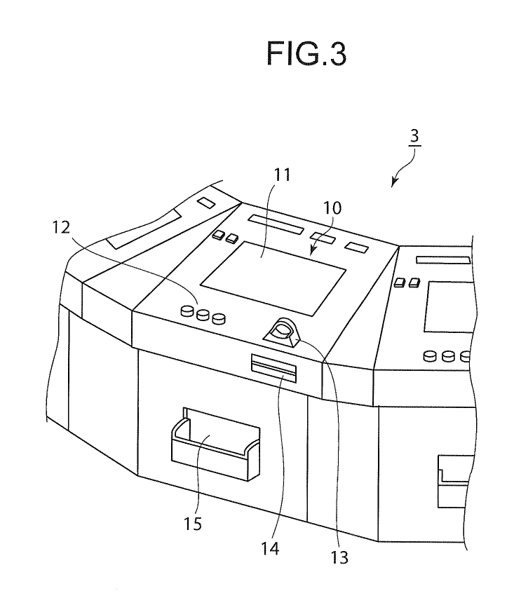

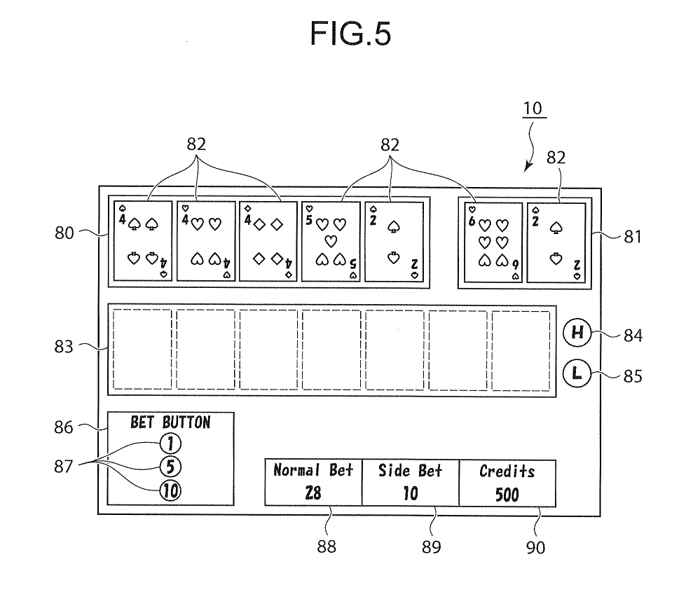

FIG. 3 is a perspective view schematically depicting an appearance and a configuration of stations included in the game machine shown in FIG. 2. As shown in FIG. 3, a liquid crystal display 10, which displays an image or the like pertinent to operation (see FIG. 5), as described later, is provided at the upper center of a station 3. In addition, a touch panel 11 for inputting operations such as BET is provided on the upper face of the liquid crystal display 10. The touch panel 11 is equivalent to a normal BET switch, a side BET switch, and an input switch, according to the present invention. The touch panel is equivalent to a BET switch, a side-BET switch, and an input switch, of the present invention.

An operational button 12 for making payout operation and a coin insertion slot 13 for inserting coins or medals are provided in front of the liquid crystal display 10. A bill insertion slot 14 for inserting bills is provided at the front top right end of the station 3. Provided downwardly of the bill insertion slot 14 is a coin payout opening 15 through which the coins or medals corresponding to stored credit are paid out to the players when payout operation is made.

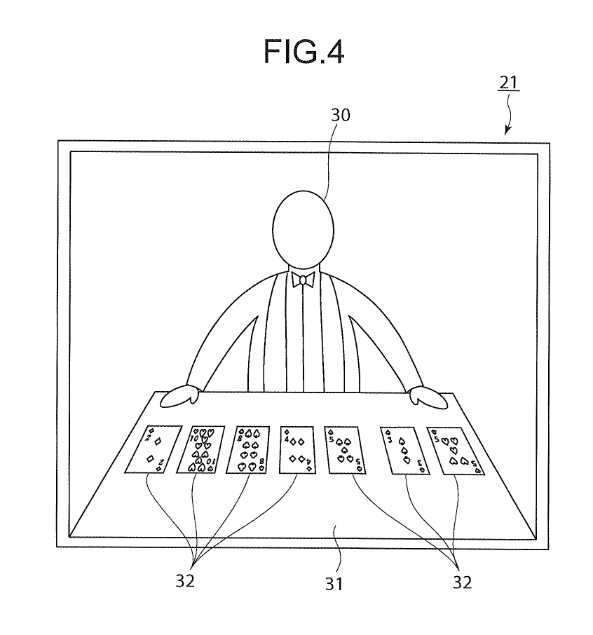

FIG. 4 is a view showing an exemplary image displayed on a front panel display included in a game machine. As shown in FIG. 4, the front panel display 21 displays a dealer image 30 which is indicative of a dealer (banker), a table image 31 which is indicative of a table, and a card image 32 which is indicative of seven banker's cards. The card image 32 is displayed in a faced down manner when cards are dealt to the dealer. When a high hand and a low hand are determined, the card image 32 is displayed in a faced up manner. In FIG. 4, the left five cards toward the banker indicate a high hand, and the right two cards indicate a low hand.

FIG. 5 is a view showing an exemplary image displayed on a liquid crystal display included in each of stations. As shown in the figure, a high hand display section 80, which displays a player's high hand, and a low hand display section 81, which displays a low hand, are provided at the upper side of the liquid crystal display 10. The high hand display section 80 and the low hand display section 81 display card images 82 indicative of a high hand card and a low hand card, respectively, in a faced up manner.

A dealt-card display section 83 is provided at the lower side of the high hand display section 80. A card image indicative of the seven player's cards after dealt to each of the players is displayed in a faced up manner at seven portions enclosed by the dotted line of the dealt-card display section 83. A high hand determination button 84 and a low hand determination button 85, for determining cards constituting a high hand and a low hand, are provided at the right side of the dealt-card display section 83. A player can determine a high hand by selecting a card desired to be high hand, via a touch panel 11, from among the cards displayed at the dealt-card display section 83, and then, operating the high hand determination button 84. The card determined to be a high hand is displayed at the high hand display section 80. Similarly, the player determines a low hand by selecting a card desired to be a low hand, via the touch panel 11, from among the cards displayed at the dealt-card display section 83, followed by operating a low hand determination button 85 via the touch panel 11.

A BET button display section 86 is provided at the lower side of the dealt-card display section 83. The BET button display section 86 displays a BET button 87 for inputting a BET number. The player can input a normal BET number and a side BET number by operating a BET button 87 via the touch panel 11.

A BET number display section 88, which displays the number of normally betted coins, is provided at the right side of the BET button display section 86. Here, it is shown that 28 coins have been betted. Where a BET of the 28 coins is input, the player may operate “10” of the BET buttons 87 twice, “5” of the BET buttons 87 once, and “1” of the BET buttons 87 three times.

A side BET number display section 89, which displays the number of side-betted coins, is provided at the right side of a normal BET number display section 88. Here, it is shown that 10 coins have been betted. At the right side of the side BET display section 89, further, a credit amount display section 90 is provided. Here, it is shown that 500 coins are credited.

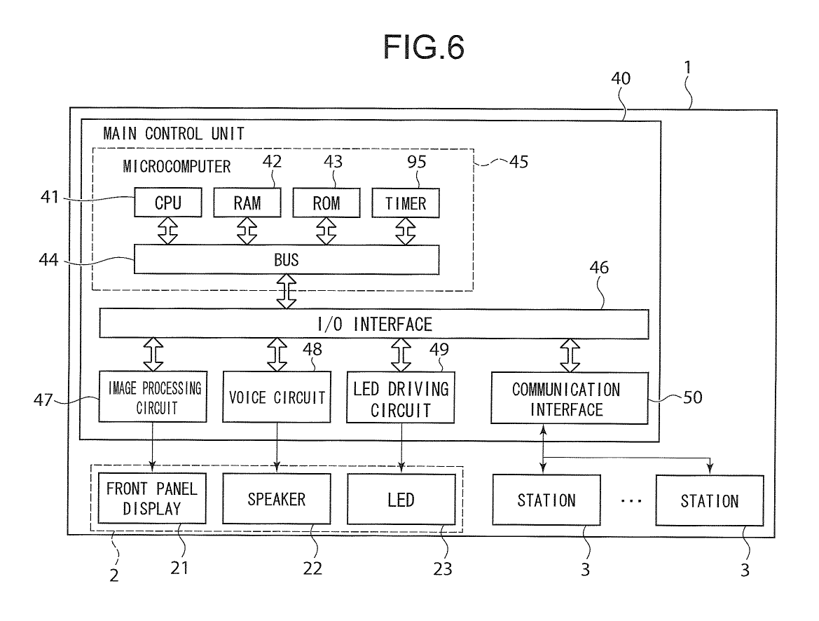

FIG. 6 is a block diagram depicting the game machine shown in FIG. 2. As shown in FIG. 6, a main control unit 40 included in the game machine 1 is basically constituted while a microcomputer 45 made up of: a CPU (Central Processing Unit) 41; a RAM (Random Access Memory) 42; a ROM (Read Only Memory) 43; a timer 95; and a bus 44 for transferring data therebetween is employed as a base. The main control unit 40 is equivalent to a controller of the present invention.

The ROM43 stores a variety of programs or data tables and the like, for performing processing required for controlling the game machine 1. The RAM42 is a memory for temporarily storing a variety of data computed by the CPU41. In addition, a timer 95 performs time measurement.

The CPU41 is connected via an I/O interface 46 to an image processing circuit 47, a voice circuit 48, an LED driving circuit 49, and a communication interface 50.

A front panel display 21 constituting a main monitor 2 is connected to the image processing circuit 47; a speaker 22 constituting the main monitor 2 is connected to the voice circuit 48; and the LED23 constituting the main monitor 2 is connected to the LED driving circuit 49. Five stations 3 are connected to the communication interface 50.

The CPU41 controls games (a PAIGOW poker and a side game) to be conducted in the game machine 1, based upon game programs (a PAIGOW poker game program and a side-game program) stored in the ROM43 and various signals received from the stations 3. Further, the CPU41 controls the front panel display 21 to display an image, the speaker 22 to output sounds, and the LED23 to light up based upon the above-mentioned game programs. In addition, the CPU41 transmits various signals to each of stations 3, based upon the above-mentioned game programs.

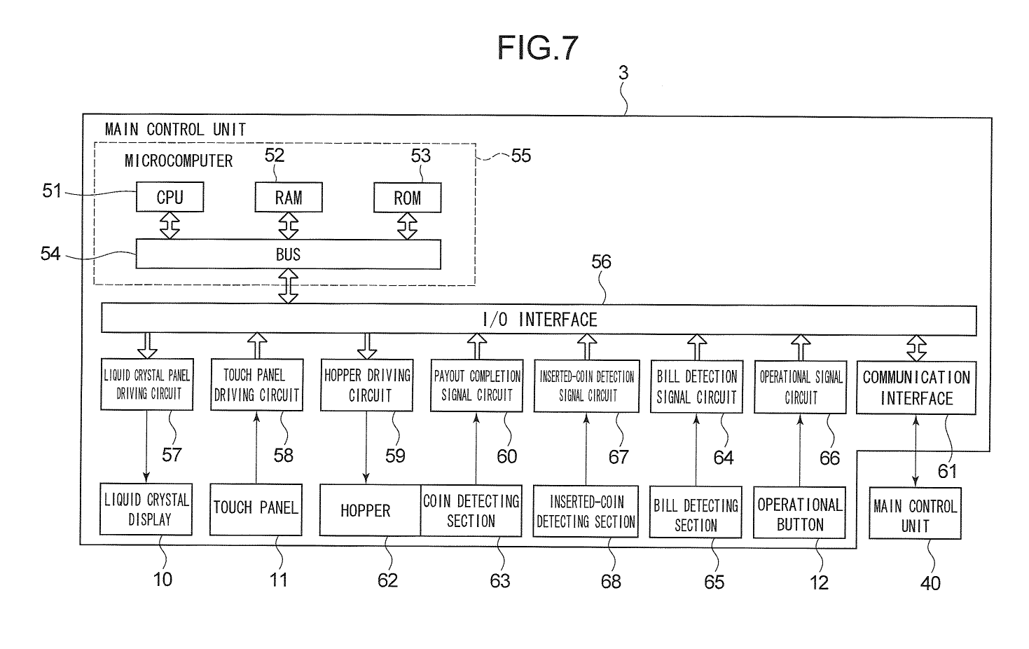

FIG. 7 is a block diagram depicting an internal configuration of the station included in the game machine shown in FIG. 2. As shown in FIG. 7, the station 3 is basically constituted while the CPU51, the RAM52, the ROM53, and the bus 54 for transferring data therebetween are employed as a base.

The ROM53 stores a variety of programs and data tables or the like, for performing processing required for controlling stations 3. In addition, the RAM52 temporarily stores the credit amount currently stored in stations 3 and a variety of data computed by the CPU51.

Furthermore, the CPU51 is connected, via an I/O interface 56, to a liquid crystal panel driving circuit 57; a touch panel driving circuit 58; a hopper driving circuit 59; a payout complete signal circuit 60; an inserted-coin detection signal circuit 67; a bill detection signal circuit 64; an operation signal circuit 66; and a communication interface 61.

The liquid crystal display 10 is connected to the liquid crystal panel driving circuit 57; the touch panel 11 is connected to the touch panel driving circuit 58; a hopper 62 is connected to a hopper driving circuit 59; a coin detecting section 63 is connected to the payout complete signal circuit 60; an inserted-coin detecting section 68 is connected to the inserted-coin detection signal circuit 67; a bill detecting section 65 is connected to the bill detection signal circuit 64; and the operational button 12 is connected to the operation signal circuit 66, respectively.

The hopper 62 is provided inside the station 3 and serves to pay out coins from the coin payout opening 15, based upon a control signal output from the CPU51. The coin detecting section 63 is provided inside the coin payout opening 15, and transmits signals to the CPU51 in a case where it is detected that a predetermined number of coins have been paid out from the coin payout opening 15.

Upon detecting that coins have been inserted through the coin insertion slot 13, the inserted-coin detecting section 68 detects the amount of the detected coins, and then, transmits to the CPU51a detection signal indicative of the detected amount. The detected coins are stored in the RAM52 while a predetermined amount is handled as one credit.

At the time of acceptance of bills, the bill detecting section 65 detects the amount of the accepted bills, and then, transmits to the CPU51a detection signal indicating the detected amount. The detected bills are stored in the RAM52 while the predetermined amount is handled as one credit. The operation button 12 is intended for performing payout operation in a case where coin payout has been determined.

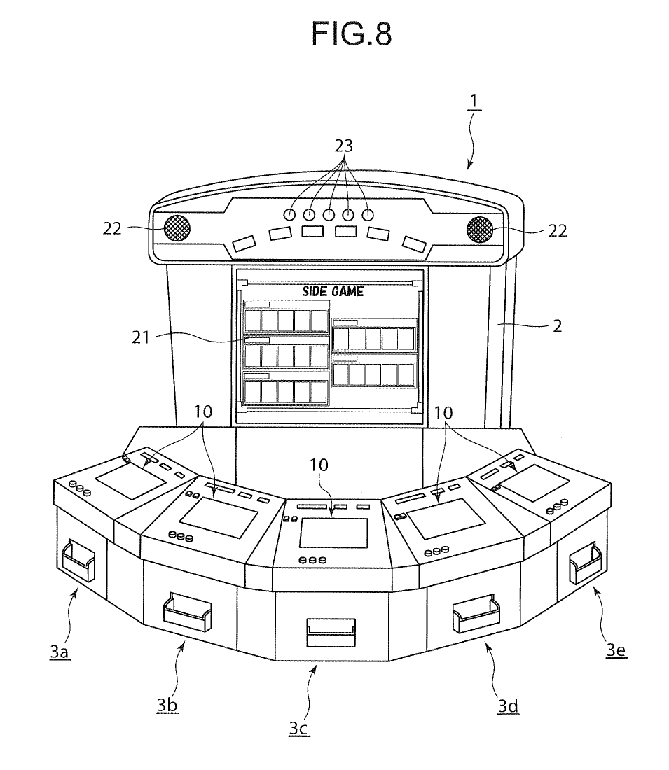

FIG. 8 is a view showing an exemplary image displayed on the front panel display of the game machine according to the first embodiment. As shown in FIG. 8, the game machine 1 is made up of the main monitor 2 and the five stations 3 (3a to 3e). When a side game is started, the display 21 at the center of the main monitor 2 displays on the liquid crystal display 10 the side game dealt cards dealt to the players staying at the stations 3 (3a to 3e). Further, the front panel display 21 displays the side game dealt cards dealt to the players staying at all of the stations 3a to 3e, and a payment is paid out to the players staying at the stations 3 (3a to 3e) according to a combination of the cards displayed on the front panel display 21.

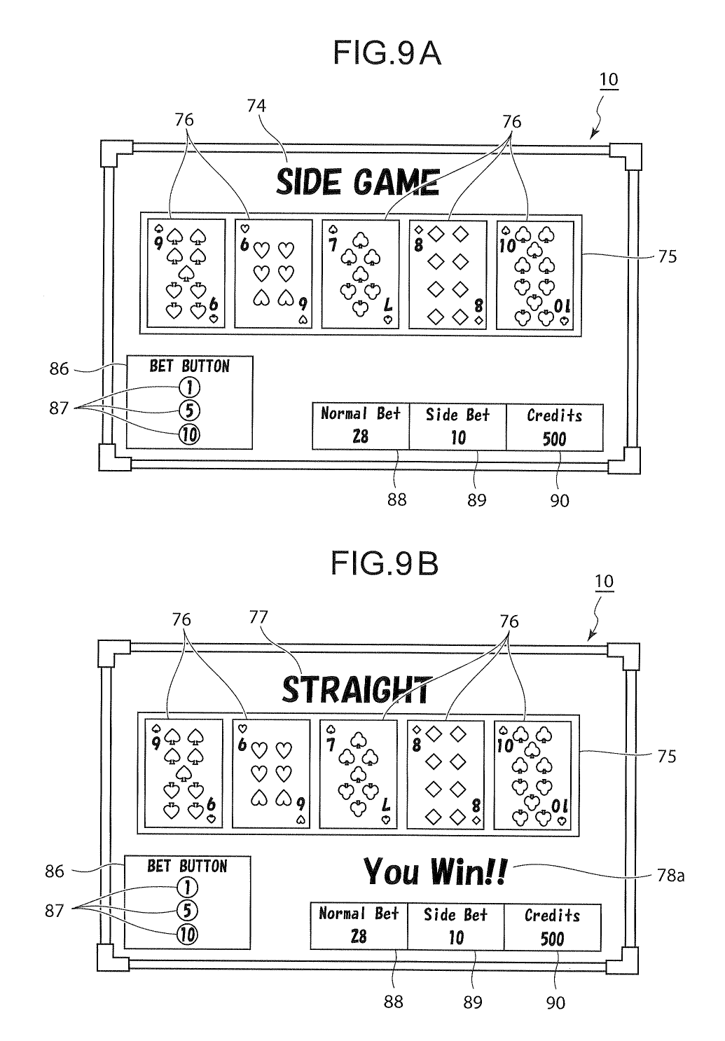

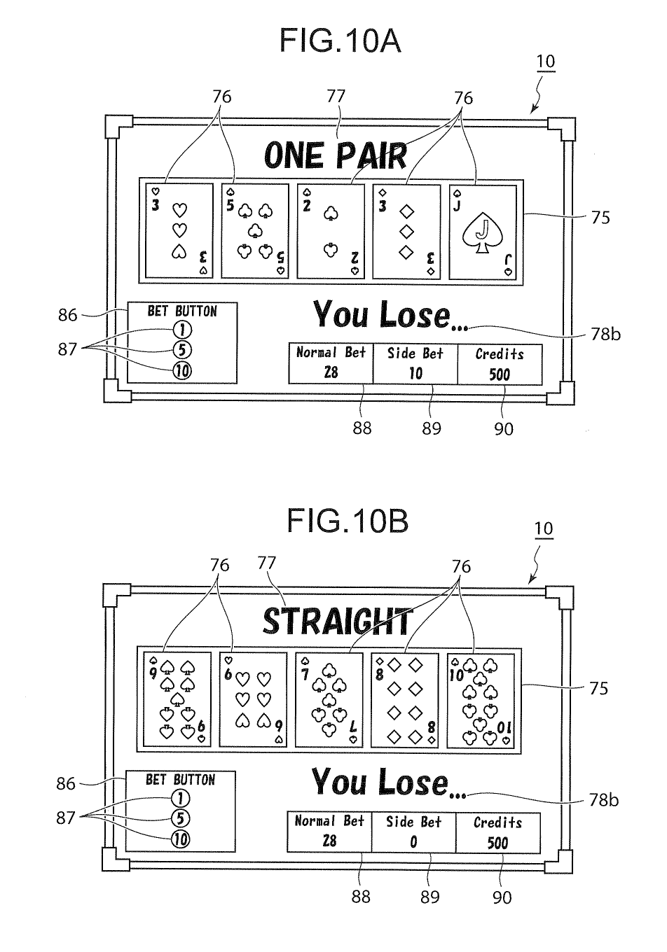

FIGS. 9 and 10 are views each showing an exemplary image displayed on a liquid crystal display included in each of the stations in a side game according to the first embodiment. As shown in FIG. 9A, when a side game is started, the liquid crystal display 10 displays a side game display image 74 which is indicative of the fact that the side game has been started. Further, the side game dealt-card display section 75 displays the side game cards 76 dealt at the time when the side game has been started. Here, it is assumed that the above display device displays the fact that the five cards “9 of spade”, “6 of heart”, “7 of club”, “8 of diamond”, and “10 of club” have been dealt. Further, the BET button display section 86 is displayed at the lower side of the side game dealt-card display section 75. At the lower side of the side game dealt-card display 75, further, a normal BET number 88, a side BET number display section 89, which displays the number of side-betted coins, and a credit amount display section 90 are provided. In this case, 28 coins are normally betted, ten coins are side-betted, and 500 coins are credited.

As shown in FIG. 9B, where the dealt cards are realized as a predetermined combination, the liquid crystal display 10 displays a combination display image 77 which indicates a card combination. Here, the side game dealt-card display section 75 displays side-game cards “9 of heart”, “6 of heart”, “7 of club”, “8 of diamond”, and “10 of club”, so that a combination display image 77, which is indicative of a card combination “Straight,” is displayed. Further, when a winner or loser is determined by comparing the cards of the players at all of the stations 3a to 3e, the winner-loser information display section 78a is displayed. Because the card combination “Straight” was strongest among the players at all of the stations 3a to 3e, the winner-loser information display section 78a, which is inclusive of a message “You Win”, is displayed, and then, the payment determined by comparing the plurality of cards possessed by the players is paid out.

At the lower side of the side game dealt-card display section 75, a normal BET number display section 88; a side BET number display section 89, which displays the number of side-betted coins; and a credit amount display section 90 are provided. In this case, 28 coins are normally betted, ten coins are side-betted, and 500 coins are credited.

As shown in FIG. 10A, where the dealt cards are realized as a predetermined combination, the liquid crystal display 10 displays a combination display image 77 which displays a card combination. Since the side game dealt-card display section 75 displays the side game cards 76, “3 of heart”, “2 of club”, “3 of diamond”, and “Jack of spade”, a combination display image 77, which is indicative of “One Pair”, is displayed. Further, if a winner or loser is determined by comparing the cards of the players staying at all of the stations 3a to 3e, the winner-loser information display section 78b is displayed. Here, because the card combination “straight” was the strongest among the players at all of the stations 3a to 3e, the winner-loser information display section 78b, which is inclusive of a message “You Lose”, is displayed. At the lower side of the side game dealt-card display 75, further, a normal BET number display 88; a side BET number display section 89, which displays the number of side-betted coins; and a credit amount display section 90 are provided. In this case, 28 coins are normally betted, ten coins are side-betted, and 500 coins are credited.

As shown in FIG. 10B, where the dealt cards are realized as a predetermined combination, the liquid crystal display 10 displays a combination display image 77 which displays a card combination. Here, the side game dealt-card display section 75 displays side game cards 76 “9 of spade”, “6 of heart”, “7 of club”, “8 of diamond”, and “10 of club”, so that the combination display image 77, which is indicative of “Straight”, is displayed. At the lower side of the side game dealt-card display section 75, further, a normal BET number display section 88, a side BET number display section 89, which displays the number of side-betted coins, and a credit amount display section 90 are provided. Here, 28 coins are normally betted, no coin is side-betted, and 500 coins are credited. Further, when a winner or loser is determined by comparing the cards of the players at all of the stations 3a to 3e, the winner-loser information display section 78b is displayed. Although a winning combination “Straight” was the strongest among the players at all of the stations 3a to 3e, the side BET number display section 89 displays 0, and no side BET is performed. Therefore, the payment determined by comparing a plurality of cards possessed by the players is not paid out, and the winner-loser information display 78b, which is inclusive of a message “You Lose”, is displayed.

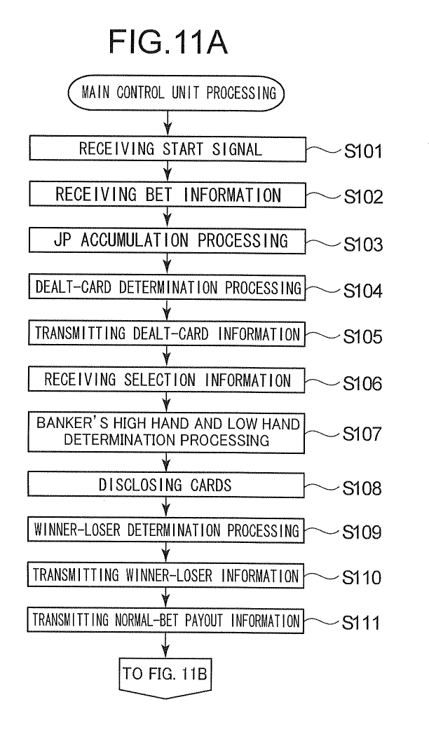

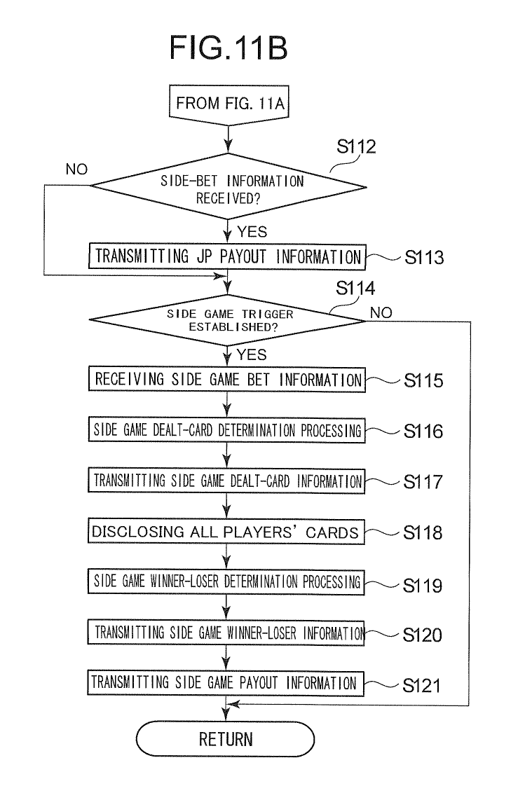

Next, the processing operations performed at the main control unit 40 and the station 3 will be described in detail. FIGS. 11A and 11B are flowcharts each showing main control processor processing executed at the main control unit included in the game machine according to the first embodiment. In this processing operation, at first, the CPU41 included in the main control unit 40 receives a start signal (step S101). Specifically, the CPU41 receives a start signal from any of the stations 3. The start signal is obtained when it is triggered for conducting a PAIGOW poker game in the game machine 1.

Next, the CPU41 receives BET information from a station 3 (see FIG. 2) (step S102). BET information is pertinent to BET, and is inclusive of: information which is indicative of whether or not a normal BET and a side BET have been performed; or information which is indicative of the amounts of a normal BET and a side BET.

Next, the CPU41 executes JP accumulation processing (step S103). Specifically, the CPU41 accumulatively stores, in the RAM42 (see FIG. 6), 50% (predetermined rate) of the side-betted credit as JP, based upon the BET information received at step S102.

Next, the CPU41 executes dealt-card determination processing (step S104). In this processing operation, the CPU41 determines seven cards to be dealt to each of the persons consisting of the players and banker from among one set of trump cards, with the use of random numbers. The seven cards determined to be dealt to the players at the step S104 are equivalent to the player's cards, and the seven cards determined to be dealt to the banker are equivalent to the banker's cards. Further, the front panel display 21 (see FIG. 2) included in the game machine 1 displays a card image indicative of the seven banker's cards in a faced down manner.

Next, the CPU41 transmits dealt-card information (step S105). Specifically, the CPU41 transmits the dealt-card information to the station 3. The dealt-card information is inclusive of information inclusive of kinds of cards determined to be dealt to the players and the banker (numbers or alphabets and suits (heart, clover, spade, and diamond). At each of the stations 3, the liquid crystal display 10 displays the card image which is indicative of the seven player's cards, based upon the received dealt-card information, and then, accepts entry for dividing them into a group of 5 cards (high hand) and a group of two cards (low hand).

Next, the CPU41 receives selection information from the station 3 (step S106). The selection information indicates which one of the cards dealt to the players has been selected as a high hand, and which one of the cards have been selected as a low hand.

Next, the CPU41 executes processing of determining a banker's high hand and low hand (step S107). In this processing operation, the CPU41 executes processing of dividing the cards dealt to the banker into a high hand and a low hand.

Next, the CPU41 discloses cards (step S108). Specifically, the CPU41 displays in a faced up manner on the front panel display 21 the card images indicative of the high hand and the low hand determined at the step S106.

Next, the CPU41 performs winner-loser determination processing (step S109). In this processing operation, the CPU41 executes processing of determining a winner or loser, based upon the selection information received at the step S106, and the high hand and the low hand determined at step S107. Namely, this CPU executes processing of determining a winner or loser after comparing the players' hands of the cards after dealt to the players and the banker's card hands. Specifically, it is judged as to which one of the players' hands is strong or weak after comparing the players' high hands with the banker's high hand. In addition, it is also judged as to which one is strong or weak after comparing the players' low hands with the banker's low hand. Further, the winner or loser is determined based upon the judgment results. Specifically, in a case where the player's high hand is stronger than the banker's high hand and in a case where the player's low hand is stronger than the banker's low hand, it is judged to be the player's win. In a case where the banker's high hand is stronger than the player's high hand and in a case where the banker's low hand is stronger than the player's low hand, it is judged to be the banker's win. Even if the player is stronger at one of the high and low hands, in a case where the banker is stronger at the other one, it is judged to be “draw”.

Next, the CPU41 transmits winner-loser information (step S110). Specifically, the CPU41 transmits to the station 3 the information indicative of the winner or loser determined at the step S109 (hereinafter, referred to as winner-loser information). Upon the receipt of the winner-loser information, based upon the received winner-loser information, the liquid crystal display 10 displays any one of the images inclusive of messages “You Win”, “You Lose”, and “Draw”.

Next, the CPU41 performs processing of transmitting normal-BET payout information (step S111). In this processing operation, the CPU41 transmits the normal-BET payout information to the station 3. The normal-BET payout information is generally indicative of an amount of credit (currency values) to be paid out to a normal BET. Specifically, in a case where the player has won, this CPU transmits information indicative of credit of which amount is twice of that of normal BET. In a case where the outcome of the game is “draw”, the CPU transmits information indicative of credit of which amount is equal to that of normal BET. In addition, in a case where the banker has won, the CPU transmits information indicative of the fact that an amount of given credit is 0.

Next, in FIG. 11B, the CPU41 judges whether or not a side BET signal has been received (step S112). Specifically, the CPU41 judges whether or not a signal has been received indicative of the fact that the side BET has been performed. When the CPU41 judges that no side BET signal has been received (step S112: NO), the routine proceeds to step S114.

On the other hand, when it is judged that a side BET signal is received (step S112: YES), JP payout information is transmitted to the station 3 (step S113). The JP payout information is indicative of the amount of JP credit (currency value) to be paid out in response to the side BET. Specifically, where a player has won against the banker owing to a winning combination “Royal Flush” at high hand, the information, which is indicative of the credit equivalent to the total amount of JP, is transmitted; where a winning combination “Straight Flush” is realized at the player's high hand, the information, which is indicative of the credit equivalent to 50% of JP, is transmitted; and where any other combination is realized at the player's high hand, the information, which is indicative of the credit equivalent to 10% of JP, is transmitted. In addition, in the case where the result is “draw”, this CPU transmits information which is indicative of a credit of which amount is equal to that of a side BET. Moreover, in a case where the banker has won, this CPU transmits the fact that the amount of credit given is 0.

While the embodiment of the present invention describes a case in which, when the player has won in a PAIGOW poker at the time of a side BET, where a winning combination of the player's cards at high hand is realized as a “Royal Flush”, 100% of JP is given; where it is realized as a “Straight Flush”, 50% of JP is given; and where it is realized as any other combination, 10% of JP is given. In the embodiment of the present invention, a correspondence relationship between the amount of JP given and a hand is not limitative thereto.

While the embodiment of the present invention described a case in which a correspondence relationship between the player's hand in the PAIGOW poker at the time of a side BET and a payment (JP) to be paid out is preset, a correspondence relationship between the player's hand and the payment to be paid out may be randomly changed every time the PAIGOW poker is performed at the time of a side BET.

Further, while the embodiment of the present invention describes a case of paying out credit of which amount is equal to that of side BET in a case where the result is “draw”, the above payout of the credit may not be performed.

Next, the CPU41 judges whether or not a side game trigger is established (step S114). Specifically, the CPU41 executes the programs stored in the RAM42, thereby sampling random number values from among the numeric range of the predetermined random number values. The CPU41 terminates main control unit processing when it executes the processing of step S114 upon judging that a side game trigger has not been established (step S114: NO).

On the other hand, upon judging that a side-game trigger has been established (step S114: YES), the CPU41 receives side-game BET information from the station 3 (see FIG. 2) (step S115).

Next, the CPU41 executes processing of determining dealt cards in a side game (step S116). In this processing operation, from among one set of trump cards, the CPU41 determines five cards to be dealt to each of the players.

Next, the CPU41 transmits information on cards to be dealt in the side game (step S117). Specifically, the CPU41 transmits the side game dealt-card information to the station 3. The side game dealt-card information is inclusive of information which is indicative of the kinds (numbers or alphabets and suits (heart, club, spade, and diamond) of the cards determined to be dealt to the players. The side game dealt-card information includes information indicative of suits (heart, club, spade, and diamond) of the cards determined to be dealt to the players. At the station 3, based upon the received dealt-card information, the liquid crystal display 10 displays a card image indicative of the five player's cards.

Next, the CPU41 discloses all the players' cards (step S118). Specifically, the CPU41 displays, in a faced up manner on the front panel display 21 on a player-by-player basis, the five-card images of the players' cards determined at step S116.

Next, the CPU41 performs side game winner-loser determination processing (step S19). In this processing operation, the CPU41 executes processing of determining a winner or loser, based upon the side game cards possessed by all of the players disclosed at step S118. Specifically, it is judged as to which one of the players' hands is strong or weak after comparing all of the players' cards, and a winner or loser is determined based upon the judgment result. Here, any one of the predetermined combinations is realized in the five players' cards, it is judged as to which combination of respective ones of the players' cards is strong or weak. The predetermined combinations designate “Royal Flush”, “Straight Flush”, “Four of a Kind”, “Full House”, “Flush”, “Three of a Kind”, “Two Pairs”, “One Pair”, and “No Pair” in sequential order from the strongest combination of the five cards.

Next, the CPU41 transmits side game winner-loser information (step S120). Specifically, the CPU41 transmits the station 3 the winner-loser information which is indicative of the winner or loser in the side game determined at step S119. The station 3 displays any one of the images inclusive of the messages “You Win”, “You Lose”, and “Draw” on the liquid crystal display 10, based upon winner-loser information, upon the receipt of the winner-loser information (see FIGS. 9B and 10).

Next, the CPU41 transmits the side game payout information to the station 3 (step S121). The side game payout information is indicative of the quantity of the credit (currency value) paid out to the side game. Specifically, the CPU41 transmits information which is indicative of the credit determined based upon the winning combinations “Royal Flush”, “Straight Flush”, “Four of a Kind”, “Full House”, “Flush”, “Three of a Kind”, “Two Pairs”, “One Pair”, and “No Pair”. Here, this CPU transmits payout information by determining any one of the cases of: paying out the payment determined by comparing the plurality of cards possessed by the players; making a payout for the player who has entered a side BET; distributing and paying out the payment among the players who has entered the side BET; and distributing and paying out the payment among all of the players who has entered the side BET. The CPU41 terminates main control unit processing when executing the processing at step S121.

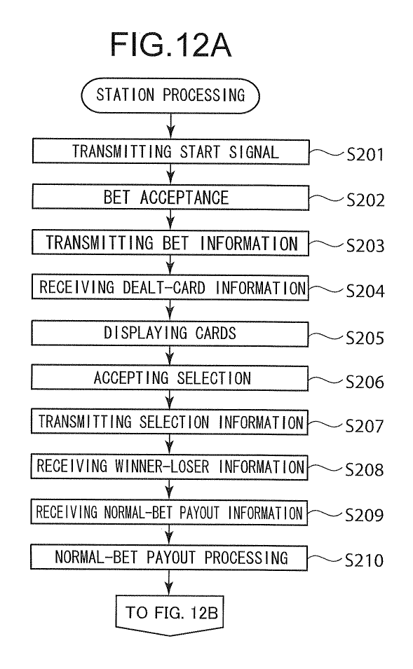

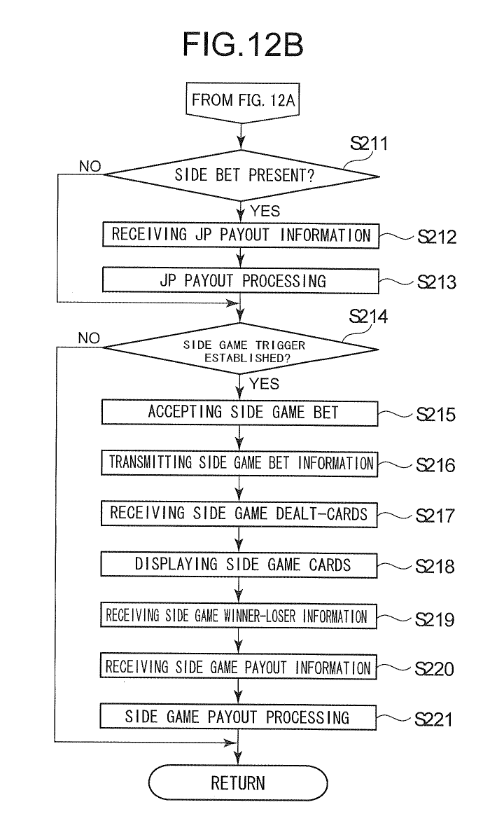

Next, the processing performed at the station 3 will be described in detail. FIGS. 12A and 12B are flowcharts each showing a subroutine of the station processing executed at the station, according to the first embodiment. In this processing operation, at first, the CPU51 included in the station 3 transmits a start signal to the main control unit 40 upon the receipt of signal indicative of the fact that a touch from the touch panel 11 has been sensed or that coin insertion has been detected from the entered-coin detecting section 68 (step S201). In this manner, at the main control unit 40, the processing operations shown in FIGS. 11A and 11B are conducted.

Next, the CPU51 accepts entries of the normal BET and side BET (step S202). This allows the player to enter the normal BET and the side BET via the touch panel 11 included in the station 3. Upon the receipt of a signal indicative of the fact that entry of the side BET has been made, the CPU51 sets a side-BET flag. This side-BET flag is set in a case where entry of the side BET has been made.

Next, the CPU51 transmits to the main control unit 40, BET information serving as information pertinent to an input BET (step S203). Upon the receipt of the BET information, the main control unit 40 determines cards to be dealt to the players and the banker (see step S104 of FIG. 11A).

Next, the CPU51 receives from the main control unit 40 the dealt-card information indicative of the cards dealt to the players (step S204). Specifically, the CPU51 receives the dealt-card information transmitted at step S105 of FIG. 11A.

Next, the CPU51 displays cards (step S205). Specifically, the CPU51 displays a card image indicative of the seven player's cards at the dealt-card display section 83 of the liquid crystal display 10, based upon the dealt-card information received at step S204.

Next, the CPU51 accepts entry for selecting high hands and low hands (step S206). This allows the players to determine high hands and low hands from among the dealt cards by operating high hand determination button 84 and a low hand determination button 85 via the touch panel 11.

Next, the CPU51 transmits to the main control unit 40 the selection information that is based upon selection of high hands and low hands (step S207). Upon the receipt of the selection information, the main control unit 40 determines a high hand and a low hand of the banker's cards, and then, executes processing of determining a winner or loser (see step S109 of FIG. 11A).

Next, the CPU51 receives winner-loser information from the main control unit 40 (step S208). Subsequently, the dealt-card display section 83 of the liquid crystal display 10 displays any one of the images inclusive of the messages “You Win”, “You Lose”, and “Draw”, during a predetermined period of time, based upon the received winner-loser information.

Next, the CPU51 receives normal-BET payout information from the main control unit 40 (step S209). Upon the receipt of the normal-BET payout information, the CPU51 stores in the RAM52 the credit data that is based upon the normal-BET payout information.

Next, the CPU51 receives normal-BET payout information, based upon the normal-BET payout information received at step S209 (step S210). In this normal-BET payout processing, in a case where a player has won, payout is performed, based upon information indicative of a credit of which amount is twice of that of the normal BET; and in a case where the result is “draw”, payout is performed, based upon information indicative of a credit of which amount is equal to that of the normal BET. In addition, in a case where the banker has won, information indicative of the fact that the amount of credit to be given is 0 is displayed.

Next, in FIG. 12B, the CPU51 judges whether or not entry of side BET has been made, while in the BET acceptance at step S202 (step S211). Specifically, the CPU51 judges whether or not a side-BET flag is set. When the CPU51 judges that entry of the side BET has not been made (step S211: NO), the routine proceeds to step S214.

On the other hand, upon judging that entry of the side BET has been made (step S211: YES), the CPU51 receives JP payout information (step S212). Specifically, the CPU51 receives JP payout information from the main control unit 40. Upon the receipt of JP payout information, the CPU51 stores in the RAM52 the credit data that is based upon the JP payout information.

Next, the CPU51 executes JP payout processing (step S213). Specifically, the CPU51 pays out credit, based upon the JP payout information received at step S212.

Next, the CPU51 judges whether or not a side game trigger has been established (step S214). Specifically, the CPU51 judges whether or not a side game trigger has been established at the main control unit 40. Upon judging that no side game trigger has been established (step S214: NO), the CPU51 terminates station processing.

On the other hand, upon judging that the side-game trigger has been established (step S214: YES), the CPU51 accepts entry of normal BET and side BET for the side game (step S215). In this manner, the player can enter the normal BET and the side BET in the side game via the touch panel 11 included in the station 3.

Next, the CPU51 transmits to the main control unit 40 the BET information pertinent to BETs for the entered side game (step S216). Upon the receipt of side-game BET information, the main control unit 40 determines the side game dealt cards to the players (see step S116 of FIG. 11A).

Next, the CPU51 receives from the main control unit 40 the side game dealt-card information which is indicative of the cards dealt to the player in the side game (step S217). Specifically, the CPU51 receives the dealt-card information transmitted at step S117 of FIG. 11B.

Next, the CPU51 displays side-game cards (step S218). Specifically, the CPU51 displays the card image which is indicative of the five player's cards at the dealt-card display section 83 of the liquid crystal display 10, based upon the side game dealt-card information received at step S217.

Next, the CPU51 receives side game winner-loser information from the main control unit 40 (step S219). Then, the dealt-card display section 83 of the liquid crystal display 10 displays any one of the images inclusive of the messages “You Win”, “You Lose”, and “Draw”, during a predetermined period of time, based upon the received winner-loser information.

Next, the CPU51 receives side-game payout information (step S220). Upon the receipt of the side game payout information, the CPU51 stores in the RAM52 the credit data that is based upon the side game payout information.

Next, the CPU51 executes side game payout processing, based upon the side game payout information received at step S220 (step S221). In this processing operation, the CPU receives payout information, based upon the information determined in any one of the cases of: paying out the payout determined by comparing a plurality of cards possessed by the players; paying out the payment to the player having entered the side BET; and distributing and paying out the payment among all of the players having entered the side BETs. The CPU51 terminates station processing when terminating this processing.

### 2. Second Embodiment

Next, the game machine 1 according to a second embodiment will be described in detail with referring to the drawings. The game machine 1 according to the second embodiment that follows has an appearance and a circuit construction or the like, which are substantially similar to those according to the first embodiment of the present invention. Thus, a duplicate description of like construction is omitted here. Also, like constituent elements corresponding to those of the game machine 1 are designated by like reference numerals and are explained.

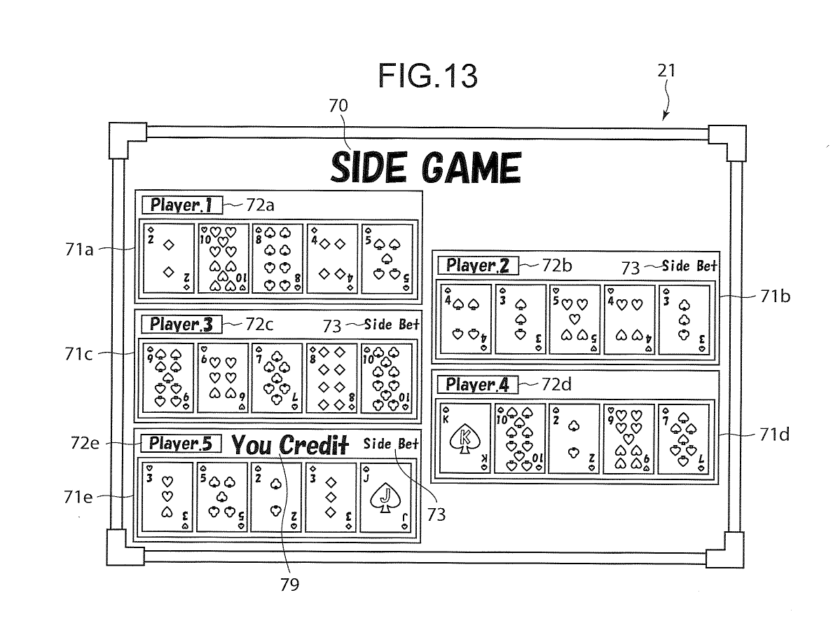

FIG. 13 is a view showing an exemplary image displayed on a front panel display in a side game according to the second embodiment. As shown in FIG. 13, when a side game is started, a side-game display image 70 is displayed which is indicative of the commencement of the side game. Further, five cards are dealt to the plurality of players, and the front panel display 21 displays the cards after dealt to the plurality of players. Card images 71a to 71e dealt to players 1 to 5 respectively, and player display sections 72a to 72e are displayed which are indicative of the fact that the five players 1 to 5 are performing a side game.

Further, a side-BET display image 73 is displayed for the players having accepted side BETs. At the upper right of the card image 71 of the players 2, 3, and 5 having accepted side BET, the side-BET display image 73 is displayed to make identifiable the players having performed a side BET. From among the players 2, 3, and 5 having accepted a side BET, further, a credit display image 79 is displayed over any of the card images. Here, the credit display image 79, which is inclusive of a message “You Credit”, is displayed over the card image 71e of the player 5.

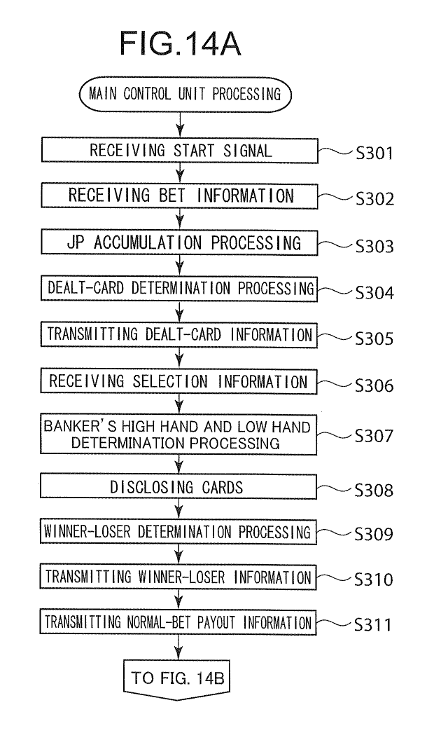

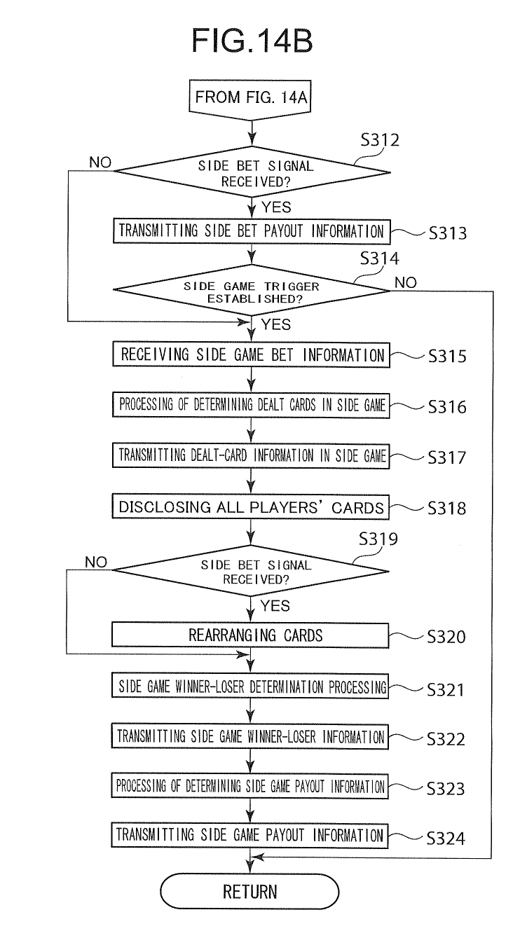

Next, the processing operations performed at the main control unit 40 and the station 3 will be described in detail. FIGS. 14A and 14B are flowcharts each showing main control unit processing executed at the main control unit included in the game machine according to the second embodiment. In this processing operation, at first, the CPU41 included in the main control unit 40 receives a start signal (step S301). After that, the processing operations of steps S302 to S311 are performed. These processing operations are not described here, since they are identical to those of steps S101 to S111 shown in FIG. 11A.

Next, in FIG. 14B, the CPU41 judges whether or not a side-BET signal has been received (step S312). Specifically, this CPU judges whether or not a signal indicative of the fact that a side BET is performed has been received. When the CPU41 judges that no side-BET signal has been received (step S312: NO), the routine proceeds to step S315.

On the other hand, when it is judged that the side-BET signal has been received (step S312: YES), the CPU41 transmits JP payout information to the stations 3 (step S313). The JP payout information is indicative of the amount of JP credit (currency value) to be paid out in response to the side BET.

Next, the CPU41 judges whether or not a side game trigger has been established (step S314). Specifically, the CPU41 executes the programs stored in the RAM42, thereby sampling random number values from among the numeric range of the predetermined random number values. Based upon the sampled random number values, this CPU judges whether or not the side game trigger has been established (step S314: NO). The CPU41 terminates main control unit processing upon executing the processing of step S314.

On the other hand, upon judging that the side game trigger has been established (step S314: YES), the CPU41 receives side-game BET information from the station 3 (refer to FIG. 2).

Next, the CPU41 executes processing of determining dealt cards in a side game (step S316). In this processing operation, from among one set of trump cards, the CPU41 determines five cards to be dealt to each of the players.

Next, the CPU41 transmits side game dealt-card information (step S317). Specifically, the CPU41 transmits the side game dealt-card information to the station 3. The side game dealt-card information is inclusive of information which is indicative of the kinds (numbers or alphabets and suits (heart, club, spade, and diamond) of the cards determined to be dealt to the players. At the station 3, based upon the received dealt-card information, the liquid crystal display 10 displays a card image indicative of the five player's cards.

Next, the CPU41 discloses all players' cards (step S318). Specifically, the CPU41 controls the front panel display 21 to display the five-card image determined at step S317 in a faced up manner (see FIG. 13).

Next, the CPU41 judges whether or not a side BET signal has been received (step S319). Specifically, the CPU41 judges whether or not a signal has been received indicative of the fact that the side BET has been performed. When the CPU41 judges that no side BET signal has been received (step S319: NO), the CPU41 proceeds to step S321.

On the other hand, when judging that a side BET signal has been received (step S319: YES), the CPU41 rearranges cards (step S320). Specifically, the CPU41 redisplays the rearranged-card image as a card image which is different from the player-selected card image.

Next, the CPU41 performs side game winner-loser determination processing (step S321). In this processing operation, the CPU41 executes processing of determining a winner or loser, based upon the side game cards of all players disclosed at step S318. Specifically, it is judged as to which one of the players' hands is strong or weak after comparing all of the players' cards, and a winner or loser is determined based upon the judgment result. Specifically, any one of the predetermined combinations is realized in five player's cards, and it is judged whether or not the card combination is strong or weak. The predetermined combinations designate “Royal Flush”, “Straight Flush”, “Four of a Kind”, “Full House”, “Flush”, “Straight”, “Three of a Kind”, “Two Pairs”, “One Pair”, and “No Pair” in sequential order from the strongest combination of five cards.

Next, the CPU41 transmits side game winner-loser information (step S322). Specifically, the CPU41 transmits to the player at the station 3 determined at step S321 the winner-loser information which is indicative of a winner or loser of a side game determined at step S321. The station 3 displays any one of the images inclusive of the messages “You Win”, “You Lose”, and “Draw” on the liquid crystal display 10, based upon winner-loser information, upon the receipt of the winner-loser information (see FIGS. 9B and 10).

Next, the CPU41 executes processing of determining a side game payout player (step S323). Specifically, the CPU41 determines a player targeted for paying out the credit determined based upon a poker combination from among the players having accepted side BET.

Next, the CPU41 transmits side-game payout information to the station 3 (step S324). The side game payout information is indicative of the amount of credit (currency value) paid out to the side game. Specifically, this CPU transmits information which is indicative of the credit determined based upon the card combinations “Royal Flush”, “Straight Flush”, “Four of a Kind”, “Full House”, “Flush”, “Straight”, “Three of a Kind”, “Two Pairs”, “One Pair”, and “No Pair”. The CPU41 terminates main control unit processing when the processing at step S324 is executed.

### 3. Third Embodiment

Hereinafter, a game machine 1 according to a third embodiment will be described in detail with referring to the drawings. The embodiments that follow describe in detail a case in which a payment is to be paid out according to a combination of cards after dealt to a plurality of players if a trigger for a side game is established according to a plural combinations of cards in a PAIGOW poker while in action.

First, the rules of the PAIGOW poker will be described in detail. In the PAIGOW poker of the embodiments, one or more players compete against a banker with the use of one set of trump cards (52 cards) excluding a joker.

Seven cards are dealt to each of the persons consisting of a banker and the players. Each of them divides seven cards into two groups of five cards and of two cards. At this time, a hand of five cards (a high hand) must be as strong as or must be stronger than that of two cards (a low hand).

Next, it is judged as to which one of the players' hands is strong or weak after comparing the five cards of each of the banker's and players' hands with each other. Similarly, it is judged as to which one of the players' hands is strong or weak after comparing the two cards of each of the banker's and players' hands with each other. In a case where the banker's hands are stronger in both of the two groups of five and two cards, it is judged to be the banker's win. In a case where one of the players' hands is stronger in both of the two groups of five and two cards, it is judged to be the player's win. In a case where the player's hands are stronger in one of the two groups consisting of five cards and two cards, and the banker's hand is stronger in the other one, it is judged to be “draw”. In addition, in a case where the player's hand and the banker's hand are identical to each other in strength with respect to both of the two groups of five and two cards, it is judged to be the banker's win.

The hands of five cards include “Royal Flush”, “Straight Flush”, “Four of a Kind”, “Full House”, “Straight”, “Three of a Kind”, “Two of a Kind”, and “No Pair” in order of strength. The hands of two cards include “One Pair” and “No Pair” in order of strength.

In addition, in a case where the player's and banker's hands are identical to each other, it is judged as to which one of the players' hands is strong or weak after comparing the numbers or alphabets drawn in cards constituting the hands with each other. The card's numbers and alphabets include “A”, “K”, “Q”, “J”, “10”, “9”, “8”, “7”, “6”, “5”, “4”, “3”, and “2” in sequential order from the strongest combination of the five cards.

In the embodiments that follow, a PAIGOW poker accepting a normal BET and a side BET is executed. The normal BET is to be performed for the play of the PAIGOW poker, and the side BET is stored in an accumulative manner as a jackpot (hereinafter, referred to as a JP) at a predetermined rate included in a betted currency value (50% in the embodiments of the present invention). The following embodiments describe a case in which a dealer takes over a banker.

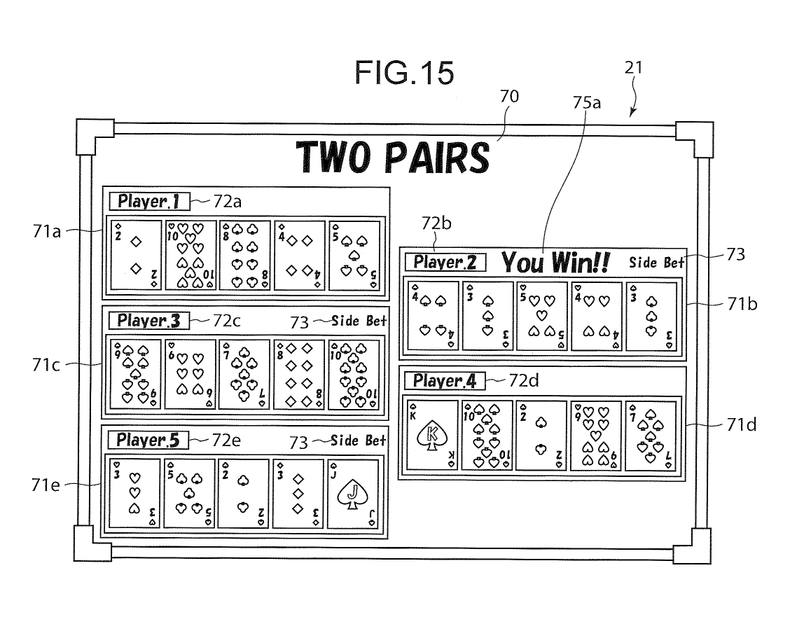

FIG. 15 is a view showing an exemplary image displayed on a front panel display in a side game according to the third embodiment. As shown in FIG. 15, when a side game is started, a combination of cards in which a payment is to be paid out is determined from among combinations of plural kinds of cards, “Royal Flush”, “Straight Flush”, “Four of a Kind”, “Full House”, “Flush”, “Straight”, “Three of a Kind”, “Two Pairs”, and “One Pair”. Then, one side-game card combination display image 70 is displayed indicating that the determined payment is paid out.

When the side-game card combination display image 70 is displayed, five cards are dealt to each of a plurality of players from among plural kinds of cards. The five cards after dealt to each of these players are arranged in a state in which kinds of the cards are identified. Then, the cards of the plurality of players are displayed on the front panel display 21. Card images 71a to 71e after dealt to players 1 to 5 are displayed respectively, and then, player displays 72a to 72c are displayed, indicating that these five players 1 to 5 are performing a sub game. If a combination of the cards displayed and included in the players' cards is a winning combination determined to be paid out, a payment is paid out based upon such card combination. In this embodiment, the side-game card combination display image 70 of “Two Pairs” is displayed, and a payout, which is based upon the combination of cards “Two Pairs”, is determined and paid out to a player who realized the combination of the cards “Two Pairs”. Further, a side BET display image 73 is displayed for a player having accepted the side BET. At the top right of the card images 71 of the players 2, 3, and 5 having accepted the side BET, side BET display images 73 are displayed so as to make identifiable the player having performed the side BET.

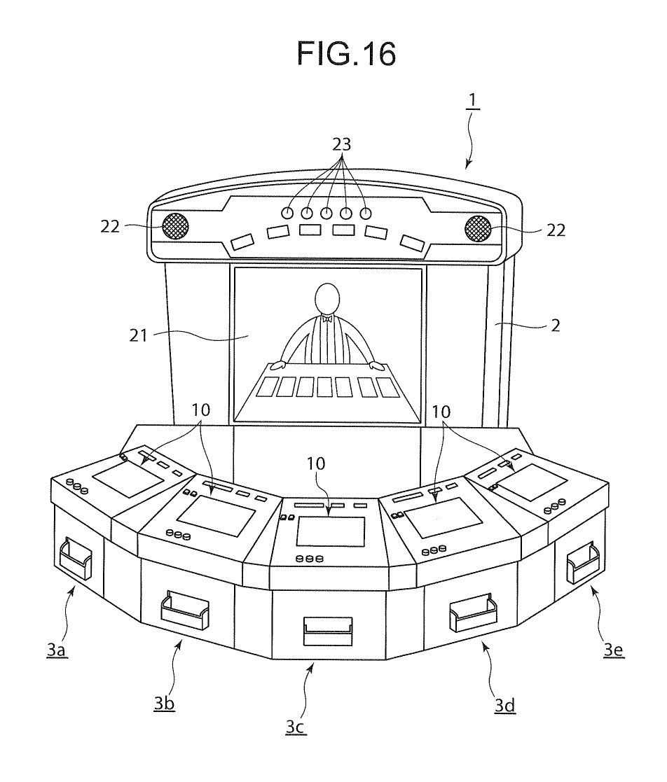

FIG. 16 is a perspective view schematically depicting an appearance and a configuration of a game machine according to a third embodiment of the present invention. As shown in FIG. 16, the game machine 1 is basically made up of a main monitor 2 and five stations 3 (stations 3a to 3e). While the present embodiment describes in detail a case in which the game machine 1 is provided with a plurality of stations 3 (five stations), the game machine may include over five stations in the present invention.

A front panel display 21 is provided at the center part of a main monitor 2, and an image indicative of a dealer and cards is displayed. The front panel display 21 is equivalent to a display device of the present invention. In addition, provided at the upper side of the main monitor 2 are: a speaker 22 for outputting music or effect sounds in accordance with the progress of a game executed by the game machine 1; and an LED23 that is lit at the time of various effects.

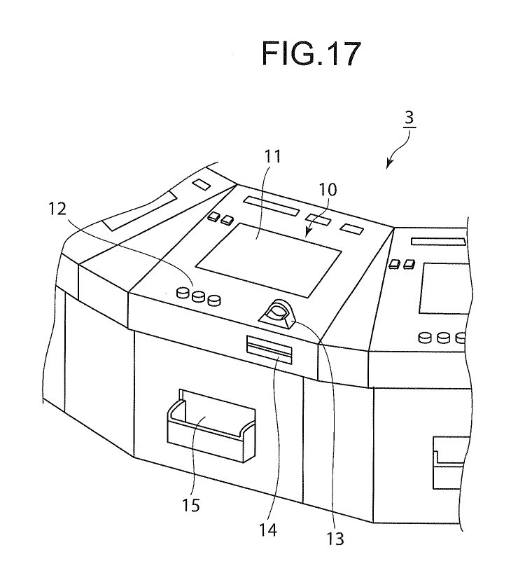

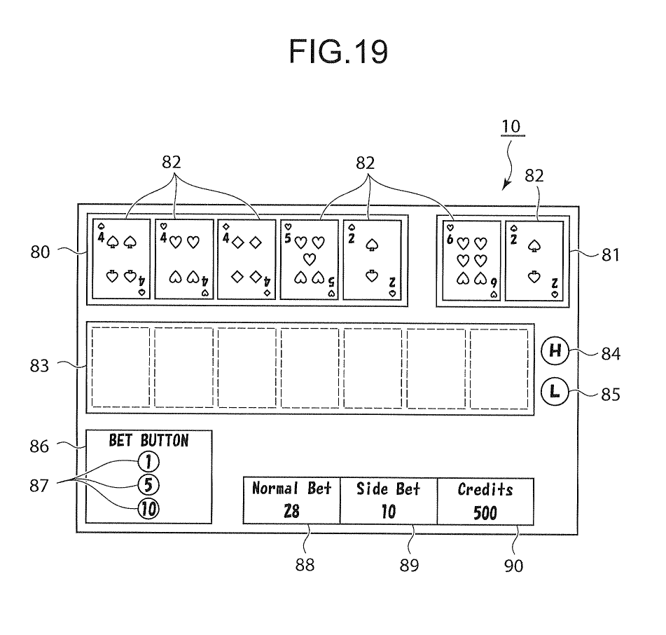

FIG. 17 is a perspective view schematically depicting an appearance and a configuration of stations included in the game machine shown in FIG. 16. As shown in FIG. 17, a liquid crystal display 10, which displays an image or the like pertinent to operation (see FIG. 19), as described later, is provided at the upper center of a station 3. In addition, a touch panel 11 for entering an operation such as BET is provided on the top face of the liquid crystal display 10. The touch panel 11 is equivalent to a BET switch, a side-BET switch, and an input switch, of the present invention.

An operational button 12 for making payout operation and a coin insertion slot 13 for inserting coins or medals are provided in front of the liquid crystal display 10. A bill insertion slot 14 for inserting bills is provided at the front top right end of the station 3. Provided downwardly of the bill insertion slot 14 is a coin payout opening 15 through which the coins or medals corresponding to stored credit are paid out to the players when payout operation is made.

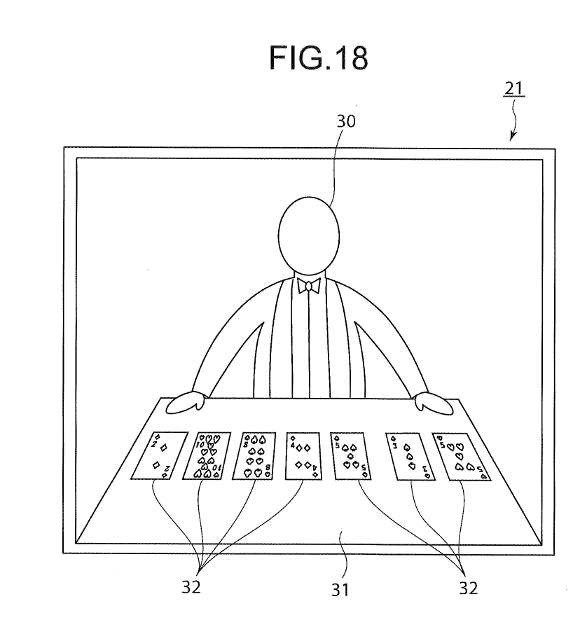

FIG. 18 is a view showing an exemplary image displayed on a front panel display included in a game machine. As shown in FIG. 18, the front panel display 21 displays a dealer image 30 indicating a dealer (banker), a table image 31 indicative of a table, and a card image 32 indicative of seven banker's cards. The card image 32 is displayed in a faced down manner when cards are dealt to the dealer. When a high hand and a low hand are determined, the card image 32 is displayed in a faced up manner. In FIG. 18, the left five cards toward the banker indicate a high hand, and the right two cards indicate a low hand.

FIG. 19 is a view showing an exemplary image displayed on a liquid crystal display included in stations. As shown in FIG. 19, a high hand display section 80, which displays a player's high hand, and a low hand display section 81, which displays a low hand, are provided at the upper side of the liquid crystal display 10. The high hand display section 80 and the low hand display section 81 display card images 82 indicative of a high hand card and a low hand card, respectively, in a faced up manner.

A dealt-card display section 83 is provided at the lower side of the high hand display section 80. A card image indicative of the seven player's cards after dealt to each of the players is displayed in a faced up manner at seven portions enclosed by the dotted line of the dealt-card display section 83. A high hand determination button 84 and a low hand determination button 85, for determining cards constituting a high hand and a low hand, are provided at the right side of the dealt-card display section 83. A player can determine a high hand by selecting a card desired to be high hand, via a touch panel 11, from among the cards displayed at the dealt-card display section 83, and then, operating the high hand determination button 84. The card determined to be a high hand is displayed at the high hand display section 80. Similarly, the player determines a low hand by selecting a card desired to be a low hand, via the touch panel 11, from among the cards displayed at the dealt-card display section 83, followed by operating a low hand determination button 85 via the touch panel 11.

A BET button display section 86 is provided at the lower side of the dealt-card display section 83. The BET button display section 86 displays a BET button 87 for inputting a BET number. The player can input a normal BET number and a side BET number by operating a BET button 87 via the touch panel 11.

A normal BET number display section 88, which displays the number of normally betted coins, is provided at the right side of the BET button display section 86. It is shown here that 28 coins have been betted. In a case where betting of these 28 coins is input, the player may operate “10” of the BET button 87 twice, “5” of the BET button 87 once, and “1” of the BET button 87 three times.

A side-BET number display section 89, which displays the number of side-betted coins, is provided at the right side of the normal BET number display section 88. Here, it is shown that 10 coins have been betted. Further, a credit number display section 90 is provided at the right side of the side-BET number display section 89. Here, it is shown that 500 coins have been credited.

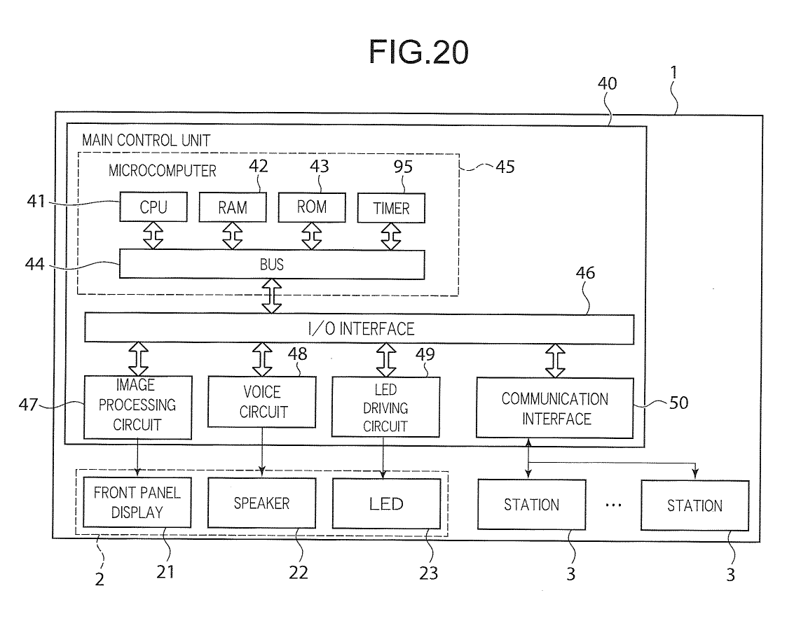

FIG. 20 is a block diagram depicting an internal configuration of the game machine shown in FIG. 16. As shown in FIG. 20, a main control unit 40 included in the game machine 1 is basically constituted while a microcomputer 45 made up of: a CPU (Central Processing Unit) 41; a RAM (Random Access Memory) 42; a ROM (Read Only Memory) 43; a timer 95; and a bus 44 for transferring data therebetween is employed as a base. The main control unit 40 is equivalent to a controller of the present invention.

The ROM43 stores: various programs for performing processing required for controlling the game machine 1; and a data table or the like. The RAM42 is a memory for temporarily storing various data computed by the CPU41. Further, the timer 95 performs time measurement.

The CPU41 is connected via an I/O interface 46 to an image processing circuit 47, a voice circuit 48, an LED driving circuit 49, and a communication interface 50.

front panel display 21 constituting a main monitor 2 is connected to the image processing circuit 47; a speaker 22 constituting the main monitor 2 is connected to the voice circuit 48; and an LED23 constituting the main monitor 2 is connected to the LED driving circuit 49. Five stations 3 are connected to the communication interface 50.

The CPU41 controls games (a PAIGOW poker and a side game) to be conducted in the game machine 1, based upon game programs (a PAIGOW poker game program and a side-game program) stored in the ROM43 and various signals received from the stations 3. Further, the CPU41 controls the front panel display 21 to display images, the speaker 22 to output sounds, and the LED23 to light, based upon the game programs. Furthermore, the CPU41 transmits various signals to the stations 3, based upon the above-mentioned game programs.

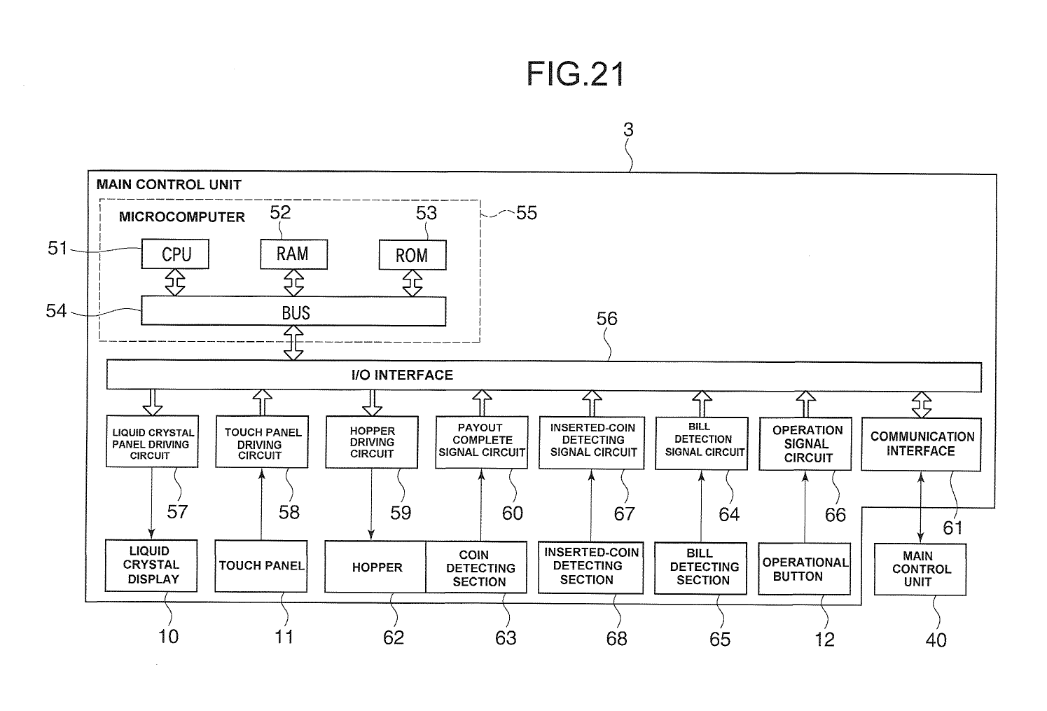

FIG. 21 is a block diagram depicting an internal configuration of each of the stations included in the game machine shown in FIG. 16. As shown in FIG. 21, stations 3 are basically constituted while microcomputers 55 made up of a CPU51, a RAM52, a ROM53, and a bus 54 for transferring data therebetween are employed as a base.

The ROM53 stores a variety of programs and data tables or the like, for performing processing required for controlling stations 3. In addition, the RAM52 temporarily stores the credit number currently stored in stations 3 and a variety of data computed by the CPU51.

In addition, the CPU51 is connected, via an I/O interface 56, to a liquid crystal panel driving circuit 57; a touch panel driving circuit 58; a hopper driving circuit 59; a payout complete signal circuit 60; an inserted-coin detection signal circuit 67; a bill detection signal circuit 64; an operation signal circuit 66; and a communication interface 61.

The liquid crystal display 10 is connected to the liquid crystal panel driving circuit 57; the touch panel 11 is connected to the touch panel driving circuit 58; a hopper 62 is connected to a hopper driving circuit 59; a coin detecting section 63 is connected to the payout complete signal circuit 60; an inserted-coin detecting section 68 is connected to the inserted-coin detection signal circuit 67; a bill detecting section 65 is connected to the bill detection signal circuit 64; and the operational button 12 is connected to the operation signal circuit 66, respectively.

The hopper 62 serves to pay out coins from the coin payout opening 15, based upon a control signal output from the CPU51. The coin detecting section 63 is provided inside the coin payout opening 15, and transmits signals to the CPU51 in a case where it is detected that a predetermined number of coins have been paid out from the coin payout opening 15.

Upon detecting that coins have been inserted through the coin insertion slot 13, the inserted-coin detecting section 68 detects the amount of the detected coins, and then, transmits to the CPU51a detection signal indicative of the detected amount. The detected coins are stored in the RAM52 while a predetermined amount is handled as one credit.

At the time of acceptance of bills, the bill detecting section 65 detects the amount of the accepted bills, and then, transmits to the CPU51a detection signal indicating the detected amount. The detected bills are stored in the RAM52 while the predetermined amount is handled as one credit. The operation button 12 is intended for performing payout operation in a case where coin payout has been determined.

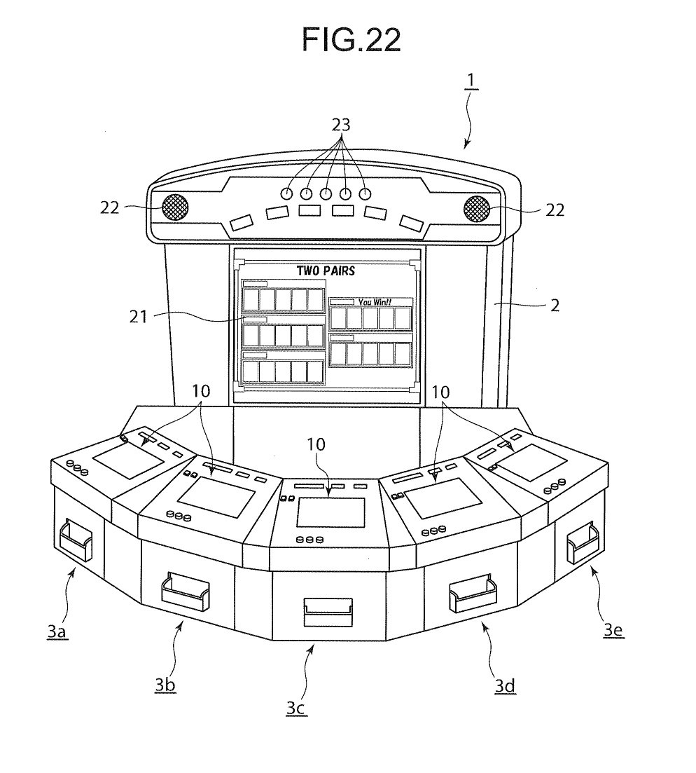

FIG. 22 is a view showing an exemplary image displayed on the front panel display of the game machine according to the third embodiment. As shown in FIG. 22, the game machine 1 is made up of the main monitor 2 and the five stations 3 (3a to 3e). When a side game is started, a display device 21 at the center of the main monitor 2 displays one side-game card combination display image 70 indicating that a payment is paid out which was randomly determined from among card combinations “Royal Flush”, “Straight Flush”, “Four of a Kind”, “Full House”, “Flush”, “Straight”, “Three of a Kind”, “Two Pairs”, and “One Pair”. Further, the liquid crystal display 10 displays the side game deal-cards, which were dealt to the players of the stations 3 (3a to 3e). Moreover, a payment is made to the players of the stations 3 (3a to 3e) in accordance with the poker combination of the cards displayed on the front panel display 21.

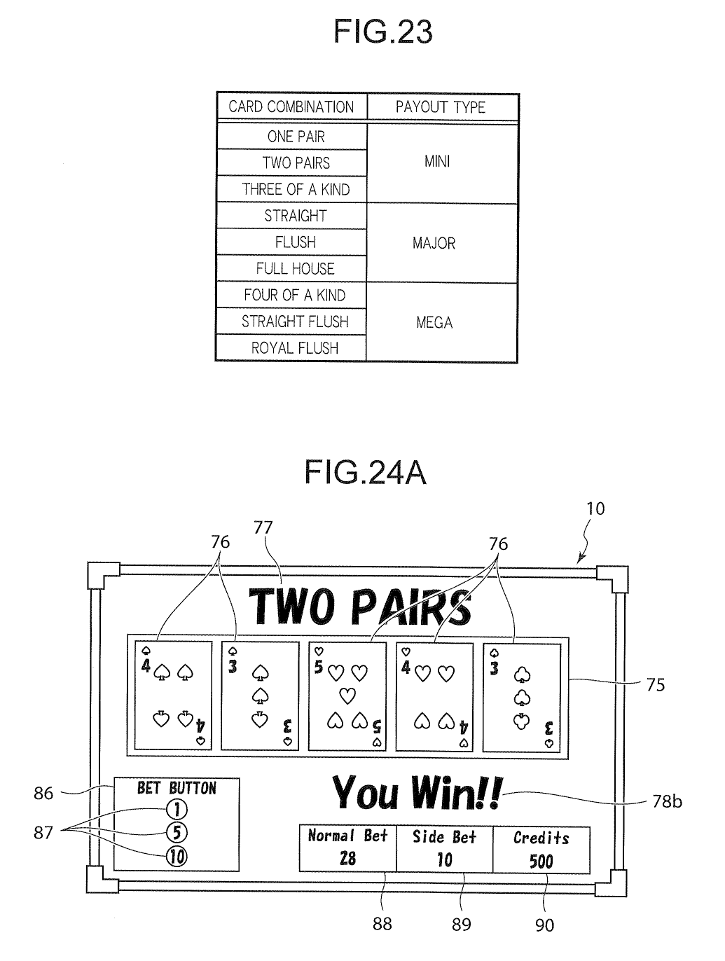

FIG. 23 is a view showing an exemplary combination payout determination table in the side game according to the third embodiment. The combination payout table is stored in the ROM43 while various combinations and payout types are associated with each other. As shown in FIG. 23, in the case of a combination in which the cards after dealt in the side game were determined, the payout type of payment is determined based upon the determined combination. Where a combination of the dealt cards is “One Pair”, “Two Pairs”, or “Three of a Kind”, a payment corresponding to “MINI” is determined; where it is “Straight”, “Flush”, or “Full House”, a payment corresponding to “MAJOR” is determined; or where it is “Four of a Kind”, “Straight Flush”, or “Royal Flush”, a payment corresponding to “MEGA” is determined. In other words, credit is paid out based upon the determined payout type.

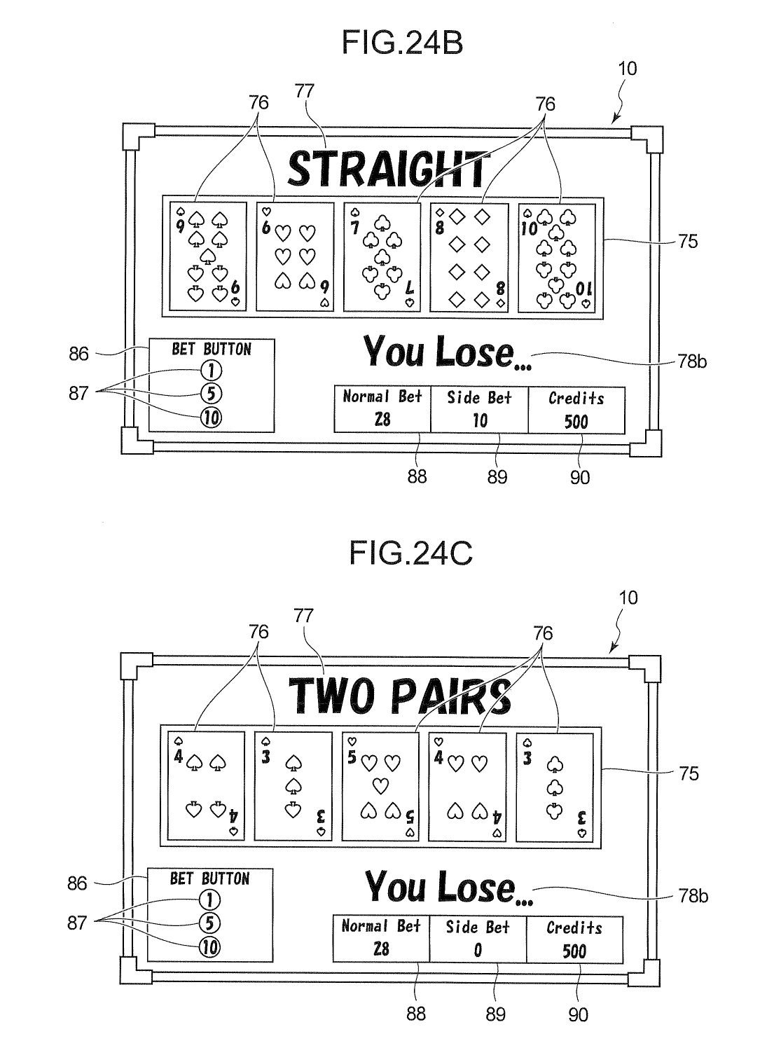

FIGS. 24A to 24C are views each showing an exemplary image displayed on the liquid crystal display device included in each of the stations in a side game according to the third embodiment. As shown in FIG. 24A, when the side game is started, the liquid crystal display 10 displays one side-game card combination display image 70 indicating that a payment is paid out which was randomly determined from among combinations of cards “Royal Flush”, “Straight Flush”, “Four of a Kind”, “Full House”, “Flush”, “Straight”, “Three of a Kind”, “Two Pairs”, and “One Pair”. Next, the side game dealt-card display section 75 displays side-game cards 76 dealt when the side game has been started, Here, five cards “4 of spade”, “3 of spade”, “5 of heart”, “4 of heart”, and “3 of club”, which are combinations of cards “Two Pairs”, are dealt. If a card combination is identical to that of the side game card combination display image 70, a winner-loser information display 78a inclusive of a message “You Win” is displayed.

A BET button display section 86 is provided at the lower side of the side game dealt-card display section 83. A normal BET number display section 88, a side-BET number display section 89 and a credit number display section 90, for displaying the number of side-betted coins, are provided at the lower side of the side game dealt-card display 75. Here, it is shown that 28 coins have been normally betted; 10 coins have been side-betted; and 500 coins have been credited.

As shown in FIG. 24B, the liquid crystal display 10 displays that a card combination “Two Pairs” in FIG. 24A is determined. Next, the side game dealt-card display section 75 displays side-game cards 76 which were dealt at the time of commencement of the side game. In the figure, five cards “9 of spade”, “6 of heart”, “7 of clover”, “8 of diamond”, and “10 of club”, which are a card combination “Straight”, are dealt, and then, the card combination display image 77 indicative of “Two Pairs” is displayed. In the figure, because the card combination “Two Pairs” was determined, even if “straight”, which is a stronger card combination, is realized, it is not a combination of cards identical to that of cards of the sub-game card combination display image 70. Thus, a winner-loser information display 78b inclusive of the message “You Lose” is displayed.

As shown in FIG. 24C, the liquid crystal display 10 displays that a card combination “Two Pairs” in FIG. 24A is determined. Next, the side game dealt-card display section 75 displays side-game cards 76 which were dealt at the time of commencement of the side game. In the figure, it is shown that dealt five cards “4 of spade”, “3 of spade”, “5 of heart”, “4 of heart” and “3 of club” are realized as a poker combination “Two Pair”, and then, the card combination display image 77, which is indicative of “Two Pairs”, is displayed.

A BET button display section 86 is provided at the lower side of the side game dealt-card display section 83. A normal BET number display section 88, a side BET number display section 89 and a credit amount display section 90, for displaying the number of side-betted coins, are provided at the lower side of the side game dealt-card display 75. Here, it is shown that 28 coins have been normally betted, no coins have been side-betted, and 500 coins have been credited. Further, even though a combination of cards identical to that of cards of the sub-game card combination display image 70 is realized, if the side-BET number display section 89 displays 0, it means that no side-BET is performed. Thus, a payment corresponding to the card combination is not paid out, and then, the winner-loser information display 78b inclusive of the message “You Lose” is displayed.

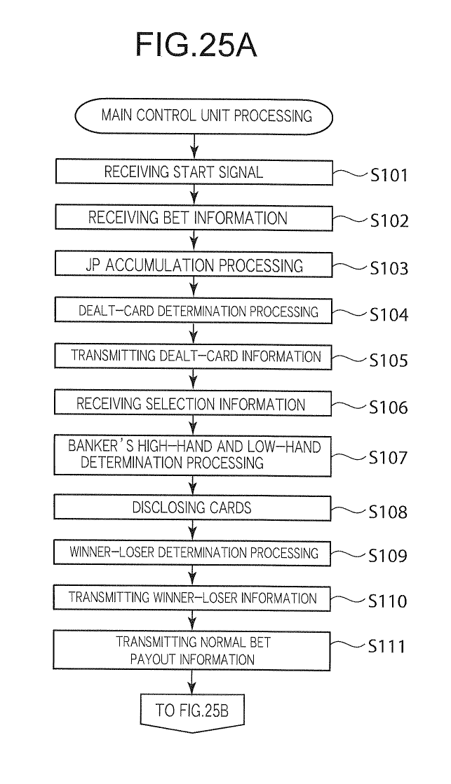

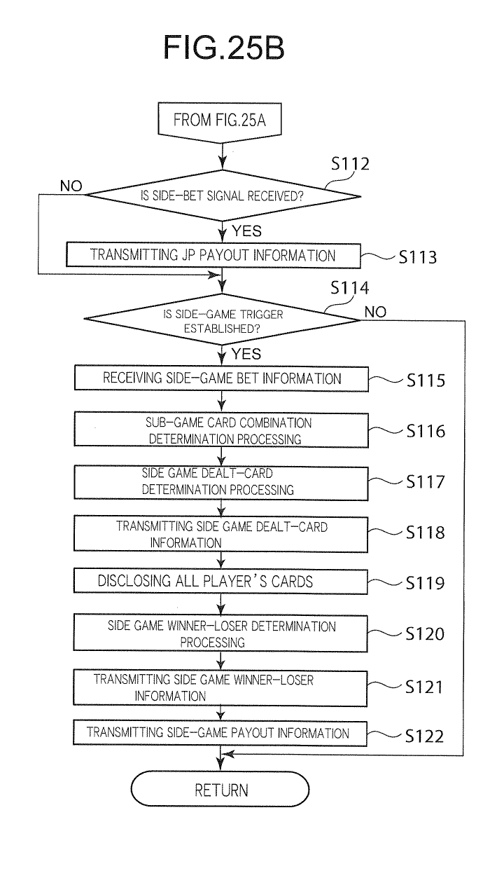

Next, the processing to be performed at the main control unit 40 and stations 3 will be described in detail. FIG. 25A and FIG. 25B are flowcharts each showing main control unit processing to be executed at the main control unit included in the game machine according to the third embodiment. In this processing operation, at first, the CPU41 included in the main control unit 40 receives a start signal (step S101). Specifically, the CPU41 receives the start signal from any of the stations 3. The start signal serves as a trigger for conducting a PAIGOW poker game in the game machine 1.

Next, the CPU41 receives BET information from the stations 3 (see FIG. 16) (step S102). The BET information is pertinent to BETs, and includes: information indicative of whether or not a normal BET and a side BET have been performed; and information indicative of the amounts of the normal BET and the side BET.

Next, the CPU41 executes JP accumulation processing (step S103). Specifically, the CPU41 accumulatively stores, in the RAM42 (see FIG. 20), 50% (predetermined rate) of the side-betted credit as JP, based upon the BET information received at step S102.

Next, the CPU41 executes dealt-card determination processing (step S104). In this processing operation, the CPU41 determines seven cards to be dealt to each of the persons consisting of the players and banker from among one set of trump cards, with the use of random numbers. The seven cards determined to be dealt to the players at the step S104 are equivalent to the player's cards, and the seven cards determined to be dealt to the banker are equivalent to the banker's cards. Further, the front panel display 21 (see FIG. 16) included in the game machine 1 displays a card image indicative of the seven banker's cards in a faced down manner.

Next, the CPU41 transmits dealt-card information (step S105). Specifically, the CPU41 transmits the dealt-card information to stations 3. The dealt-card information includes the one which is indicative of the kinds of cards (numbers or letters and suits (heart, clover, spade, and diamond)) that were determined to be dealt to the players and banker. At each of the stations 3, the liquid crystal display 10 displays the card image indicative of the seven player's cards, based upon the received dealt-card information, and then, accepts entry for dividing them into a group of 5 cards (high hand) and a group of two cards (low hand).

Next, the CPU41 receives selection information from the station 3 (step S106). The selection information indicates which ones of the cards after dealt to each of the players have been selected as a high hand, and which ones of the cards have been selected as a low hand.

Next, the CPU41 executes processing of determining a banker's high hand and low hand (step S107). In this processing operation, the CPU41 executes processing of dividing the cards after dealt to the banker into a high hand and a low hand.

Next, the CPU41 discloses cards (step S108). Specifically, the CPU41 displays in a faced up manner on the front panel display 21 the card images indicative of the high hand and the low hand determined at the step S106.

Next, the CPU41 performs winner-loser determination processing (step S109). In this processing operation, the CPU41 executes processing of determining a winner or loser, based upon the selection information received at the step S106 and the high hand and the low hand determined at step S107. Namely, this CPU executes processing of determining a winner or loser after comparing the players' hands of the cards after dealt to the players and the banker's card hands. Specifically, it is judged as to which one of the players' hands is strong or weak after comparing the players' high hands with the banker's high hand. In addition, it is also judged as to which one is strong or weak after comparing the players' low hands with the banker's low hand. Further, the winner or loser is determined based upon the judgment results. Specifically, in a case where the player's high hand is stronger than the banker's high hand and in a case where the player's low hand is stronger than the banker's low hand, it is judged to be the player's win. In a case where the banker's high hand is stronger than the player's high hand and in a case where the banker's low hand is stronger than the player's low hand, it is judged to be the banker's win. Even if the player is stronger at one of the high and low hands, in a case where the banker is stronger at the other one, it is judged to be “draw”.

Next, the CPU41 transmits winner-loser information (step S110). Specifically, the CPU41 transmits to the station 3 the information indicative of the winner or loser determined at the step S111 (hereinafter, referred to as winner-loser information). Upon the receipt of the winner-loser information, based upon the received winner-loser information, the liquid crystal display 10 displays any one of the images inclusive of the messages “You Win”, “You Lose”, and “Draw”.

Next, the CPU41 performs processing of transmitting normal-BET payout information (step S111). In this processing operation, the CPU41 transmits the normal-BET payout information to the station 3. The normal-BET payout information is generally indicative of the amount of credit (currency values) to be paid out to BET. Specifically, in a case where the player has won, this CPU transmits information indicative of credit of which amount is twice of that of normal BET. In a case where the outcome of the game is “draw”, the CPU transmits information indicative of credit of which amount is equal to that of normal BET. In addition, in a case where the banker has won, the CPU transmits information indicative of the fact that an amount of given credit is 0.

Next, in FIG. 25B, the CPU41 judges whether or not a side BET signal has been received (step S112). Specifically, the CPU41 judges whether or not a signal has been received indicative of the fact that the side BET has been performed. When the CPU41 judges that no side BET signal has been received (step S112: NO), the routine proceeds to step S113.

On the other hand, when it is judged that a side BET signal is received (step S112: YES), JP payout information is transmitted to the station 3 (step S113). The JP payout information is indicative of the amount of JP credit (currency value) to be paid out to the side BET. Specifically, in a case where the player has won, when a high hand is “Royal Flush”, the CPU41 transmits information indicative of credit equivalent to a total amount of JP. When the player's high hand is “Straight Flush”, this CPU transmits information indicative of credit equivalent to 50% of JP, and when the player's high hand is a hand other than the above, this CPU transmits information indicative of a credit equivalent to 10% of JP. In addition, in a case where the result is “draw”, this CPU transmits information indicative of a credit of which amount is equal to that of a side BET. Moreover, in a case where the banker has won, this CPU transmits the fact that the amount of credit given is 0.

While the embodiment of the present invention described a case in which, when the player has won in a PAIGOW poker at the time of side BET, where the high hand is “Royal Flush”, 100% of JP is given, where the high hand is “Straight Flush”, 50% of JP is given, and where the high hand is a hand other than the above, 10% of JP is given. In the embodiment of the present invention, a correspondence relationship between the amount of JP given and a hand is not limitative thereto. In the present invention, further, in a case where the player has won in the PAIGOW poker at the time of side BET, all of the currency values accumulatively stored as JP may be given, regardless of the hand.

The embodiment of the present invention described a case in which a correspondence relationship between a player's hand and a payment (JP) to be paid out, in the PAIGOW poker at the time of side BET is preset. In the present invention, however, the correspondence relationship between the player's hand and the payment to be paid out may be randomly varied every time the PAIGOW poker is performed at the time of a side BET.

Further, while the embodiment of the present invention describes a case of paying out credit of which amount is equal to that of side BET in a case where the result is “draw”, the above payout of the credit may not be performed.

Next, the CPU41 judges whether or not a side game trigger is established (step S114). Specifically, the CPU41 executes the programs stored in the RAM 42, thereby sampling random number values from among the numeric range of predetermined random number values and judging whether or not a side game trigger is established based upon the sampled random number values. The CPU41 terminates main control unit processing when it executes the processing of step S114 upon judging that a side game trigger has not been established (step S114: NO). In another embodiment of the present invention, further, judgment of whether or not a side game trigger is established is made based upon whether or not a side BET has been performed in advance.

On the other hand, upon judging that a side-game trigger has been established (step S114: YES), the CPU41 receives side-game BET information from the station 3 (see FIG. 16) (step S115). BET information is pertinent to BETs, and includes information indicative of whether or not normal BET and side BET have been performed or information indicative of the amounts of the normal BET and side BET.

Next, the CPU41 executes processing of determining a side-game card combination (step S116). In this processing operation, the CPU41 determines one of the card combinations, “Royal Flush”, “Straight Flush”, “Four of a Kind”, “Full House”, “Flush”, “Straight”, “Three of a Kind”, “Two Pairs”, and “One Pair”.

Next, the CPU41 executes processing of determining cards after dealt in a side game (step S117). In this processing operation, the CPU41 determines five cards after dealt to the players, from one or plural groups of trump cards, with the use of random numbers.

Next, the CPU41 transmits information on cards to be dealt in the side game (step S118). Specifically, the CPU41 transmits, to the station 3, information on cards after dealt in the side game. The side game dealt-card information includes information indicative of suits (heart, club, spade, and diamond) of the cards determined to be dealt to the players. At the station 3, based upon the received dealt-card information, the liquid crystal display 10 displays a card image indicative of the five player's cards.

Next, the CPU41 discloses all of the player's cards (step S119). Specifically, the CPU41 displays, in a faced up manner on the front panel display 21 on a player-by-player basis, the five-card images of the players' cards determined at step S117 (see FIG. 15). In this case, the player can view the cards that were placed and arranged.

Next, the CPU41 performs side game winner-loser determination processing (step S120). In this processing operation, the CPU41 executes processing of determining a winner or loser, based upon cards of the side game of all players having accepted the side BET disclosed at step S119. Specifically, this CPU judges whether the side-game card combination determined at step S116 is identical to the player's card combination, and then, determines a winner or a loser, based upon the judgment result.

Next, the CPU41 transmits side game winner-loser information (step S121).

Specifically, the CPU41 transmits to a station 3 the winner-loser information indicative of a winner or loser of the side game determined at step S120. The station 3 displays any one of the images inclusive of the messages “You Win”, “You Lose”, and “Draw” on the liquid crystal display 10, based upon winner-loser information, upon the receipt of the winner-loser information (see FIG. 24).

Next, the CPU41 transmits side-game payout information to the stations 3 (step S123). The side-game payout information is indicative of the amount of credit (currency value) to be paid out in a side game. Specifically, where the side-game card combination determined at step S116 is identical to the player's card combination, the payout types corresponding to the card combination is determined (see FIG. 23), and then, the information indicative of the determined credit is transmitted. When executing the processing of step S122, the CPU41 terminates main control unit processing.

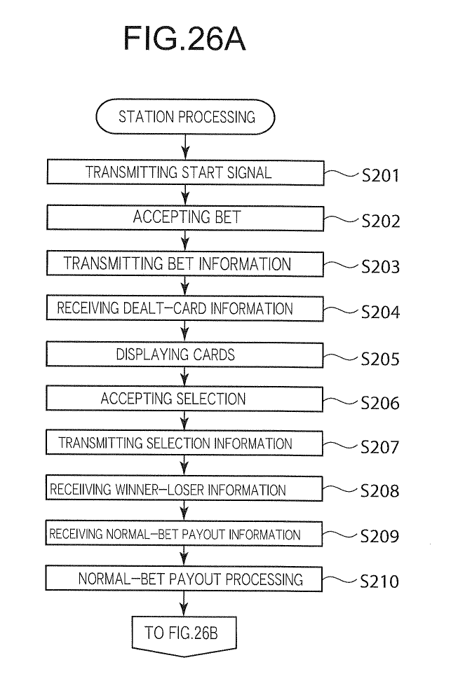

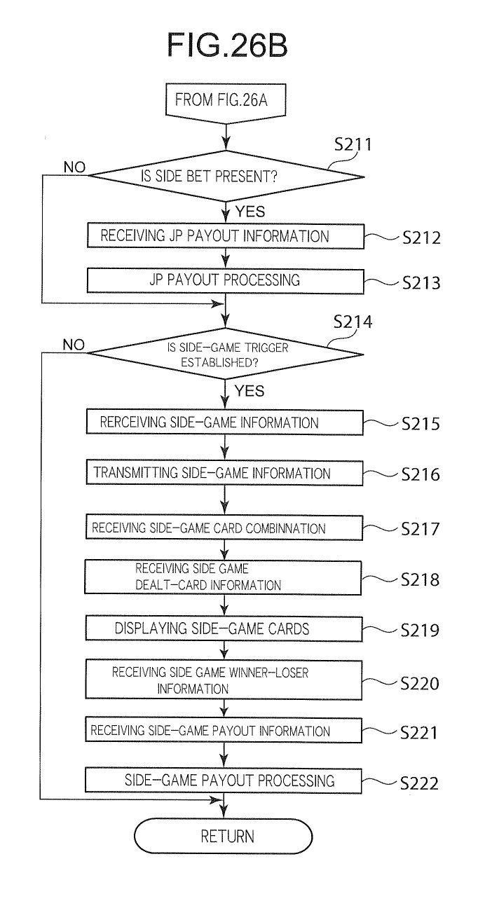

Next, the processing to be performed at the station 3 will be described in detail. FIGS. 26A and 26B are flowcharts each showing a subroutine of the station processing executed at each of the stations according to the third embodiment. In this processing operation, at first, the CPU51 included in the station 3 transmits a start signal to the main control unit 40 upon the receipt of signal indicative of the fact that a touch from the touch panel 11 has been sensed or that coin insertion has been detected from the entered-coin detecting section 68 (step S201). In this manner, at the main control unit 40, the processing operations shown in FIGS. 25A and 25B are conducted.

Next, the CPU51 accepts entries of the normal BET and side BET (step S202). This allows the player to enter the normal BET and the side BET via the touch panel 11 included in the station 3. Upon the receipt of a signal indicative of the fact that entry of the side BET has been made, the CPU51 sets a side-BET flag. This side-BET flag is set in a case where entry of the side BET has been made.

Next, the CPU51 transmits to the main control unit 40, BET information serving as information pertinent to an input BET (step S203). Upon the receipt of the BET information, the main control unit 40 determines cards to be dealt to the players and the banker (see step S104 of FIG. 25A).

Next, the CPU51 receives from the main control unit 40 the dealt-card information indicative of the cards after dealt to the players (step S204). Specifically, the CPU51 receives the dealt-card information transmitted at step S105 of FIG. 25A, and then, stores the received information in a RAM.

Next, the CPU51 displays cards (step S205). Specifically, the CPU51 displays a card image indicative of the seven player's cards at the dealt-card display section 83 of the liquid crystal display 10, based upon the dealt-card information received at step S204.

Next, the CPU51 accepts entry for selecting high hands and low hands (step S206). This allows the players to determine high hands and low hands from among the dealt cards by operating a high hand determination button 84 and a low hand determination button 85 via touch panel 11.

Next, the CPU51 transmits to the main control unit 40 the selection information that is based upon selection of high hands and low hands (step S207). Upon the receipt of the selection information, the main control unit 40 determines a high hand and a low hand of the banker's cards, and then, executes processing of determining a winner or loser (see step S109 of FIG. 25A).

Next, the CPU51 receives winner-loser information from the main control unit 40 (step S208). Subsequently, the dealt-card display section 83 of the liquid crystal display 10 displays any one of the images inclusive of the messages “You Win”, “You Lose”, and “Draw”, during a predetermined period of time, based upon the received winner-loser information.

Next, the CPU51 receives normal-BET payout information from the main control unit 40 (step S209). Upon the receipt of the normal-BET payout information, the CPU51 stores in the RAM52 the credit data that is based upon the normal-BET payout information.

Next, the CPU51 receives normal-BET payout information, based upon the normal-BET payout information received at step S209 (step S210). In this normal-BET payout processing, in a case where a player has won, payout is performed, based upon information indicative of a credit of which amount is twice of that of the normal BET; and in a case where the result is “draw”, payout is performed, based upon information indicative of a credit of which amount is equal to that of the normal BET. In addition, in a case where the banker has won, information indicative of the fact that the amount of credit to be given is 0 is displayed.

Next, in FIG. 26B, the CPU51 judges whether or not entry of side BET has been made, while in the BET acceptance at step S202 (step S211). Specifically, the CPU51 judges whether or not a side-BET flag is set. When the CPU41 judges that entry of the side BET has not been made (step S211: NO), the routine proceeds to step S214.

On the other hand, upon judging that entry of the side BET has been made (step S211: YES), the CPU51 receives JP payout information (step S212). Specifically, the CPU51 receives JP payout information from the main control unit 40. Upon the receipt of the JP payout information, the CPU51 stores in the RAM52 the credit data that is based upon the JP payout information.

Next, the CPU51 executes JP payout processing (step S213). Specifically, the CPU51 pays out credit, based upon the JP payout information received at step S212.

Next, the CPU51 judges whether or not a side-game trigger has been established (step S214). Specifically, the CPU51 judges whether or not the side-game trigger has been established at the main control unit 40. Upon judging that no side-game trigger has been established (step S214: NO), the CPU51 terminates station processing.

On the other hand, upon judging that the side-game trigger has been established (step S214: YES), the CPU51 accepts entry of normal BET and side BET for the side game (step S215). In this manner, the player can enter the normal BET and side BET in the side game via the touch panel 11 included in the station 3.

Next, the CPU51 transmits to the main control unit 40 the BET information pertinent to BETs for the entered side game (step S216). The main control unit 40 determines cards to be dealt to the player in the side game upon the receipt of the side-game BET information (see step S117 of FIG. 25B).

Next, the CPU51 receives a sub-game card combination (step S217).

Specifically, the CPU51 determines one sub-game poker combination from among the poker combinations “Royal Flush”, “Straight Flush”, “Four of a Kind”, “Full House”, “Flush”, “Straight”, “Three of a Kind”, “Two Pairs”, and “One Pair”, and then, displays a sub-game poker combination display image 70 (see FIG. 24A).

Next, the CPU51 receives from the main control unit 40 the side game dealt-card information indicative of the cards after dealt to the players in the side game (step S218). Specifically, the CPU51 receives the dealt-card information transmitted at step S118 of FIG. 25B.

Next, the CPU51 displays side-game cards (step S219). Specifically, the CPU51 displays a card image 76 indicative of the five player's cards at the dealt-card display section 83 of the liquid crystal display 10, based upon the side game dealt-card information received at step S218.

Next, the CPU51 receives the side game winner-loser information from the main control unit 40 (step S220). Next, the dealt-card display section 83 of the liquid crystal display 10 displays, for a predetermined duration, an image inclusive of any one of the messages “You Win”, “You Lose”, and “Draw”, based upon the received winner-loser information.

Next, the CPU51 receives the side-game payout information (step S221). Upon the receipt of the side-game payout information, the CPU51 stores in the RAM52 the credit data that is based upon the side-game payout information.

Next, the CPU51 executes the side-game payout processing, based upon the received side-game payout information at step S221 (step S222). In this processing operation, this CPU receives payout information, based upon information determined in any one of the cases in which: a plurality of cards owned by the players include a combination of cards, in which the randomly determined payment at step S217 is to be paid out; payout is performed for players having performed side-BET entry, based upon a card combination; and a payment is distributed and paid out among all of the players having performed side-BET entry. The CPU51 terminates station processing when terminating this processing.

### 4. Fourth Embodiment

Next, the game machine 1 according to a fourth embodiment will be described in detail with referring to the drawings. The game machine 1 according to the fourth embodiment that follows has an appearance and a circuit construction or the like, which are substantially similar to those according to the third embodiment of the present invention. Thus, a duplicate description of like construction is omitted here. Also, like constituent elements corresponding to those of the game machine 1 are designated by like reference numerals and are explained.

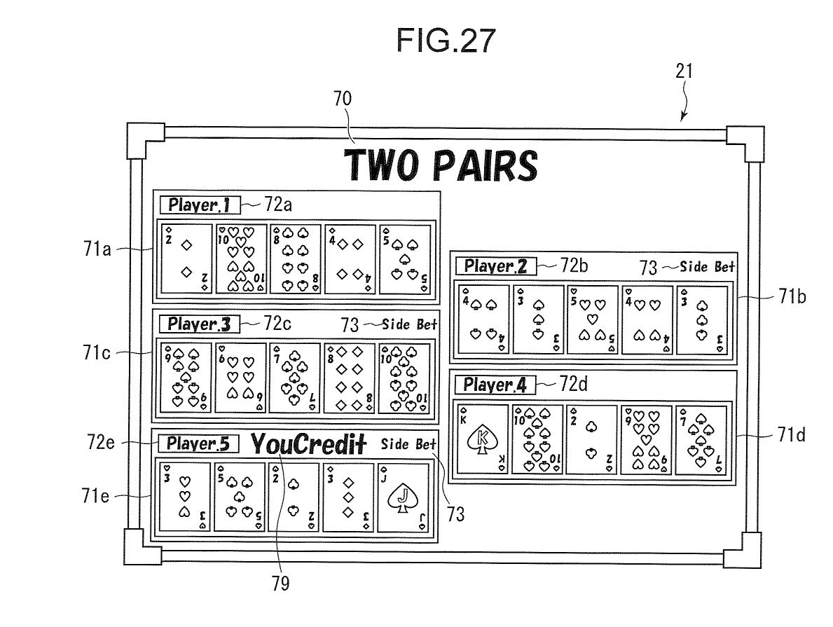

FIG. 27 is a view showing an exemplary image displayed on a front panel display in a side game according to the fourth embodiment. As shown in FIG. 27, when a sub-game is started, one side-game combination display image 70 is displayed indicating that a payment is paid out which was randomly determined from among combinations of cards “Royal Flush”, “Straight Flush”, “Four of a Kind”, “Full House”, “Flush”, “Straight”, “Three of a Kind”, “Two Pairs”, and “One Pair”.

Next, five cards are dealt to each of a plurality of players, and the front panel display 21 displays the cards after dealt to the plurality of players. Card images 71a to 71e dealt to players 1 to 5 are displayed, respectively, and player displays 72a to 72c are displayed indicating that five players 1 to 5 are performing a sub-game. Further, a side-BET display image 73 is displayed for the players having accepted a side BET. At the upper right of the card image 71 of the players 2, 3, and 5 having accepted side BET, the side-BET display image 73 is displayed to make identifiable the players having performed a side BET. Further, a player to whom a payment is to be randomly paid out is determined from among the players having accepted a side BET from among those having a plurality of cards inclusive of a combination of cards “Two Pairs”. From among the players 2, 3, and 5 having accepted a side BET, a credit display image 79 inclusive of a message “You Credit” is displayed over the card image 71 for the player 2 to whom the randomly determined payment is to be paid out.

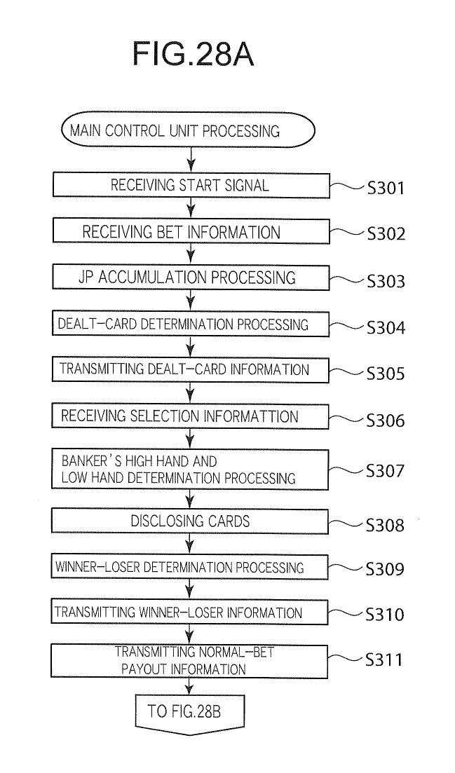

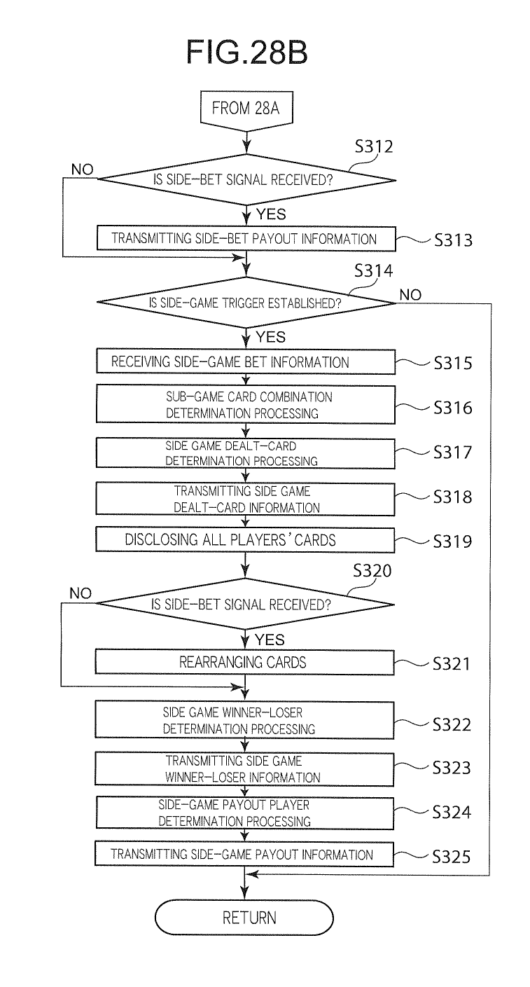

Next, the processing performed at the main control unit 40 and stations 3 will be described in detail. FIGS. 28A and 28B are flowcharts each showing main control unit processing executed at the main control unit included in the game machine according to the fourth embodiment. In this processing operation, at first, the CPU41 included in the main control unit 40 receives a start signal (step S301). After that, the processing operations of steps S302 to S311 are performed. These processing operations are not described here, since they are identical to those of steps S101 to S111 shown in FIG. 25A.

Next, in FIG. 28B, the CPU41 judges whether or not a side-BET signal has been received (step S312). Specifically, this CPU judges whether or not a signal indicative of the fact that a side BET is performed has been received. When the CPU 41 judges that no side-BET signal has been received (step S312: NO), the routine proceeds to step S314.

On the other hand, when it is judged that the side-BET signal has been received (step S312: YES), the CPU41 transmits JP payout information to the stations 3 (step S313). The JP payout information is indicative of the amount of JP credit (currency value) to be paid out in response to the side BET.

Next, the CPU41 judges whether or not a side game trigger has been established (step S314). Specifically, the CPU41 executes the programs stored in the RAM42, thereby sampling random number values from among the numeric range of the predetermined random number values. Based upon the sampled random number values, this CPU judges whether or not the side game trigger has been established (step S314: NO). The CPU41 terminates main control unit processing upon executing the processing of step S314.

On the other hand, upon judging that the side game trigger has been established (step S314: YES), the CPU41 receives side-game BET information from the station 3 (refer to FIG. 16) (step S315). BET information is pertinent to BETs, and includes information indicative of whether or not a normal BET and a side BET have been performed or information indicative of the amounts of the normal BET and side BET.

Next, the CPU41 executes processing of determining a side-game card combination (step S316). In this processing operation, the CPU41 determines one of the card combinations “Royal Flush”, “Straight Flush”, “Four of a Kind”, “Full House”, “Flush”, “Straight”, “Three of a Kind”, “Two Pairs”, and “One Pair”.

Next, the CPU41 executes processing of determining side game dealt-cards (step S317). In this processing operation, from among one set of trump cards, the CPU41 determines five cards to be dealt to each of the players.

Next, the CPU41 transmits side game dealt-card information (step S318). Specifically, the CPU41 transmits the side game dealt-card information to the stations 3. The sub-game dealt-card information includes information indicative of suits (heart, clover, spade, and diamond) of cards determined to be dealt to the players. At each of the stations 3, the liquid crystal display 10 displays a card image indicative of five player's cards, based upon the received dealt-card information.

Next, the CPU41 discloses all of the players' cards (step S319). Specifically, the CPU41 controls the front panel display 21 to display the five-card image determined at step S317 in a faced up manner (see FIG. 27).

Next, the CPU41 judges whether or not a side-BET signal has been received (step S320). Specifically, the CPU41 judges whether or not a signal indicative of the fact that a side BET is performed has been received. When judging that no side-BET signal has been received (step S320: NO), the CPU41 proceeds to step S322.

On the other hand, upon judging that the side-BET signal has been received (step S320: YES), the CPU41 rearranges cards (step S321). Specifically, the CPU41 redisplays the rearranged-card image to a card image which is different from the player-selected card image.

Next, the CPU41 performs side game winner-loser determination processing (step S322). In this processing operation, the CPU41 executes processing of determining a winner or a loser, based upon the side-game cards of all of the players disclosed at step S319. Specifically, this CPU judges whether the side-game card combination determined at step S316 is identical to the player's card combination, and then, determines a winner or a loser, based upon the judgment result.

Next, the CPU41 transmits side game winner-loser information (step S323). Specifically, the CPU41 transmits to the stations 3 the winner-loser information indicative of a side-game winner or loser which was determined at step S323. At each of the stations 3, upon the receipt of the winner-loser information, the liquid crystal display 10 serves to display any one of the images inclusive of the messages “You Win”, “You Lose”, and “Draw”, based upon the received winner-loser information (see FIG. 24).

Next, the CPU41 executes processing of determining side-game payout players (step S324). Specifically, in a case where the side-game card combination determined at step S316 is identical to the player's card combination, the CPU41 randomly determines a player to whom a payment corresponding to the card combination is to be paid out, from among the players having accepted the side BET.

Next, the CPU41 transmits side-game payout information to the stations 3 (step S325). The side-game payout information is indicative of the amount of credit (currency value) to be paid out in a side game. Specifically, in a case where the side-game poker combination determined at step S316 is identical to the player's card poker combination, this CPU determines a payout type corresponding to the poker combination (see FIG. 23), and then, transmits information indicative of the determined credit. The CPU41 terminates main control unit processing upon executing the processing of step S322.

### 5. Fifth Embodiment

Hereinafter, a game machine 1 according to a fifth embodiment will be described in detail with referring to the drawings. The embodiments that follow describe in detail a case in which a payment is paid out according to a combination of a plurality of cards and a special card after dealt to a plurality of players if a trigger for a side game is established according to a plural combinations of cards in a PAIGOW poker while in action.

First, the rules of the PAIGOW poker will be described in detail. In the PAIGOW poker of the present embodiment, one or plural players complete against a banker with the use of one group of trump cards (52 cards) excluding a joker.

Seven cards are dealt to each of the persons consisting of a banker and the players. Each of them divides seven cards into two groups of five cards and of two cards. At this time, a hand of five cards (a high hand) must be as strong as or must be stronger than that of two cards (a low hand).

Next, it is judged as to which one of the players' hands is strong or weak after comparing the five cards of each of the banker's and players' hands with each other. Similarly, it is judged as to which one of the players' hands is strong or weak after comparing the two cards of each of the banker's and players' hands with each other. In a case where the banker's hands are stronger in both of the two groups of five and two cards, it is judged to be the banker's win. In a case where one of the players' hands is stronger in both of the two groups of five and two cards, it is judged to be the player's win. In a case where the player's hands are stronger in one of the two groups consisting of five cards and two cards, and the banker's hand is stronger in the other one, it is judged to be “draw”. In addition, in a case where the player's hand and the banker's hand are identical to each other in strength with respect to both of the two groups of five and two cards, it is judged to be the banker's win.

The hands of five cards include “Royal Flush”, “Straight Flush”, “Four of a Kind”, “Full House”, “Straight”, “Three of a Kind”, “Two of a Kind”, and “No Pair” in order of strength. The hands of two cards include “One Pair” and “No Pair” in order of strength.

In addition, in a case where the player's and banker's hands are identical to each other, it is judged as to which one of the players' hands is strong or weak after comparing the numbers or alphabets drawn in cards constituting the hands with each other. The card's numbers and alphabets include “A”, “K”, “Q”, “J”, “10”, “9”, “8”, “7”, “6”, “5”, “4”, “3”, and “2” in sequential order from the strongest combination of the five cards.

In the embodiments that follow, a PAIGOW poker accepting a normal BET and a side BET is executed. The normal BET is to be performed for the play of the PAIGOW poker, and the side BET is stored in an accumulative manner as a jackpot (hereinafter, referred to as a JP) at a predetermined rate included in a betted currency value (50% in the embodiments of the present invention). The following embodiments describe a case in which a dealer takes over a banker.

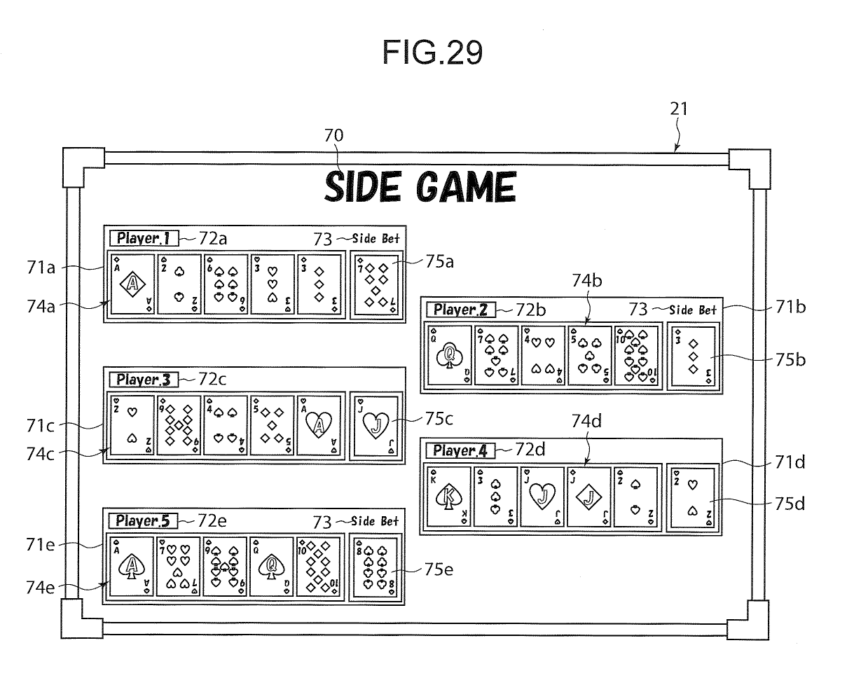

FIG. 29 is a view showing an exemplary image displayed on a front panel display 21 in a side game according to the fifth embodiment. As shown in FIG. 29, a game machine according to the fifth embodiment includes: liquid crystal displays 10, which are a plurality of first display devices provided corresponding to respective ones of a plurality of players; a front panel displays 21, which is a second display provided in common to the plurality of players; a memory for storing first card set data including plural kinds of card data and second card set data including card data identical to the card data included in the first card set data; and a controller for controlling the first and second display devices and the memory, wherein the controller is programmed to: (a) execute a basic game; (b) display a predetermined number of players' cards on the liquid crystal displays 10 and a predetermined number of banker's cards on the front panel display 21, from among the plural kinds of cards contained in the first card set data, while in the basic game; (c) pay out to players a payment determined by comparing the players' cards and the banker's cards displayed in the process (b), while in the basic game; (d) execute a side game in a case where a predetermined condition is met in the basic game; (e) displays, on the liquid crystal displays 10 and the front panel display 21, high hand cards 74a to 74e, which are the players' cards, while in the side game; (f) determine at least one of special cards 75a to 75e to be dealt to each of the plurality of players, from among the plural kinds of cards contained in the second card set data stored in the memory, and display the special cards 75a to 75e dealt to each of the players on each of the liquid crystal displays 10 or front panel display 21 of at least a corresponding player; and (g) pay out a payment to players having special cards 75a to 75e which constitute a combination of the cards, in a case where combinations of the players' cards of the plurality of players, which are displayed on the front panel display 21, and the special cards 75a to 75e of the players, which are displayed on the front panel display 21, include a predetermined card combination. When a side game is started, a side game display image 70 is displayed which is indicative of the commencement of the side game. Further, five high hand cards 74a to 74e determined to be high hands of the PAIGOW poker and one of the special cards 75a to 75e are dealt to a plurality of players. After that, the cards dealt to the plurality of players are displayed on the front panel display 21. Here, dealt-card image display regions 71a to 71e dealt to each of players 1 to 5 are displayed; among them, high hand cards 74a to 74e of each of the players and the special cards 75a to 75e are displayed; and player displays 72a to 72c are displayed which is indicative of the fact that five players 1 to 5 are performing a side game. Furthermore, in the game machine of the present invention, a side-BET display image 73 is displayed for a player having accepted a side BET. Here, on the top right of the high hand cards 74a, 74b, and 74e of the players 1, 2, and 5 having accepted a side BET, the side-BET display image 73 is displayed so as to make identifiable the player having performed a side BET, and a winner or loser can also be determined among the players having performed such side BET.

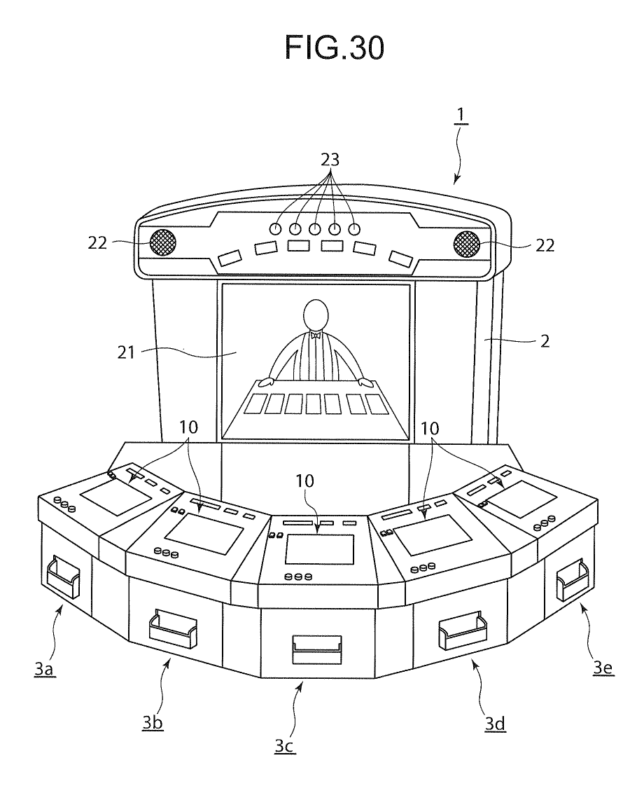

FIG. 30 is a perspective view schematically depicting an appearance and a configuration of a game machine according to a fifth embodiment of the present invention. As shown in FIG. 30, the game machine 1 is basically made up of a main monitor 2 and five stations 3 (stations 3a to 3e). While the present embodiment describes in detail a case in which the game machine 1 is provided with a plurality of stations 3 (five stations), the game machine may include over five stations in the present invention.

A front panel display 21 is provided at the center part of a main monitor 2, and an image indicative of a dealer and cards is displayed. The front panel display 21 is equivalent to a display device of the present invention. In addition, provided at the upper side of the main monitor 2 are: a speaker 22 for outputting music or effect sounds in accordance with the progress of a game executed by the game machine 1; and an LED23 that is lit at the time of various effects.

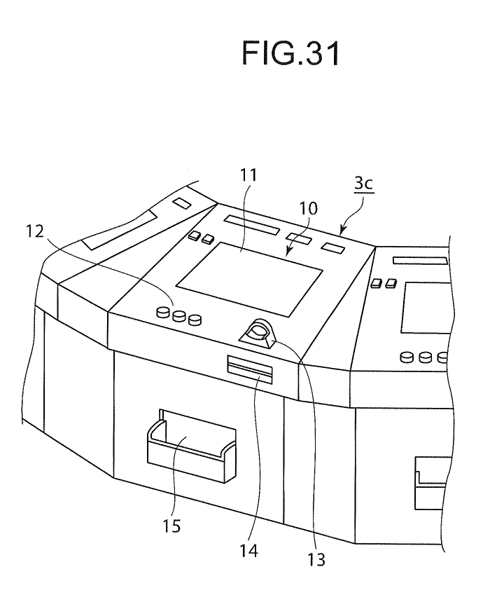

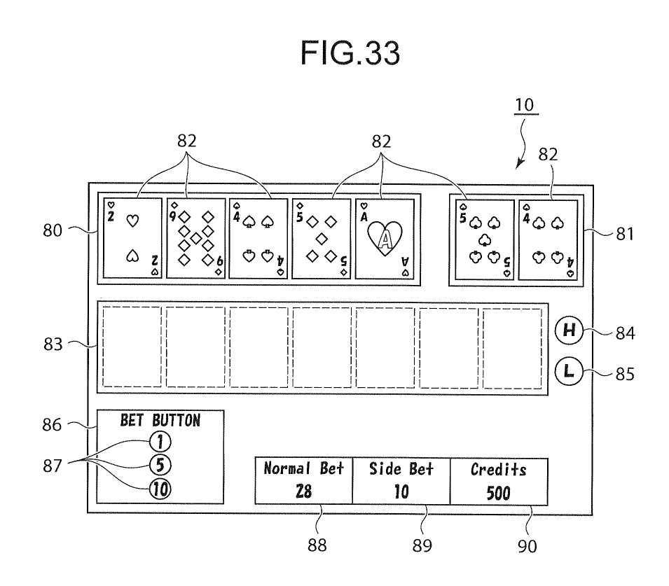

FIG. 31 is a perspective view schematically depicting an appearance and a configuration of stations included in the game machine shown in FIG. 30. As shown in FIG. 31, a liquid crystal display 10, which displays an image or the like pertinent to operation (see FIG. 33), as described later, is provided at the upper center of a station 3. In addition, a touch panel 11 for entering an operation such as BET is provided on the top face of the liquid crystal display 10. The touch panel 11 is equivalent to a BET switch, a side-BET switch, and an input switch, of the present invention.

An operational button 12 for making payout operation and a coin insertion slot 13 for inserting coins or medals are provided in front of the liquid crystal display 10. A bill insertion slot 14 for inserting bills is provided at the front top right end of the station 3. Provided downwardly of the bill insertion slot 14 is a coin payout opening 15 through which the coins or medals corresponding to stored credit are paid out to the players when payout operation is made.

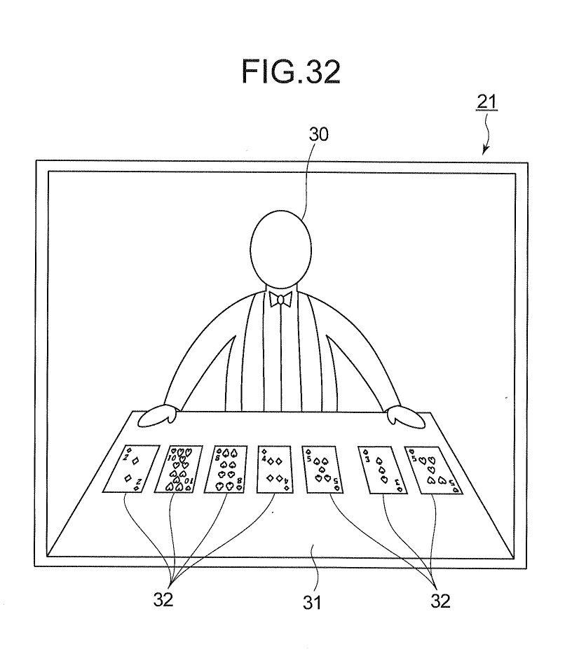

FIG. 32 is a view showing an exemplary image displayed on a front panel display included in a game machine. As shown in FIG. 32, the front panel display 21 displays a dealer image 30 indicating a dealer (banker), a table image 31 indicative of a table, and a card image 32 indicative of seven banker's cards. The card image 32 is displayed in a faced down manner when cards are dealt to the dealer. When a high hand and a low hand are determined, the card image 32 is displayed in a faced up manner. In FIG. 32, the left five cards toward the dealer indicate a high hand, and the right two cards indicate a low hand.

FIG. 33 is a view showing an exemplary image displayed on a liquid crystal display included in stations. As shown in FIG. 33, a high hand display section 80, which displays a player's high hand, and a low hand display section 81, which displays a low hand, are provided at the upper side of the liquid crystal display 10. The high hand display section 80 and the low hand display section 81 display card images 82 indicative of a high hand card and a low hand card, respectively, in a faced up manner.

A dealt-card display section 83 is provided at the lower side of the high hand display section 80. A card image indicative of the seven player's cards after dealt to each of the players is displayed in a faced up manner at seven portions enclosed by the dotted line of the dealt-card display section 83. A high hand determination button 84 and a low hand determination button 85, for determining cards constituting a high hand and a low hand, are provided at the right side of the dealt-card display section 83. A player can determine a high hand by selecting a card desired to be high hand, via a touch panel 11, from among the cards displayed at the dealt-card display section 83, and then, operating the high hand determination button 84. The card determined to be a high hand is displayed at the high hand display section 80. Similarly, the player determines a low hand by selecting a card desired to be a low hand, via the touch panel 11, from among the cards displayed at the dealt-card display section 83, followed by operating a low hand determination button 85 via the touch panel 11.

A BET button display section 86 is provided at the lower side of the dealt-card display section 83. The BET button display section 86 displays a BET button 87 for inputting a BET number. The player can input a normal BET number and a side BET number by operating a BET button 87 via the touch panel 11.

A normal BET number display section 88, which displays the number of normally betted coins, is provided at the right side of the BET button display section 86. It is shown here that 28 coins have been betted. In a case where betting of these 28 coins is input, the player may operate “10” of the BET button 87 twice, “5” of the BET button 87 once, and “1” of the BET button 87 three times.

A side-BET number display section 89, which displays the number of side-betted coins, is provided at the right side of the normal BET number display section 88. Here, it is shown that 10 coins have been betted. Further, a credit number display section 90 is provided at the right side of the side-BET number display section 89. Here, it is shown that 500 coins have been credited.

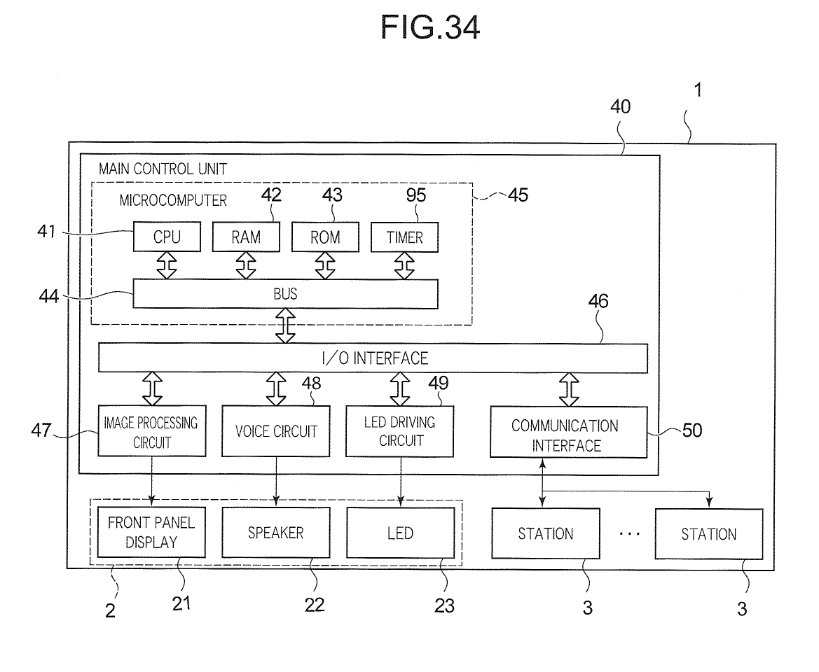

FIG. 34 is a block diagram depicting an internal configuration of the game machine shown in FIG. 30. As shown in FIG. 34, a main control unit 40 included in the game machine 1 is basically constituted while a microcomputer 45 made up of: a CPU (Central Processing Unit) 41; a RAM (Random Access Memory) 42; a ROM (Read Only Memory) 43; a timer 95; and a bus 44 for transferring data therebetween is employed as a base. The main control unit 40 is equivalent to a controller of the present invention.

The ROM43 stores: various programs for performing processing required for controlling the game machine 1; and a data table or the like. The RAM42 is a memory for temporarily storing various data computed by the CPU41. Further, the timer 95 performs a time measurement.

The CPU41 is connected via an I/O interface 46 to an image processing circuit 47, a voice circuit 48, an LED driving circuit 49, and a communication interface 50.

A front panel display 21 constituting a main monitor 2 is connected to the image processing circuit 47; a speaker 22 constituting the main monitor 2 is connected to the voice circuit 48; and an LED23 constituting the main monitor 2 is connected to the LED driving circuit 49. Five stations 3 are connected to the communication interface 50.

The CPU41 controls games (a PAIGOW poker and a side game) to be conducted in the game machine 1, based upon game programs (a PAIGOW poker game program and a side-game program) stored in the ROM43 and various signals received from the stations 3. Further, the CPU41 controls the front panel display 21 to display images, the speaker 22 to output sounds, and the LED23 to light, based upon the game programs. Furthermore, the CPU41 transmits various signals to the stations 3, based upon the above-mentioned game programs.

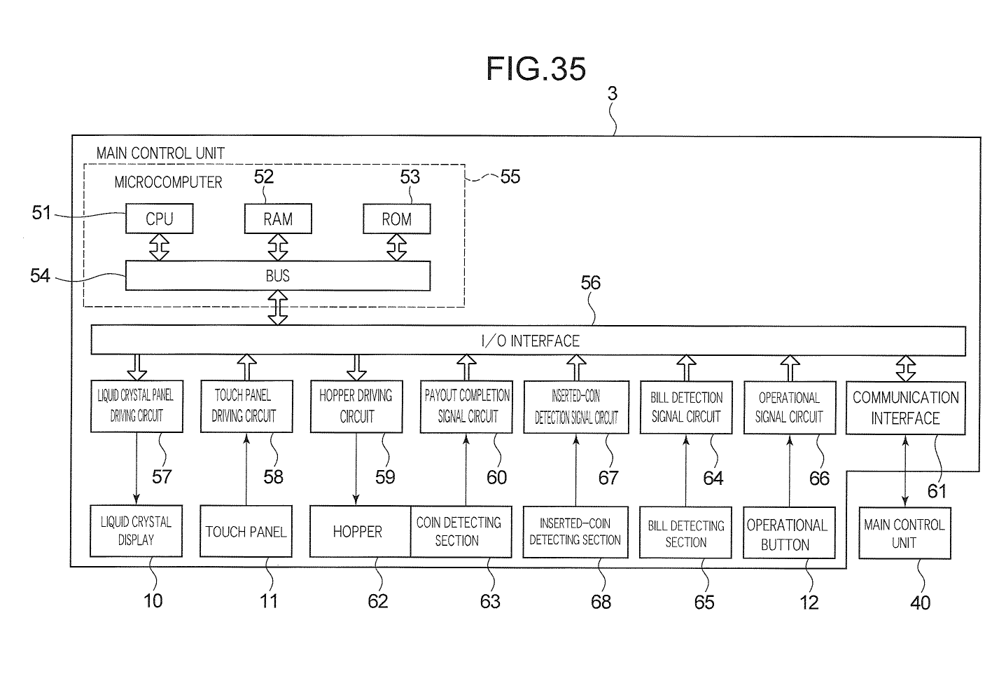

FIG. 35 is a block diagram depicting an internal configuration of each of the stations included in the game machine shown in FIG. 30. As shown in FIG. 35, stations 3 are basically constituted while microcomputers 55 made up of a CPU51, a RAM52, a ROM53, and a bus 54 for transferring data therebetween are employed as a base.

The ROM53 stores a variety of programs and data tables or the like, for performing processing required for controlling stations 3. In addition, the RAM52 temporarily stores the credit number currently stored in stations 3 and a variety of data computed by the CPU51.

In addition, the CPU51 is connected, via an I/O interface 56, to a liquid crystal panel driving circuit 57; a touch panel driving circuit 58; a hopper driving circuit 59; a payout complete signal circuit 60; an inserted-coin detection signal circuit 67; a bill detection signal circuit 64; an operation signal circuit 66; and a communication interface 61.

The liquid crystal display 10 is connected to the liquid crystal panel driving circuit 57; the touch panel 11 is connected to the touch panel driving circuit 58; a hopper 62 is connected to a hopper driving circuit 59; a coin detecting section 63 is connected to the payout complete signal circuit 60; an inserted-coin detecting section 68 is connected to the inserted-coin detection signal circuit 67; a bill detecting section 65 is connected to the bill detection signal circuit 64; and the operational button 12 is connected to the operation signal circuit 66, respectively.

The hopper 62 is provided inside the station 3 and serves to pay out coins from the coin payout opening 15, based upon a control signal output from the CPU51. The coin detecting section 63 is provided inside the coin payout opening 15, and transmits signals to the CPU51 in a case where it is detected that a predetermined number of coins have been paid out from the coin payout opening 15.

Upon detecting that coins have been inserted through the coin insertion slot 13, the inserted-coin detecting section 68 detects the amount of the detected coins, and then, transmits to the CPU51a detection signal indicative of the detected amount. The detected coins are stored in the RAM52 while a predetermined amount is handled as one credit.

At the time of acceptance of bills, the bill detecting section 65 detects the amount of the accepted bills, and then, transmits to the CPU51a detection signal indicating the detected amount. The detected bills are stored in the RAM52 while the predetermined amount is handled as one credit. The operation button 12 is intended for performing payout operation in a case where coin payout has been determined.

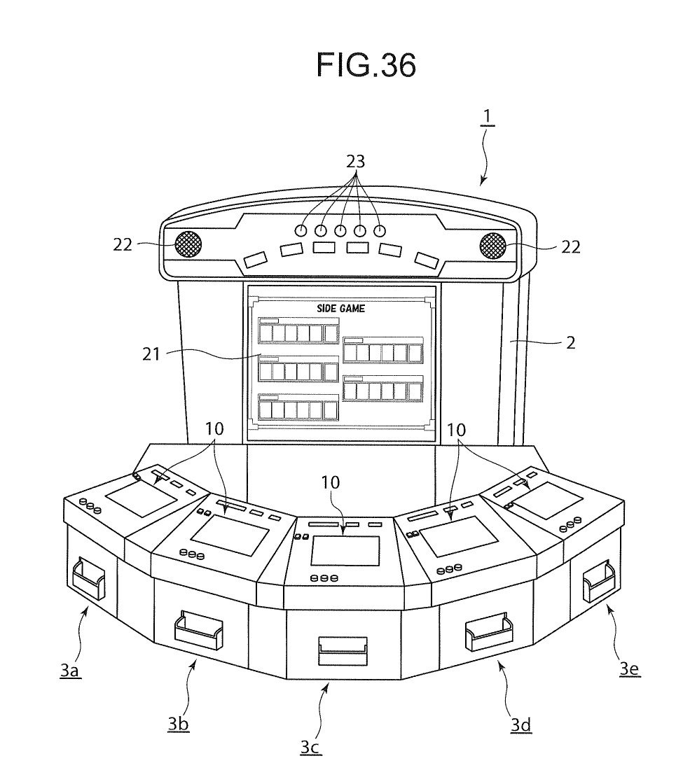

FIG. 36 is a view showing an exemplary image displayed on the front panel display of the game machine according to the fifth embodiment. As shown in FIG. 36, the game machine 1 is made up of the main monitor 2 and the five stations 3 (3a to 3e). When the side game is started, the liquid crystal display 10 displays side game dealt-cards (high hand cards and special cards) dealt to the players of the stations 3 (3a to 3e). Further, the front panel display 21 serves to display the side game dealt-cards dealt to the players of all of the stations 3a to 3e. After that, a payment is made to the players of the stations 3 (3a to 3e) in accordance with a poker combination realized by a combination of the high hand cards and special cards displayed on the front panel display 21.

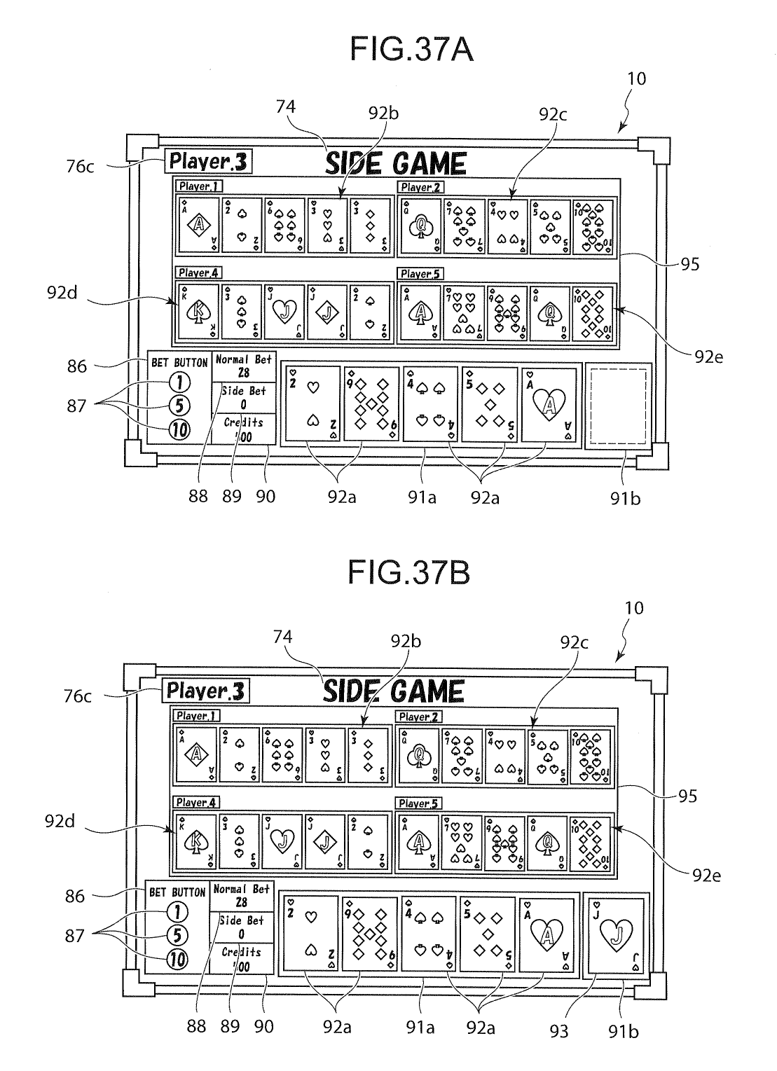

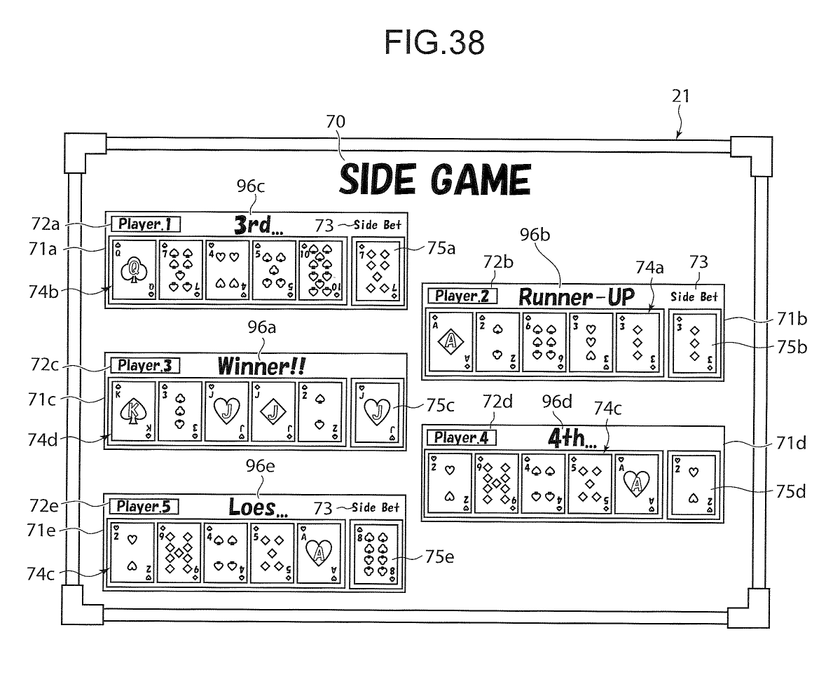

FIGS. 37 and 38 are views each showing an exemplary image displayed on the liquid crystal display 10 included in the station of player 3 in the side game according to the fifth embodiment. As shown in FIG. 37A, when a side game is started, the liquid crystal display 10 displays the side game display image 74, which is indicative of the commencement of the side game. A high hand card display section 95, which displays high hand cards 92b to 92e of each of the players, is provided at the center of the liquid crystal display 10. Further, a side game dealt-card display region 91a displays five high hand cards 92a which the player 3 selected in a basic game. Here, it is displayed that five high hand cards 92 “2 of Heart”, “9 of Diamond”, “4 of Spade”, “5 of Diamond”, and “Ace of Heart” were dealt. Furthermore, a special card display region 91b is provided at the right side of the side game dealt-card display region 91a. Still furthermore, a BET button display section 86; a normal BET number display section 88; a side BET number display section 89, which displays the number of side-betted coins; and a credit amount display section 90, are provided at the left side of the side game dealt-card display region 91a. Here, 28 coins are normally betted; 10 coins are side-betted; and 500 coins are credited. Further, a player number 72c is displayed, and it is indicated that player 3 is present at this station.

As shown in FIG. 38B, further, a special card 93 is dealt, and then, the dealt card is displayed in a special card display region 91b. Here, it is displayed that a card “Jack of Heart” was dealt. After that, with respect to whether or not a combination of the dealt one's own card 93, high hand cards 92b to 92e of other players, and one's own high hand card 92a is a predetermined combination and whether or not a combination of higher payment than those of such other players is realized, a winner or loser is determined by comparing the players' cards of all of the stations 3a to 3e.

As shown in FIG. 38, a display device 21 at the center of a main monitor 2 displays dealt-card image display regions 71a to 71e of the players. This display device displays correspondently high hand cards 74a to 74e (see FIG. 29) in which a combination with special cards 75a to 75e dealt to each of the players is realized which has the highest payment. Specifically, the dealt-card image display region 71a of player 1 originally displays a high hand card 74b (see FIG. 29) of player 2, and a card “7 of Spade” included therein and a card “7 of Diamond”, which is a special card 75a dealt to the player 1, forms a combination “One Pair”. Similarly, the side game dealt-card display region 71c of player 3 originally displays a high hand card 74d of the player 4 so that a combination with “Jack of Heart” serving as a dealt special card 75c is realized which has the highest payment, and “Three of a Kind” is realized as a winning combination. Further, when a winner or loser is determined by comparing the players' cards of all of stations 3a to 3e, winner-loser information displays 96a to 96e are displayed in the dealt-card image display regions 71a to 71e of the players. Here, since player 3 has a “Three of a Kind” composed of Jacks which has the highest payment among the players of all of the stations 3a to 3e, the side game dealt-card display region 71c displays a winner-loser information display 96a “Winner!!”. In addition, since a combination “Three 3s of a kind” has the second highest payment, the side game dealt-card display region 71b displays the winner-loser information display 96b “Runner-Up!!”. Further, for the player 1 who realized a combination “One Pair of 7s”, the dealt-card image display region 71a displays the winner-loser information display 96c “3^{rd}”. For the player 4 who realized a combination of “One Pair of 2s”, the side game dealt-card display region 71d displays the winner-loser information display 96d which is indicative of “4^{th}”. Then, the winner-loser information display 96e, which is indicative of “Lose”, is provided in a side game dealt-card display region 71e of player 5, in which a combination “No Pair” is realized which is indicative of the fact that no card combination is realized in special card 75e and high hand cards 74a to 74e of all of the players. After that, a payment determined by comparing a plurality of cards owned by each of the players is paid out.

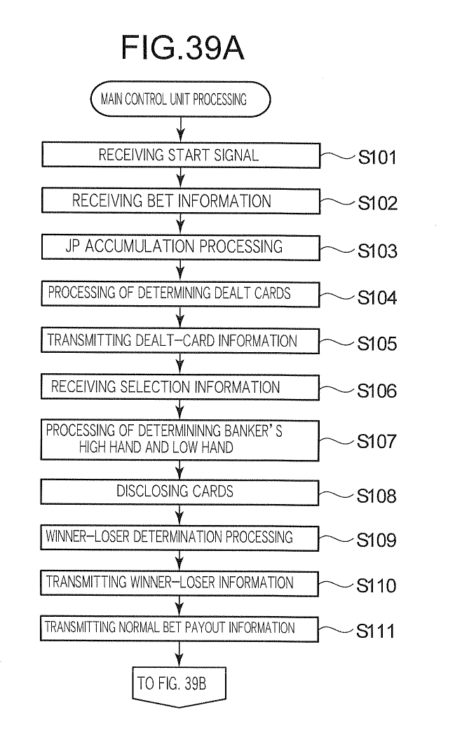

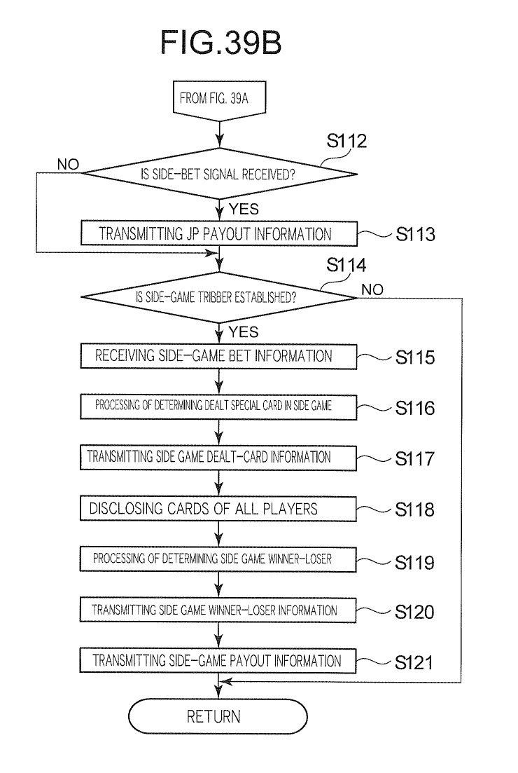

Next, the processing performed at the main control unit 40 and stations 3 will be described in detail. FIG. 39A and FIG. 39B are flowcharts each showing main control unit processing executed at the main control unit included in the game machine according to the fifth embodiment. In this processing operation, at first, the CPU41 included in the main control unit 40 receives a start signal (step S110). Specifically, the CPU41 receives the start signal from any of the stations 3. The start signal serves as a trigger for conducting a PAIGOW poker game in the game machine 1.

Next, the CPU41 receives BET information from the stations 3 (see FIG. 30) (step S102). The BET information is pertinent to BETs, and includes: information indicative of whether or not a normal BET and a side BET have been performed; and information indicative of the amounts of the normal BET and the side BET.

Next, the CPU41 executes JP accumulation processing (step S103). Specifically, the CPU41 accumulatively stores, in the RAM42 (see FIG. 6), 50% (predetermined rate) of the side-betted credit as JP, based upon the BET information received at step S102.

Next, the CPU41 executes dealt-card determination processing (step S104). In this processing operation, the CPU41 determines seven cards to be dealt to each of the persons consisting of the players and banker from among one set of trump cards, with the use of random numbers. The seven cards determined to be dealt to the players at the step S104 are equivalent to the player's cards, and the seven cards determined to be dealt to the banker are equivalent to the banker's cards. Further, the front panel display 21 (see FIG. 30) included in the game machine 1 displays a card image indicative of the seven banker's cards in a faced down manner.

Next, the CPU41 transmits dealt-card information (step S105). Specifically, the CPU41 transmits the dealt-card information to the station 3. The dealt-card information is inclusive of information which is indicative of kinds of cards determined to be dealt to the players and banker (suits (Heart, Clover, Spade, and Diamond)). The station 3 causes the liquid crystal display 10 to display a card image which is indicative of seven player's cards, based upon the received dealt-card information. This station also accepts entry for dividing the dealt cards into a group of five cards (high hand) and a group of two cards (low hand).

Next, the CPU41 receives selection information from the station 3 (step S106). The selection information indicates which ones of the cards after dealt to each of the players have been selected as a high hand, and which ones of the cards have been selected as a low hand.

Next, the CPU41 executes processing of determining a banker's high hand and low hand (step S107). In this processing operation, the CPU41 executes processing of dividing the cards after dealt to the banker into a high hand and a low hand.

Next, the CPU41 discloses cards (step S108). Specifically, the CPU41 displays in a faced up manner on the front panel display 21 the card images indicative of the high hand and the low hand determined at the step S106.

Next, the CPU41 performs a winner-loser determination processing (step S109). In this processing operation, the CPU41 executes processing of determining a winner or loser, based upon the selection information received at the step S107 and the high hand and the low hand determined at step S107. Namely, this CPU executes processing of determining a winner or loser after comparing the players' hands of the cards after dealt to the players and the banker's card hands. Specifically, it is judged as to which one of the players' hands is strong or weak after comparing the players' high hands with the banker's high hand. In addition, it is also judged as to which one is strong or weak after comparing the players' low hands with the banker's low hand. Further, the winner or loser is determined based upon the judgment results. Specifically, in a case where the player's high hand is stronger than the banker's high hand and in a case where the player's low hand is stronger than the banker's low hand, it is judged to be the player's win. In a case where the banker's high hand is stronger than the player's high hand and in a case where the banker's low hand is stronger than the player's low hand, it is judged to be the banker's win. Even if the player is stronger at one of the high and low hands, in a case where the banker is stronger at the other one, it is judged to be “draw”.

Next, the CPU41 transmits winner-loser information (step S110). Specifically, the CPU41 transmits to the station 3 the information indicative of the winner or loser determined at the step S111 (hereinafter, referred to as winner-loser information). Upon the receipt of the winner-loser information, based upon the received winner-loser information, the liquid crystal display 10 displays any one of the images inclusive of the messages “You Win”, “You Lose”, and “Draw”.

Next, the CPU41 performs the processing of transmitting normal-BET payout information (step S111). In this processing operation, the CPU41 transmits the normal-BET payout information to the station 3. The normal-BET payout information is generally indicative of the amount of credit (currency values) to be paid out to BET. Specifically, in a case where the player has won, this CPU transmits information indicative of credit of which amount is twice of that of normal BET. In a case where the outcome of the game is “draw”, the CPU transmits information indicative of credit of which amount is equal to that of normal BET. In addition, in a case where the banker has won, the CPU transmits information indicative of the fact that an amount of given credit is 0.

Next, in FIG. 39B, the CPU41 judges whether or not a side BET signal has been received (step S112). Specifically, the CPU41 judges whether or not a signal has been received which is indicative of the fact that the side BET has been performed. When the CPU41 judges that no side BET signal has been received (step S112: NO), the routine proceeds to step S14.

On the other hand, when it is judged that a side BET signal is received (step S112: YES), JP payout information is transmitted to the station 3 (step S113). The JP payout information is indicative of the amount of JP credit (currency value) to be paid out to the side BET. Specifically, in a case where the player has won, when a high hand is “Royal Flush”, the CPU41 transmits information indicative of credit equivalent to a total amount of JP. When the player's high hand is “Straight Flush”, this CPU transmits information indicative of credit equivalent to 50% of JP, and when the player's high hand is a hand other than the above, this CPU transmits information indicative of a credit equivalent to 10% of JP. In addition, in a case where the result is “draw”, this CPU transmits information indicative of a credit of which amount is equal to that of a side BET. Moreover, in a case where the banker has won, this CPU transmits the fact that the amount of credit given is 0.

While the embodiment of the present invention describes a case in which, when the player has won in a PAIGOW poker at the time of a side BET, where “Royal Flush” is realized at the high hand, 100% of JP is given, where “Straight Flush” is realized at the high hand, 50% of JP is given, and where any other combination is realized at the high hand, 10% of JP is given. In the embodiment of the present invention, a correspondence relationship between the amount of JP given and a hand is not limitative thereto. In the present invention, further, in a case where the player has won in the PAIGOW poker at the time of side BET, all of the currency values accumulatively stored as JP may be given, regardless of the hand.

The embodiment of the present invention described a case in which a correspondence relationship between a player's hand and a payment (JP) to be paid out, in the PAIGOW poker at the time of side BET is preset. In the present invention, however, the correspondence relationship between the player's hand and the payment to be paid out may be randomly varied every time the PAIGOW poker is performed at the time of a side BET.

Further, while the embodiment of the present invention describes a case of paying out credit of which amount is equal to that of side BET in a case where the result is “draw”, the above payout of the credit may not be performed.

Next, the CPU41 judges whether or not a side game trigger is established (step S114). Specifically, the CPU41 executes the programs stored in the RAM 42, thereby sampling random number values from among the numeric range of predetermined random number values and judging whether or not a side game trigger is established based upon the sampled random number values. The CPU41 terminates main control unit processing when it executes the processing of step S114 upon judging that a side game trigger has not been established (step S114: NO). In another embodiment of the present invention, further, judgment of whether or not a side game trigger is established is made based upon whether or not a side BET has been performed in advance.

On the other hand, upon judging that a side-game trigger has been established (step S114: YES), the CPU41 receives side-game BET information from the station 3 (see FIG. 30) (step S115).

Next, the CPU41 executes processing of determining a special card dealt in a side game (step S116). In this processing operation, with the use of random numbers, the CPU41 determines each of the special cards dealt to players from among another group of trump card data which is different from that used in the PAIGOW poker serving as a basic game.

Next, the CPU41 transmits information on cards to be dealt in the side game (step S117). Specifically, the CPU41 transmits, to the station 3, information on cards after dealt in the side game. The side game dealt-card information is inclusive of information which is indicative of suits (heart, club, spade, and diamond) of the cards determined to be dealt to the players. At the station 3, based upon the received dealt-card information, the liquid crystal display 10 displays a card image indicative of six player's cards consisting of five high hand cards and one special card dealt to each of the players in the PAIGOW poker.

Next, the CPU41 discloses all the players' cards (step S118). Specifically, the CPU41 controls the liquid crystal display 10 of the corresponding station 3 to display, in a faced up manner, five high hand card images of all of the players determined at step S107 (five groups of 25 cards); and one special card for each of the players determined at step S116 (see FIG. 37). Further, the CPU41 controls the front panel display 21 to display five high hand card images of all of the players determined at step S107 (five groups of 25 cards) determined at step S116 (five cards) (see FIG. 36).

Next, the CPU41 performs a side game winner-loser determination processing (step S119). In this processing operation, the CPU41 executes processing of determining a winner or loser, based upon the dealt cards of all of the players in the side game, which were disclosed at step S118. Specifically, this CPU judges which one of the card combinations is strong or weak by comparing the cards of all of the players, and then, determines the winner or loser, based upon the judgment result. Here, any one of the predetermined combinations is realized in card combinations between one special card dealt to each of the players and plural common cards contained in each of the five groups of high hand cards of all of the players, and it is judged which one of the card combinations is strong or weak. The predetermined combinations denote “Royal Flush”, “Straight Flush”, “Four of a Kind”, “Full House”, “Flush”, “Straight”, “Three of a Kind”, “Two Pairs”, “One Pair”, and “No pair” in order of strength, among the five cards.

Next, the CPU41 transmits side game winner-loser information (step S120). Specifically, the CPU41 transmits to a station 3 the winner-loser information which is indicative of a winner or loser of the side game determined at step S120. At the station 3, upon the receipt of winner-loser information, the liquid crystal display 10 displays any one of the images which are inclusive of messages “Winner!!”, “Runner-Up!!”, “3^{rd}”, “4^{th}”, and “Lose”, based upon the received winner-loser information.

Next, the CPU41 transmits side game payout information to the station 3 (step S121). The side game payout information is indicative of an amount of credit (currency value) to be paid out in the side game. Specifically, this CPU transmits the information which is indicative of the credit determined based upon the combinations “Royal Flush”, “Straight Flush”, “Four of a Kind”, “Full House”, “Flush”, “Straight”, “Three of a Kind”, “Two Pairs”, “One Pair”, and “No pair”. The CPU41 terminates main control unit processing upon executing the processing of step S121.

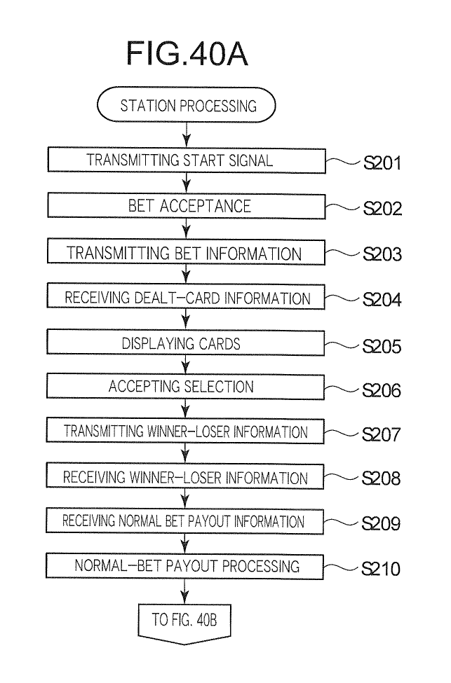

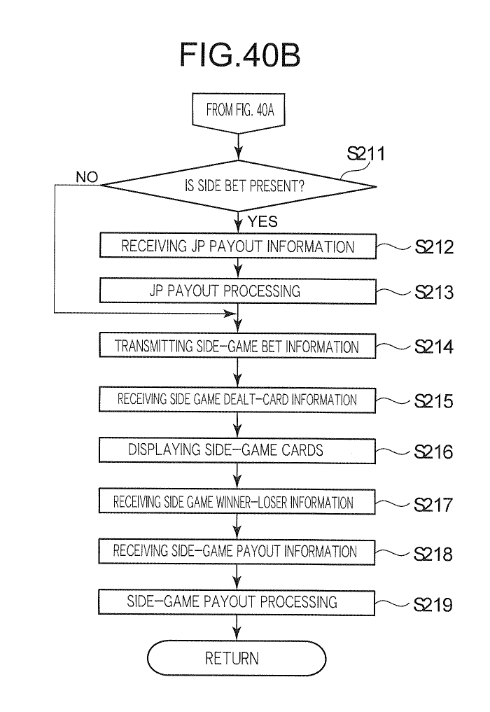

Next, the processing to be performed at the station 3 will be described in detail. FIGS. 40A and 40B are flowcharts each showing a subroutine of the station processing executed at each of the stations according to the fifth embodiment. In this processing operation, at first, the CPU51 included in the station 3 transmits a start signal to the main control unit 40 upon the receipt of signal indicative of the fact that a touch from the touch panel 11 has been sensed or that coin insertion has been detected from the entered-coin detecting section 68 (step S201). In this manner, at the main control unit 40, the processing operations shown in FIGS. 39A and 39B are conducted.

Next, the CPU51 accepts entries of the normal BET and side BET (step S202). This allows the player to enter the normal BET and the side BET via the touch panel 11 included in the station 3. Upon the receipt of a signal indicative of the fact that entry of the side BET has been made, the CPU51 sets a side-BET flag. This side-BET flag is set in a case where entry of the side BET has been made.

Next, the CPU51 transmits to the main control unit 40, BET information serving as information pertinent to an input BET (step S203). Upon the receipt of the BET information, the main control unit 40 determines cards to be dealt to the players and the banker (see step S104 of FIG. 39A).

Next, the CPU51 receives from the main control unit 40 the dealt-card information indicative of the cards after dealt to the players (step S204). Specifically, the CPU51 receives the dealt-card information transmitted at step S105 of FIG. 39A, and then, stores the received information in a RAM.

Next, the CPU51 displays cards (step S205). Specifically, the CPU51 displays a card image indicative of the seven player's cards at the dealt-card display section 83 of the liquid crystal display 10, based upon the dealt-card information received at step S204.

Next, the CPU51 accepts entry for selecting high hands and low hands (step S206). This allows the players to determine high hands and low hands from among the dealt cards by operating a high hand determination button 84 and a low hand determination button 85 via the touch panel 11.

Next, the CPU51 transmits to the main control unit 40 the selection information that is based upon selection of high hands and low hands (step S207). Upon the receipt of the selection information, the main control unit 40 determines a high hand and a low hand of the banker's cards, and then, executes processing of determining a winner or loser (see step S108 of FIG. 39A).

Next, the CPU51 receives winner-loser information from the main control unit 40 (step S208). Subsequently, the dealt-card display section 83 of the liquid crystal display 10 displays any one of the images inclusive of the messages “You Win”, “You Lose”, and “Draw”, during a predetermined period of time, based upon the received winner-loser information.

Next, the CPU51 receives normal-BET payout information from the main control unit 40 (step S209). Upon the receipt of the normal-BET payout information, the CPU51 stores in the RAM52 the credit data that is based upon the normal-BET payout information.

Next, the CPU51 receives normal-BET payout information, based upon the normal-BET payout information received at step S209 (step S210). In this normal-BET payout processing, in a case where a player has won, payout is performed, based upon information indicative of a credit of which amount is twice of that of the normal BET; and in a case where the result is “draw”, payout is performed, based upon information indicative of a credit of which amount is equal to that of the normal BET. In addition, in a case where the banker has won, information indicative of the fact that the amount of credit to be given is 0 is displayed.

Next, in FIG. 40B, the CPU51 judges whether or not entry of side BET has been made, while in the BET acceptance at step S202 (step S211). Specifically, the CPU51 judges whether or not a side-BET flag is set. When the CPU41 judges that entry of the side BET has not been made (step S211: NO), the routine proceeds to step S214.

On the other hand, upon judging that entry of the side BET has been made (step S211: YES), the CPU51 receives JP payout information (step S212). Specifically, the CPU51 receives JP payout information from the main control unit 40. Upon the receipt of the JP payout information, the CPU51 stores in the RAM52 the credit data that is based upon the JP payout information.

Next, the CPU51 executes JP payout processing (step S213). Specifically, the CPU51 pays out credit, based upon the JP payout information received at step S212.

Next, the CPU51 transmits side game BET information (step S214). Specifically, the CPU51 transmits, to the main control unit, BET information pertinent to an entered BET. The BET information is indicative of information which is indicative of whether or not a normal BET and a side BET have been performed and information indicative of amounts of the normal BET and side BET.

Next, the CPU51 receives from the main control unit 40 the side game dealt-card information indicative of the cards after dealt to the players in the side game (step S215). Specifically, the CPU51 receives the dealt-card information transmitted at step S117 of FIG. 39B.

Next, the CPU51 displays side-game cards (step S216). Specifically, the CPU51 displays a card image 76, which is indicative of the five player's cards, at the dealt-card display section 83 of the liquid crystal display 10, based upon the side game dealt-card information received at step S215.

Next, the CPU51 receives side game winner-loser information from the main control unit 40 (step S217). Then, based upon the received winner-loser information, the CPU51 controls the dealt-card display section 83 of the liquid crystal display 10 to display, for a predetermined period of time, an image which is inclusive of any one of the messages “Winner!!”, “Runner-Up!!”, “3^{rd}”, “4^{th}”, and “Lose”.

Next, the CPU51 receives the side-game payout information (step S218). Upon the receipt of the side-game payout information, the CPU51 stores in the RAM52 the credit data that is based upon the side-game payout information.

Next, the CPU51 executes side game payout processing, based upon the received side game payout information at step S218 (step S219). Specifically, the CPU51 pays out credit, based upon the received side game payout information at step S218, in a case where a combination of the side-betted player's cards is realized as a predetermined combination.

### 6. Sixth Embodiment

Next, the game machine 1 according to a sixth embodiment will be described in detail with referring to the drawings. The game machine 1 according to the sixth embodiment that follows has an appearance and a circuit construction or the like, which are substantially similar to those according to the fifth embodiment of the present invention. Thus, a duplicate description of like construction is omitted here. Also, like constituent elements corresponding to those of the game machine 1 are designated by like reference numerals and are explained.

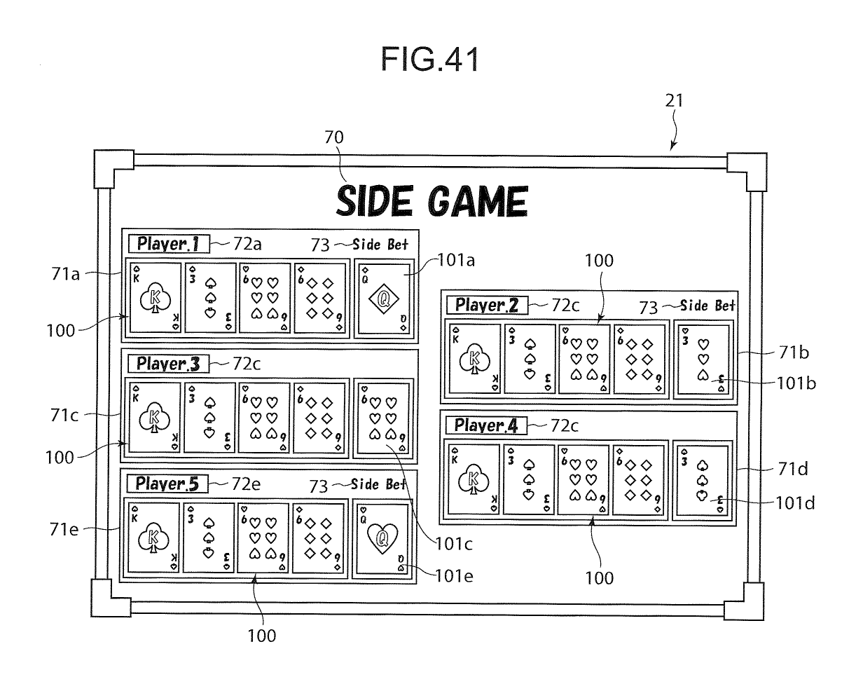

FIG. 41 is a view showing an exemplary image displayed on a front panel display 21 in a side game according to the sixth embodiment. As shown in FIG. 41, when a side game is started, a side game display image 70 is displayed which is indicative of the commencement of the side game. Further, the front panel display 21 displays: four common cards 100 and special cards 101a to 101e, which were dealt as side-game dealt cards to a plurality of players; and the dealt cards on a plural-players basis. Here, this display 21 displays: a common card image 100 dealt to each of players 1 to 5; special cards 101a to 101e dealt to the respective players; and player displays 72a to 72e, which are indicative of the fact that five players 1 to 5 are performing a side game. Furthermore, a side BET display image 73 is displayed for a player having accepted a side BET. Here, on the special cards of players 2, 3, and 5 having accepted a side BET, the side BET display image 73 is displayed so as to make identifiable the player having performed the side BET.

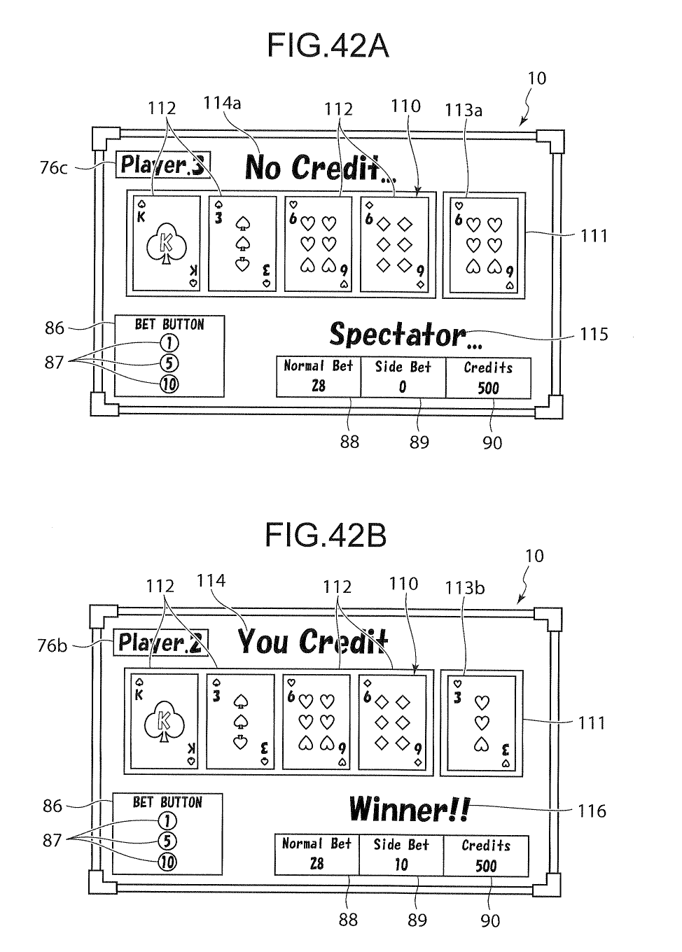

FIG. 42 is a view showing an exemplary image displayed on a liquid crystal display 10 included in a station 3 of a player in a side game. FIG. 42A shows a liquid crystal display at the station 3 of a player 3. When the side game is started, a common card display region 110 displays four common cards 112 “King of club”, “3 of Spade”, “6 of Heart”, and “6 of Diamond” for the side game in association with the contents of a front panel display 21. Then, a special card display region 11 displays a card, “6 of Spade”, which serves as a special card 113a. In addition, a BET button display section 86 is provided at the lower side of the common card display region 110. Further, a normal BET number display section 88; a side BET number display section 89, which displays the number of side-betted coins; and a credit number display section 90, are provided at the lower side of the common card display region 110. Here, 28 coins are normally betted, no coins are side-betted, and 500 coins are credited. Then, a player number 72c is displayed, and it is shown that the player 3 is present at this station. Furthermore, the liquid crystal display 10 displays a side game credit image 114a which is indicative of the fact that no side BET is performed. In other words, this display 10 displays a side game credit image 114a which is indicative of the fact that no side bet is made, and also displays a side game result display 115 which is indicative of the fact that no player participate in the side game.

As shown in FIG. 42B, when the side game is started, the common card display region 110 of the player 2 also displays four common cards 112 “King of Club”, “3 of Spade”, “6 of Heart”, and “6 of Diamond” and a special card 113b “3 of Heart” in association with the contents of the front panel display 21. Here, 28 coins are normally betted, 10 coins are side-betted, and 500 coins are credited. Then, the liquid crystal display 10 displays a side game credit image 114b which is indicative of the fact that a side BET has been performed. Because the side BET was already performed, in a case where the dealt common card 92 and the special card 112 form a predetermined combination and a combination with a higher payment than that of other players is realized, a side game result display is displayed which is indicative of the fact that a payment is paid out. Here, because a combination “Two Pairs” was the strongest among the players of all stations 3a to 3e (see FIG. 41), the side game result display 116 “Winner!!” is displayed, and a payment determined by comparing a plurality of cards owned by the players is paid out.

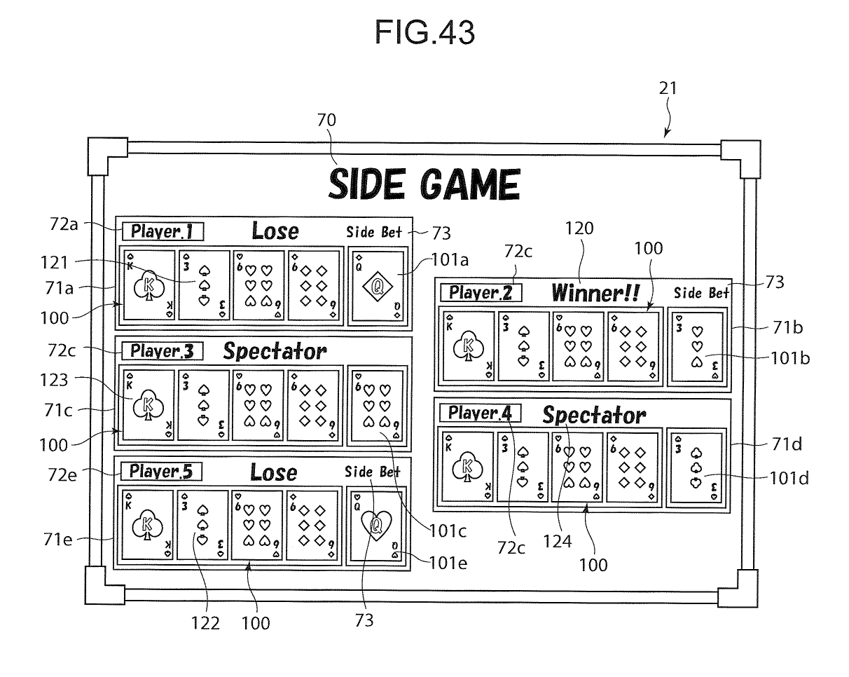

As shown in FIG. 43, when the side game result is determined, dealt-card image display regions 71a to 71e of the players on the front panel display 21 display the side game result displays 120 to 124 which are indicative of the side game result. For example, in a side game dealt-card display region 71c of the player 3, because the player 3 did not perform a side BET, even if “Three of a Kind” is realized as a combination between the common cards 100 and the special card 101c, a result information result display “Spectactor” 123 is provided which is indicative of the fact that no player participated in the side game. Further, the player 4 also did not perform a side BET, a result information display “Spectator” 124 is provided which is indicative of no participation of the player 4. In the side game dealt-card display region of the player 2, because the player 2 realizes a combination with the special card “One Pair” with the highest payment, among players 1, 2, and 5 having performed a side BET, the result information display “WINNER” 120 is displayed. Then, the dealt-card display regions 71a and 71e of the players 1 and 5 display result information displays “Lose” 121 and 122.

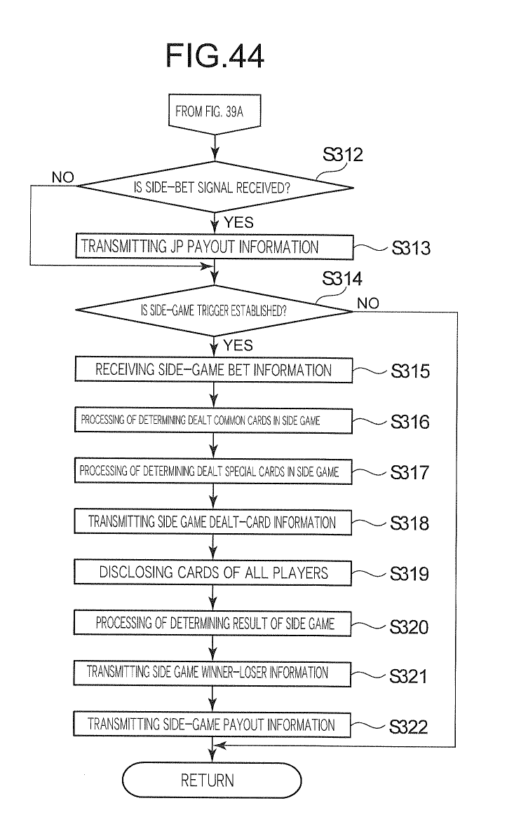

FIG. 44 shows a subroutine of main control unit processing performed after processing is performed in the same manner as that in FIG. 39A serving as a flowchart showing a subroutine of the main control unit processing executed at the stations according to the sixth embodiment. First, the CPU41 judges whether or not a side BET signal has been received (step S312). Specifically, this CPU judges whether or not a signal has been received which is indicative of the fact that a player is performing a side BET. When judging that no side BET signal has been received (step S312: NO), the CPU41 proceeds to step S314.

On the other hand, when judging that the side BET signal has been received (step S312: YES), the CPU41 transmits JP payout information to the station 3 (step S313). The JP payout information is indicative of the amount of JP credit (currency value) paid out in response to the side BET. Specifically, where a player has won, for example, where a combination “Royal Flush” is realized at the player's high hand, information is transmitted which is indicative of a credit equivalent to 100% of JP; where “Straight Flush” is realized at the player's high hand, information is transmitted which is indicative of 50% of JP; and where any other combination is realized at the player's high hand, information is transmitted which is indicative of a credit equivalent to 10% of JP. Further, where the result is “Draw”, information is transmitted which is indicative of a credit of which amount is equal to that of the side BET. Furthermore, where the banker has won, information is transmitted which is indicative of the fact that the amount of credit to be given is 0.

While the embodiment of the present invention described a case in which, when a player has won in the PAIGOW poker at the time of a side BET, where “Royal Flush” is realized at the player's high hand, 100% of JP is given; where “Straight Flush” is realized at the player's high hand, 50% of JP is given; and where any other combination is realized at the player's high hand, 10% of JP is given, a correspondence relationship between the amount of JP to be given and the hand is not limitative thereto. In the present invention, where the player has won in the PAIGOW poker at the time of a side BET, all of the currency values accumulatively stored as JP may be given.

While the embodiment of the present invention described a case in which a correspondence relationship between the players' hands in the PAIGOW poker at the time of a side BET and a payment (JP) to be paid out is preset, a correspondence relationship between the players' hands and the payment to be paid out may be randomly changed every time the PAIGOW poker is performed at the time of the side BET.

Further, while the embodiment of the present invention described a case in which a credit of which amount is equal to that of the side BET is paid out in the case of “Draw,” a payout may not be performed in that case.

Next, the CPU41 judges whether or not a side game trigger is established. Specifically, the CPU41 executes the program stored in the RAM42, thereby sampling random number values from a numeric-value range of predetermined random numbers, followed by judging whether or not the side game trigger has been established, based upon the sampled random number values. When judging that no side game trigger has been established (step S314: NO), the CPU41 terminates main control unit processing.

On the other hand, when judging that the side game trigger has been established (step S314: YES), the CPU41 receives side-game BET information from the station 3 (see FIG. 30) (step S315).

Next, the CPU41 executes processing of determining common dealt cards in the side GAME (step S316). In this processing operation, with the use of the random numbers, the CPU41 determines four cards dealt to each of the players from among one group of trump cards.

Next, the CPU41 executes processing of determining special dealt-cards in the side game (step S317). In this processing operation, the CPU41 determines cards dealt to the players, on a one-by-one card basis, from among another group of trump cards, which is different from one group of trump cards in which common cards were determined at step S316 with the use of random numbers.

Next, the CPU41 transmits side game dealt-card information (step S318). Specifically, the CPU41 transmits the side game dealt-card information to the station 3. The side game dealt-card information is inclusive of information which is indicative of suits (Heart, Clover, Spade, and Diamond) of cards determined to be dealt to the players. At the station 3, the liquid crystal display 10 displays a card image which is indicative of five player's cards consisting of four common cards and one special card, based upon the received dealt-card information.

Next, the CPU41 discloses all players' cards (step S319). Specifically, the CPU41 controls the front panel display 21 to display, in a faced up manner, an image of four common cards determined at step S316 and one special card determined at step S317 (see FIG. 36).

Next, the CPU41 performs a side-game result determination processing (step S320). In this processing operation, the CPU41 executes processing of determining participation, non-participation, and a winner or loser, based upon the side game dealt-cards of all of the players, which were disclosed at step S319. Specifically, this CPU judges whether or not the side BET of all of the players is performed, and then, defines the players having performed the side BET as participation and those not having it as non-participation. Further, the CPU41 judges which one of the card combinations is strong or weak, by comparing the cards of the players having participated in the side game, and determines a winner or loser, based upon the judgment result. Here, any one of the predetermined combinations is realized in five player's cards, and it is judged which one of the card combinations is strong or weak. The predetermined combinations denote “Royal Flush”, “Straight Flush”, “Four of a Kind”, “Full House”, “Flush”, “Straight”, “Three of a Kind”, “Two Pairs”, “One Pair”, and “No pair” in order of strength, among the five cards.

Next, the CPU41 transmits side-game result information (step S321). Specifically, the CPU41 transmits to the station 3 the result information which is indicative of the result of the side game determined at step S320. At the station 3, upon the receipt of result information, the liquid crystal display 10 displays any one of the images which are inclusive of the messages “Winner!!”, “Runner-Up!!”, “Lose”, and “Spectator”, based upon the received result information.

Next, the CPU41 transmits side-game payout information to the station 3 (step S322). The side-game payout information is indicative of the amount of credit (currency value) to be paid out in the side game. Specifically, this CPU transmits information which is indicative of the credit determined based upon the combinations “Royal Flush”, “Straight Flush”, “Four of a Kind”, “Full House”, “Flush”, “Straight”, “Three of a Kind”, “Two Pairs”, “One Pair”, and “No pair”. The CPU41 terminates main control unit processing upon executing the processing of step S322.

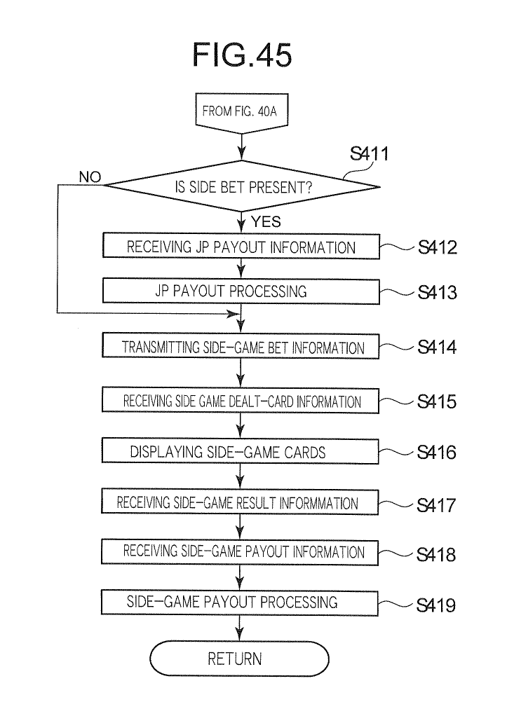

Processing operations performed at the station 3 will be described in detail. FIG. 45 shows a subroutine of station processing performed after processing is performed in the same manner as that of FIG. 40A serving as a flowchart showing a subroutine of station processing executed at the station according to the sixth embodiment. First, the CPU51 judges whether or not a side BET has been entered during BET acceptance at step S202 (step S411). Specifically, the CPU51 judges whether or not a side-BET flag is set. When judging that no side-BET has been entered (step S411: NO), the CPU41 proceeds to step S414.

On the other hand, when judging that the side BET has been entered (step S411: YES), the CPU51 receives JP payout information (step S412). Specifically, the CPU51 receives JP payout information from a main control unit 40. Upon the receipt of JP payout information, the CPU51 stores in a RAM52 the credit data that is based upon the received JP payout information.

Next, the CPU51 executes JP payout processing (step S413). Specifically, the CPU51 pays out credit, based upon the received JP payout information at step S412.

Next, the CPU51 transmits side-game BET information (step S414). Specifically, the CPU51 transmits, to the main control unit, BET information pertinent to the entered BET. The BET information is inclusive of information which is indicative of whether or not a normal BET and a side BET have been performed or information which is indicative of the amounts of normal BET and side BET.

Next, the CPU51 receives from the main control unit 40 the side game dealt-card information which is indicative of the cards dealt to the players in the side game (step S415). Specifically, the CPU51 receives the side game dealt-card information consisting of the common-card information and special-card information that were transmitted at step S318 of FIG. 42.

Next, the CPU51 displays dealt cards in the side game (step S415). Specifically, based upon the received side game dealt-card information at step S416, the CPU51 controls the common card display region 110 and the special card display region 111 of the liquid crystal display 10 to display card images which are indicative of five player's cards consisting of four common cards and one special card.

Next, the CPU51 receives side game result information from the main control unit 40 (step S417). Then, based upon the received result information, the CPU51 controls the dealt-card display section 83 of the liquid crystal display 10 to display, for a predetermined period of time, any one of the images which are inclusive of messages “Winner!!”, “Runner-Up!!”, “Lose”, and “Spectator”.

Next, the CPU51 receives side-game payout information (step S418). Specifically, upon the receipt of the side-game payout information, the CPU51 stores in the RAM52 the credit data that is based upon the received side-game payout information.

Next, the CPU51 executes side-game payout processing, based upon the received side-game payout information at step S418 (step S419). Specifically, in this processing operation, where a combination of the side-betted player's cards is realized as a predetermined combination, the CPU51 pays out credit, based upon the received side-game payout information at step S418.

### 7. Seventh Embodiment

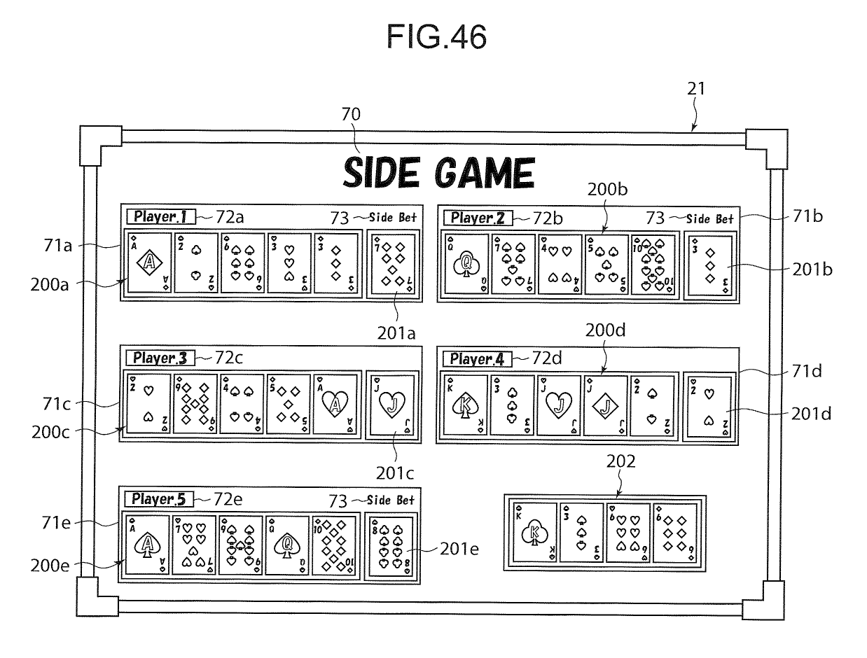

FIG. 46 is a view showing an exemplary image displayed on the front panel display in a side game according to the seventh embodiment. As shown in FIG. 29, when a side game is started, a side-game display image 70 is displayed which is indicative of the commencement of the side game. Further, five high hand cards, determined to be a high hand of the PAIGOW poker, and one special card are dealt as side game dealt-cards to a plurality of players. Then, the cards dealt to the plurality of players are displayed on the front panel display 21. Here, dealt-card image display regions 71a to 71e are displayed which is indicative of the fact that cards were dealt to each of the players 1 to 5; among them, high hand cards 200a to 200e and special cards 75a to 75e are displayed; and player displays 72a to 72c are displayed which is indicative of the fact that five players 1 to 5 are performing a side game. Further, a side-BET display image 73 is displayed for the players having accepted a side BET. Here, on the right top of a card image 71 of the players 2, 3, and 5 having accepted the side BET, the side-BET display image 73 is displayed so as to make identifiable the players having performed the side BET. Then, a common card 202 is also displayed as a side-game dealt card.

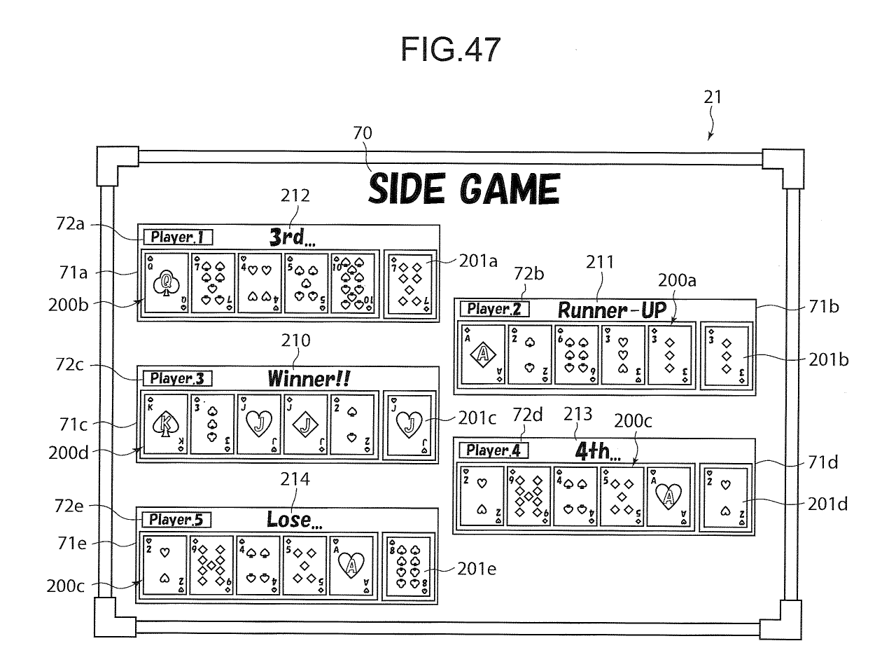

FIG. 47 shows an exemplary image displayed on the front panel display 21 after a side game is performed in the same manner as that of the above-described seventh embodiment according to the present invention. The dealt-card image display regions 71a to 71e for the players are displayed on the front panel display 21 at the center of the main monitor 2. The special cards 201a to 201e dealt to the players are displayed, and high hand cards 200a to 200e (see FIG. 46), of which combination with the special cards 201a to 201e dealt to the players is realized as a combination with the highest payment, are displayed correspondently. Specifically, high hand cards 200b (see FIG. 46) of the player 5 are displayed in the dealt-card image display region 71a of the player 1, and a combination “One Pair” is realized by “7 of Spade” included therein and “7 of Diamond” serving as a special card 201a dealt to the player 1. Similarly, in the side game dealt-card display region 71c of the player 3, a high hand card 200d of the player 4 is originally displayed so that a combination with “Jack of Heart” serving as a dealt special card 201c is realized as a combination with the highest payment, and a combination “Three of a Kind” is realized. Further, when a winner or loser is determined by comparing the players' cards of all the stations 3a to 3e, the dealt-card image display regions 71a to 71e of the players display winner-loser information displays 210 and 214. Here, since a combination “Three of a Kind” composed of Jacks has the highest payment among the players of all the stations 71a to 71e, the side game dealt-card display region 71c displays the winner-loser information display 210 which is inclusive of a message “Winner!!”. Since a combination “Three 3s of a Kind” of the player 2 has the second highest payment, the side game dealt-card display region 71b displays the winner-loser information display 211 which is inclusive of the message “Runner-Up!!”. For the player 1 who realized a combination “One Pair of 7s”, further, the dealt-card display region 71b displays the winner-loser information display 211 inclusive of the message “3^{rd}”. For the player 4 who realized a combination “One Pair of 2s”, the side game dealt-card display region 71b displays the winner-loser information display 211 which is inclusive of the message “4^{th}”. Then, a winner-loser information display 222, which is inclusive of the message “Lose”, is provided in the side game dealt-card display region 71e of the player 5, which is indicative of “No Pair” meaning that no combination is realized between the special card 201e and the high hand cards 200a to 200e of all of the players. After that, a payment determined by comparing a plurality of cards owned by the players is paid out.

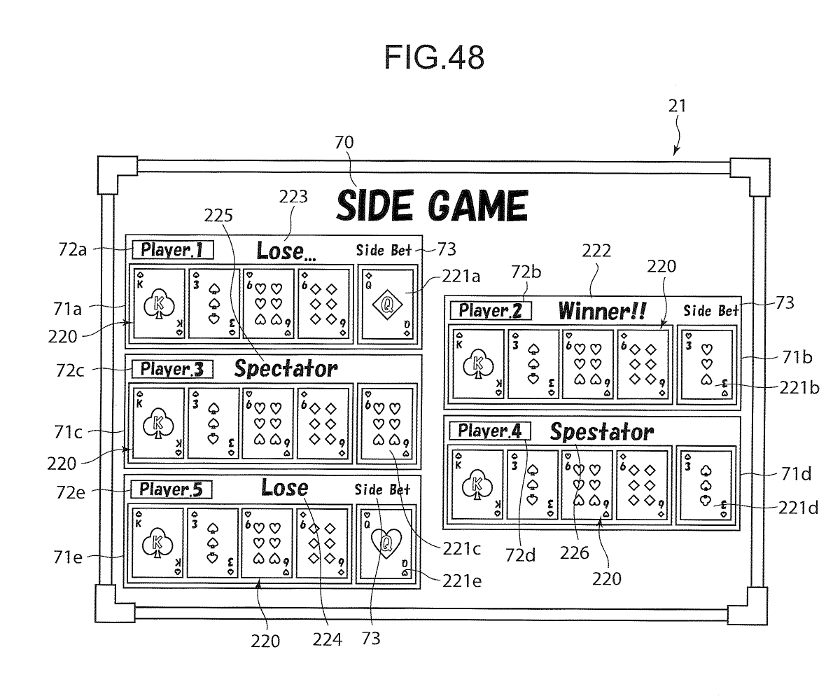

FIG. 48 shows an exemplary image displayed on the front panel display 21 after the side game is performed in the same manner as that of the above-described seventh embodiment according to the present invention. The front panel display 21 disposed at the center of the main monitor 2 displays the dealt-card image display regions 71a to 71e of the players and displays common cards 220 and special cards 221a to 221e dealt to the players. The dealt-card image display regions 71a to 71e of the players display side-game result displays 222 to 225 which are indicative of the result of the side game. In a side game dealt-card display region 71c of the player 3, for example, because the player 3 did not perform a side BET, even if “Three of a Kind” is realized in combination between the common card 100 and the special card 101c, a winner-loser information result display “Spectactor” 225 is provided which is indicative of the fact that no player participated in the side game. Further, because the player 4 did not perform a side BET, a winner-loser information display “Spectactor 226” is displayed which is indicative of the fact the player did not participate in the side game. In the side game dealt-card display region of the player 2, since a combination with the special card “One Pair” is realized which has the highest payment among players 1, 2, and 5 who are performing a side BET, the winner-loser information display “WINNER” 222 is provided. In addition, the dealt-card image display regions 71a to 71e of the players 1 and 5 display the contents of the winner-loser information displays 223 and 224.

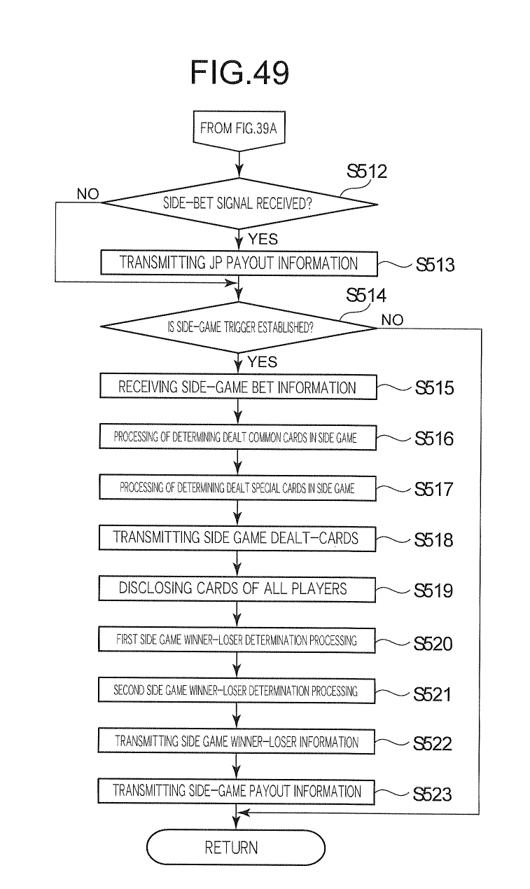

FIG. 49 shows a subroutine of main control unit processing performed after processing is performed in the same manner as that in FIG. 39A serving as a flowchart showing a subroutine of the main control unit processing executed at the stations according to the seventh embodiment. First, the CPU41 judges whether or not a side BET signal has been received (step S512). Specifically, this CPU judges whether or not a signal has been received which is indicative of the fact that a player is performing a side BET. When judging that no side BET signal has been received (step S512: NO), the CPU41 proceeds to step S314.

On the other hand, when it is judged that a side BET signal is received (step S512: YES), JP payout information is transmitted to the station 3 (step S513). The JP payout information is indicative of the amount of JP credit (currency value) paid out to the side BET. Specifically, in a case where the player has won, when “Royal Flush” is realized at the player's high hand, the CPU41 transmits information which is indicative of credit equivalent to a total amount of JP. When “Straight Flush” is realized at the player's high hand, this CPU transmits information which is indicative of credit equivalent to 50% of JP, and when any other combination is realized at the player's high hand, this CPU transmits information which is indicative of a credit equivalent to 10% of JP. In addition, in a case where the result is “draw”, this CPU transmits information which is indicative of a credit of which amount is equal to that of a side BET. Moreover, in a case where the banker has won, this CPU transmits the fact that the amount of credit given is 0.

While the embodiment of the present invention describes a case in which, when the player has won in a PAIGOW poker at the time of side BET, where “Royal Flush” is realized at the high hand, 100% of JP is paid out, where “Straight Flush” is realized at the high hand, 50% of JP is paid out, and where any other combination is realized at the high hand, 10% of JP is paid out. In the embodiment of the present invention, a correspondence relationship between the amount of JP paid out and a hand is not limitative thereto. In the present invention, further, in a case where the player has won in the PAIGOW poker at the time of a side BET, all of the currency values accumulatively stored as JP may be paid out, regardless of the hand.

The embodiment of the present invention described a case in which a correspondence relationship between a player's hand and a payment (JP) to be paid out, in the PAIGOW poker at the time of side BET is preset. In the present invention, however, the correspondence relationship between the player's hand and the payment to be paid out may be randomly varied every time the PAIGOW poker is performed at the time of a side BET.

Further, while the embodiment of the present invention describes a case of paying out credit of which amount is equal to that of side BET in a case where the result is “draw”, the above payout of the credit may not be performed.

Next, the CPU41 judges whether or not a side game trigger has been established (step S514). Specifically, the CPU41 executes the programs stored in the RAM42, thereby sampling random number values from among the numeric range of the predetermined random number values. Based upon the sampled random number values, this CPU judges whether or not the side game trigger has been established (step S514: NO). The CPU41 terminates main control unit processing upon executing the processing of step S514.

On the other hand, upon judging that the side game trigger has been established (step S514: YES), the CPU41 receives side-game BET information from the station 3 (refer to FIG. 30) (step S515).

Next, the CPU41 executes processing of determining common dealt card in a side game (step S516). In this processing operation, the CPU41 determines four cards dealt to each of the players from among another group of trump cards with the use of random numbers.

Next, the CPU41 executes processing of determining special dealt-cards in a side game (step S517). In this processing operation, the CPU41 determines single cards dealt to the players from among another group of trump cards which is different from one group of trump cards in which common cards were determined at step S516 with the use of random numbers.

Next, the CPU41 transmits side game dealt-card information (step S518). Specifically, the CPU41 transmits the side game dealt-card information to the stations 3. The side game dealt-card information is inclusive of information indicative of suits (heart, clover, spade, and diamond) of cards determined to be dealt to the players. At each of the stations 3, based upon the received dealt-card information, the liquid crystal display 10 displays a card image indicative of five player's cards consisting of four common cards and one special card and a card image indicative of six player's cards consisting of five high hand cards and one special card in a basic game.

Next, the CPU41 discloses all players' cards (step S319). Specifically, the CPU41 controls the front panel display 21 to display, in a faced up manner, images indicative of five groups of cards, each of which consists of five high hand player's cards determined at step S107, images indicative of four common cards determined at step S516, and one special cards determined at step S517 (see FIG. 46).

Next, the CPU41 performs a side game winner-loser determination processing (step S520). In this processing operation, the CPU41 executes the processing of determining a winner or loser, based upon the side game dealt cards of all of the players disclosed at step S519. Specifically, it is judged which one of the card combinations is strong or weak by comparing cards of all of the players. Then, a winner and a loser are determined based upon the judgment result. Here, any one of the predetermined combinations is realized in combination between one special card and plural common cards dealt to each of the players and plural common cards, both of which are contained in each of the five groups of high hand cards of all of the players. After that, it is judged which one of the card combinations is strong or weak. The predetermined combinations denote “Royal Flush”, “Straight Flush”, “Four of a Kind”, “Full House”, “Flush”, “Straight”, “Three of a Kind”, “Two Pairs”, “One Pair”, and “No Pair” in order of strength, among the five cards.

Next, the CPU41 performs a second side-game result determination processing (step S521). In this processing operation, the CPU41 executes processing of determining participation, non-participation, and a winner or loser, based upon the side game dealt-cards of all of the players disclosed at step S519. Specifically, this CPU judges whether or not the side BET of all of the players is performed, and defines the players having performed the side BET as participation and those not having performed it as non-participation. Further, the CPU41 judges which one of the card combinations is strong or weak by comparing the cards of the players having participated in the side game, and determines a winner or loser, based upon the judgment result. Here, any one of the predetermined combinations is realized in five player's cards, and it is judged which one of the card combinations is strong or weak. The predetermined combinations denote “Royal Flush”, “Straight Flush”, “Four of a Kind”, “Full House”, “Flush”, “Straight”, “Three of a Kind”, “Two Pairs”, “One Pair”, and “No pair” in order of strength, among the five cards.

Next, the CPU41 transmits side-game result information (step S522). Specifically, the CPU41 transmits to the station 3 the result information which is indicative of the result of the side game determined at steps S520 and S521. At the station 3, upon the receipt of result information, the liquid crystal display 10 displays any one of the images which are inclusive of the messages “Winner!!”, “Runner-Up”, 43^{rd}, 4^{th}, “Lose”, and “Spectator”, based upon the received result information.

Next, the CPU41 transmits side-game payout information to the station 3 ((step S523). The side-game payout information is indicative of the amount of credit (currency value) to be paid out in a side game. Specifically, the side-game payout information is indicative of the amount of credit (currency value) paid out in a side game. Specifically, this CPU transmits information which is indicative of the credit determined based upon the combinations “Royal Flush”, “Straight Flush”, “Four of a Kind”, “Full House”, “Flush”, “Straight”, “Three of a Kind”, “Two Pairs”, “One Pair”, and “No pair”. The CPU41 terminates main control unit processing when executing the processing of step S322.

While the embodiment according to the present invention has been described, the description presents only some of the specific examples and is not intended to limit the present invention in any way and specific constructions of each means and the like can be properly changed in terms of design. Moreover, the effects described in the embodiment of the present invention are only the most preferable effects generated from the present invention and the effects to be caused by the present invention is not limitative thereto.

First, a game machine 1 will be described with referring to the drawings. The following embodiment describes in detail a case in which, if a side-game trigger is established in a PAIGOW poker after the poker is performed, a payment is paid out according to any of combinations of a predetermined number of cards and special cards, from among players' cards and banker's cards.

First, the rules of the PAIGOW poker will be described in detail. In the PAIGOW poker of the embodiments, one or more players compete against a banker with the use of one set of trump cards (52 cards) excluding a joker.

Seven cards are dealt to each of the persons consisting of a banker and the players. Each of them divides seven cards into two groups of five cards and of two cards. At this time, a hand of five cards (a high hand) must be as strong as or must be stronger than that of two cards (a low hand).

Next, it is judged as to which one of the players' hands is strong or weak after comparing the five cards of each of the banker's and players' hands with each other. Similarly, it is judged as to which one of the players' hands is strong or weak after comparing the two cards of each of the banker's and players' hands with each other. In a case where the banker's hands are stronger in both of the two groups of five and two cards, it is judged to be the banker's win. In a case where one of the players' hands is stronger in both of the two groups of five and two cards, it is judged to be the player's win. In a case where the player's hands are stronger in one of the two groups consisting of five cards and two cards, and the banker's hand is stronger in the other one, it is judged to be “draw”. In addition, in a case where the player's hand and the banker's hand are identical to each other in strength with respect to both of the two groups of five and two cards, it is judged to be the banker's win.

The hands of five cards include “Royal Flush”, “Straight Flush”, “Four of a Kind”, “Full House”, “Straight”, “Three of a Kind”, “Two of a Kind”, and “No Pair” in order of strength. The hands of two cards include “One Pair” and “No Pair” in order of strength.

In addition, in a case where the player's and banker's hands are identical to each other, it is judged as to which one of the players' hands is strong or weak after comparing the numbers or alphabets drawn in cards constituting the hands with each other. The card's numbers and alphabets include “A”, “K”, “Q”, “J”, “10”, “9”, “8”, “7”, “6”, “5”, “4”, “3”, and “2” in sequential order from the strongest combination of the five cards.

In the embodiment that follow, a basic game and a side game accepting a normal BET and a side BET are executed. The normal BET is to be performed for the play of the PAIGOW poker, and the side BET is stored in an accumulative manner as a jackpot (hereinafter, referred to as a JP) at a predetermined rate included in a betted currency value (50% in the embodiments of the present invention). The following embodiments describe a case in which a dealer takes over a banker.

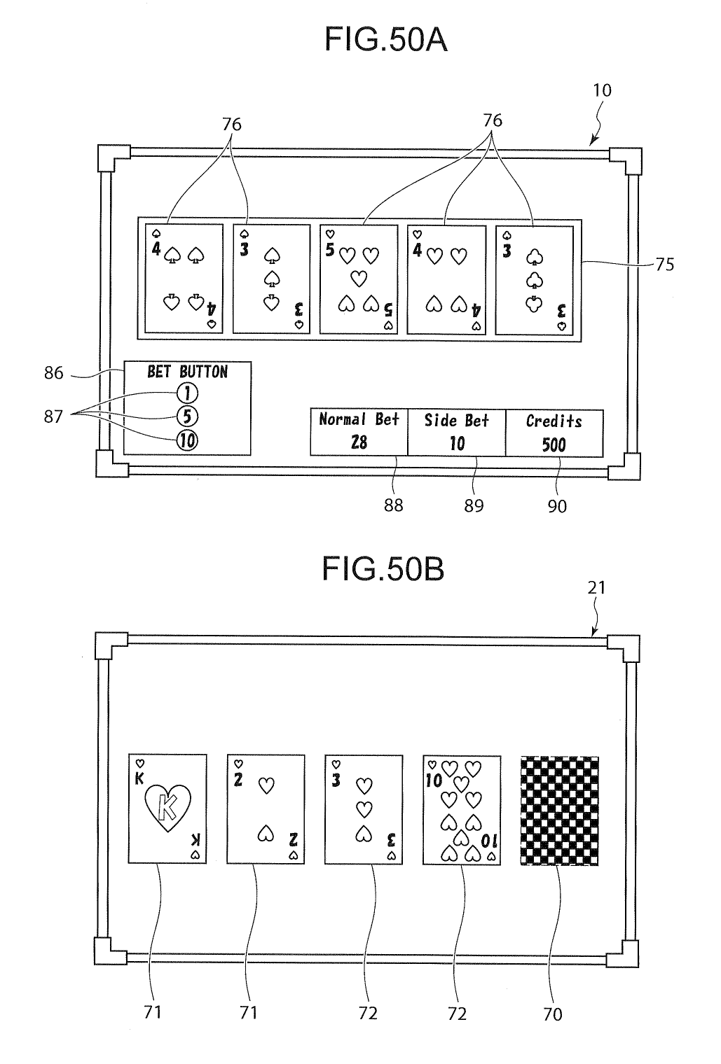

FIG. 50A is a view showing an exemplary image displayed on a liquid crystal display included in a station while in a side game. As shown in FIG. 50A, when a side game is started, a liquid crystal display 10 displays, at a side game dealt-card display section 75, five side game cards 76 dealt at the time of the commencement of the side game. Here, five cards “4 of spade”, “3 of spade”, “5 of heart”, “4 of heart”, and “3 of club”, which are indicative of a card combination “Two Pairs”, are dealt, and a payment corresponding to the card combination “Two Pairs” is paid out.

A BET button display section 86 is provided at the lower side of a dealt-card display section 83. BET buttons 87 for inputting BET numbers are displayed at the BET button display section 86. A player can input a normal BET number and a side BET number by operating the BET buttons 87 via a touch panel 11. Here, since 10 coins are side-betted, the liquid crystal display 10 displays special cards 70 which were dealt from among the cards displayed on the liquid crystal display 10 of another player.

FIG. 50B is a view showing an exemplary image displayed on a front panel display while in a side game. As shown in FIG. 50B, the front panel display 21 displays: a predetermined number of banker's cards 71 from among the cards dealt to a banker; a predetermined number of player's cards 72 from among the cards dealt to a player; and a special card 70 dealt from another player. Here, two banker's cards 72 consisting of “King of heart” and “2 of heart”; two player's cards 72 consisting of “3 of heart” and “10 of heart”; and one special card 70 consisting of “Jack of heart”, which are indicative of a card combination “Flush”, are displayed, and then, based upon the card combination “Flush”, one progressive payment is paid out from among a plurality of progressive payments.

### 8. Eighth Embodiment

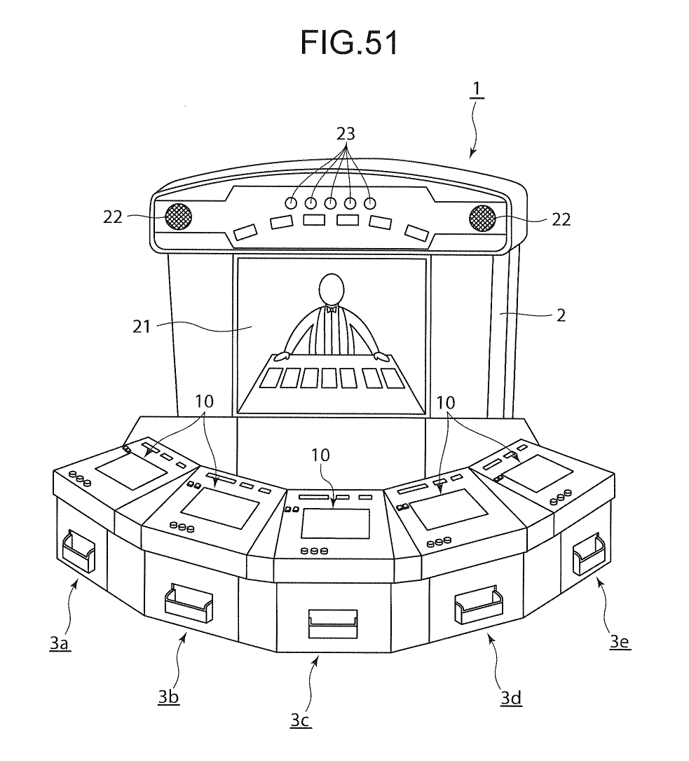

FIG. 51 is a perspective view schematically depicting an appearance and a configuration of a game machine according to the present invention. As shown in FIG. 51, the game machine 1 is basically made up of a main monitor 2 and five stations 3 (stations 3a to 3e). While the present embodiment describes in detail a case in which the game machine 1 is provided with a plurality of stations 3 (five stations), the game machine may include over five stations in the present invention.

A front panel display 21 is provided at the center part of a main monitor 2, and an image indicative of a dealer and cards is displayed. The front panel display 21 is equivalent to a display device of the present invention. In addition, provided at the upper side of the main monitor 2 are: a speaker 22 for outputting music or effect sounds in accordance with the progress of a game executed by the game machine 1; and an LED23 that is lit at the time of various effects.

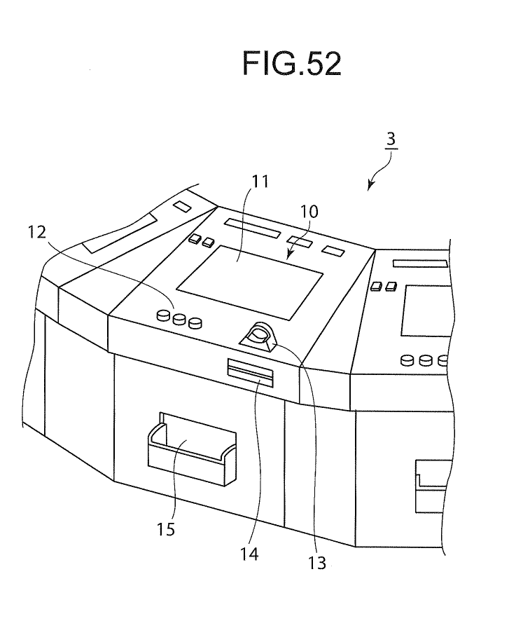

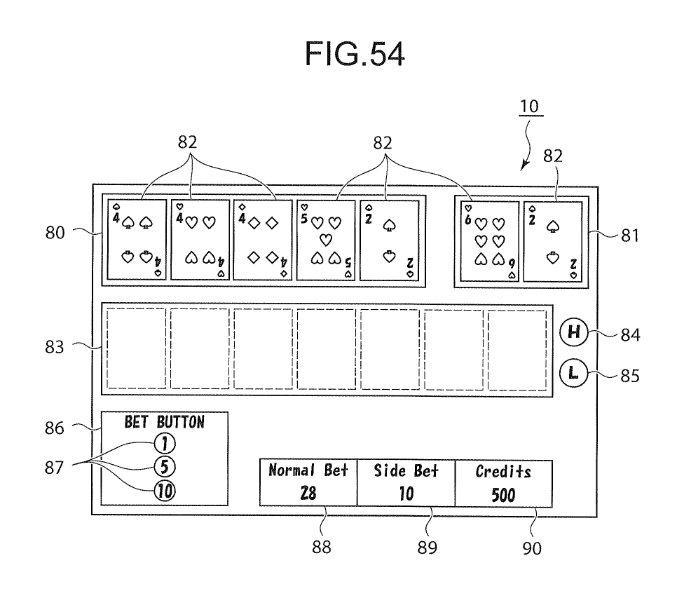

FIG. 52 is a perspective view schematically depicting an appearance and a configuration of stations included in the game machine shown in FIG. 51. As shown in FIG. 52, a liquid crystal display 10, which displays an image or the like pertinent to operation (see FIG. 54), as described later, is provided at the upper center of a station 3. In addition, a touch panel 11 for entering an operation such as BET is provided on the top face of the liquid crystal display 10. The touch panel 11 is equivalent to a BET switch, a side-BET switch, and an input switch, of the present invention.

An operational button 12 for making payout operation and a coin insertion slot 13 for inserting coins or medals are provided in front of the liquid crystal display 10. A bill insertion slot 14 for inserting bills is provided at the front top right end of the station 3. Provided downwardly of the bill insertion slot 14 is a coin payout opening 15 through which the coins or medals corresponding to stored credit are paid out to the players when payout operation is made.

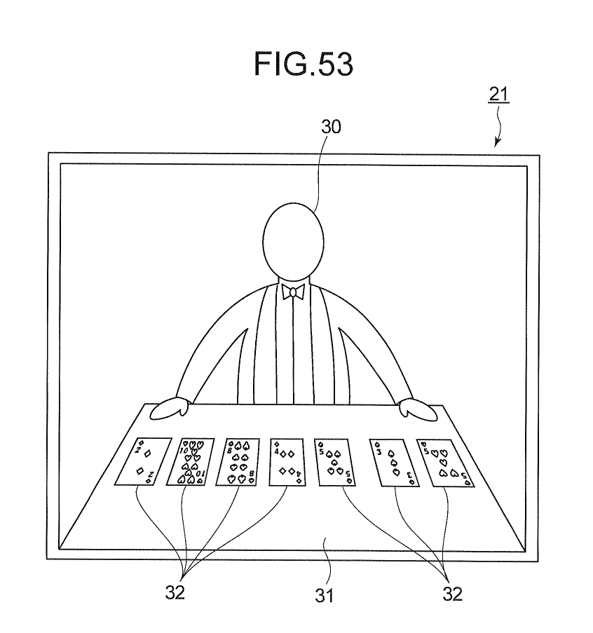

FIG. 53 is a view showing an exemplary image displayed on a front panel display included in a game machine. As shown in FIG. 53, the front panel display 21 displays a dealer image 30 indicating a dealer (banker), a table image 31 indicative of a table, and a card image 32 indicative of seven banker's cards. The card image 32 is displayed in a faced down manner when cards are dealt to the dealer. When a high hand and a low hand are determined, the card image 32 is displayed in a faced up manner. In FIG. 53, the left five cards toward the dealer indicate a high hand, and the right two cards indicate a low hand.

FIG. 54 is a view showing an exemplary image displayed on a liquid crystal display included in stations. As shown in FIG. 54, a high hand display section 80, which displays a player's high hand, and a low hand display section 81, which displays a low hand, are provided at the upper side of the liquid crystal display 10. The high hand display section 80 and the low hand display section 81 display card images 82 indicative of a high hand card and a low hand card, respectively, in a faced up manner.

A dealt-card display section 83 is provided at the lower side of the high hand display section 80. A card image indicative of the seven player's cards after dealt to each of the players is displayed in a faced up manner at seven portions enclosed by the dotted line of the dealt-card display section 83. A high hand determination button 84 and a low hand determination button 85, for determining cards constituting a high hand and a low hand, are provided at the right side of the dealt-card display section 83. A player can determine a high hand by selecting a card desired to be high hand, via a touch panel 11, from among the cards displayed at the dealt-card display section 83, and then, operating the high hand determination button 84. The card determined to be a high hand is displayed at the high hand display section 80. Similarly, the player determines a low hand by selecting a card desired to be a low hand, via the touch panel 11, from among the cards displayed at the dealt-card display section 83, followed by operating a low hand determination button 85 via the touch panel 11.

A BET button display section 86 is provided at the lower side of the dealt-card display section 83. The BET button display section 86 displays a BET button 87 for inputting a BET number. The player can input a normal BET number and a side BET number by operating a BET button 87 via the touch panel 11.

A normal BET number display section 88, which displays the number of normally betted coins, is provided at the right side of the BET button display section 86. It is shown here that 28 coins have been betted. In a case where betting of these 28 coins is input, the player may operate “10” of the BET button 87 twice, “5” of the BET button 87 once, and “1” of the BET button 87 three times.

A side-BET number display section 89, which displays the number of side-betted coins, is provided at the right side of the normal BET number display section 88. Here, it is shown that 10 coins have been betted. Further, a credit number display section 90 is provided at the right side of the side-BET number display section 89. Here, it is shown that 500 coins have been credited.

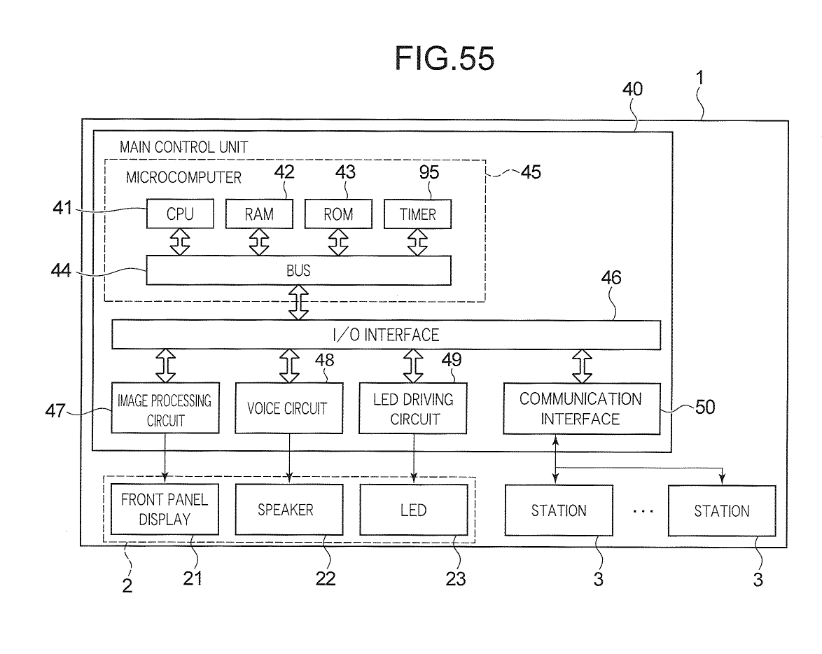

FIG. 55 is a block diagram depicting an internal configuration of the game machine shown in FIG. 51. As shown in FIG. 55, a main control unit 40 included in the game machine 1 is basically constituted while a microcomputer 45 made up of: a CPU (Central Processing Unit) 41; a RAM (Random Access Memory) 42; a ROM (Read Only Memory) 43; a timer 95; and a bus 44 for transferring data therebetween is employed as a base. The main control unit 40 is equivalent to a controller of the present invention.

The ROM43 stores: various programs for performing processing required for controlling the game machine 1; and a data table or the like. The RAM42 is a memory for temporarily storing various data computed by the CPU41. Further, the timer 95 performs time measurement.

The CPU41 is connected via an I/O interface 46 to an image processing circuit 47, a voice circuit 48, an LED driving circuit 49, and a communication interface 50.

A front panel display 21 constituting a main monitor 2 is connected to the image processing circuit 47; a speaker 22 constituting the main monitor 2 is connected to the voice circuit 48; and an LED23 constituting the main monitor 2 is connected to the LED driving circuit 49. Five stations 3 are connected to the communication interface 50.

The CPU41 controls games (a PAIGOW poker and a side game) to be conducted in the game machine 1, based upon game programs (a PAIGOW poker game program and a side-game program) stored in the ROM43 and various signals received from the stations 3. Further, the CPU41 controls the front panel display 21 to display images, the speaker 22 to output sounds, and the LED23 to light, based upon the game programs. Furthermore, the CPU41 transmits various signals to the stations 3, based upon the above-mentioned game programs.

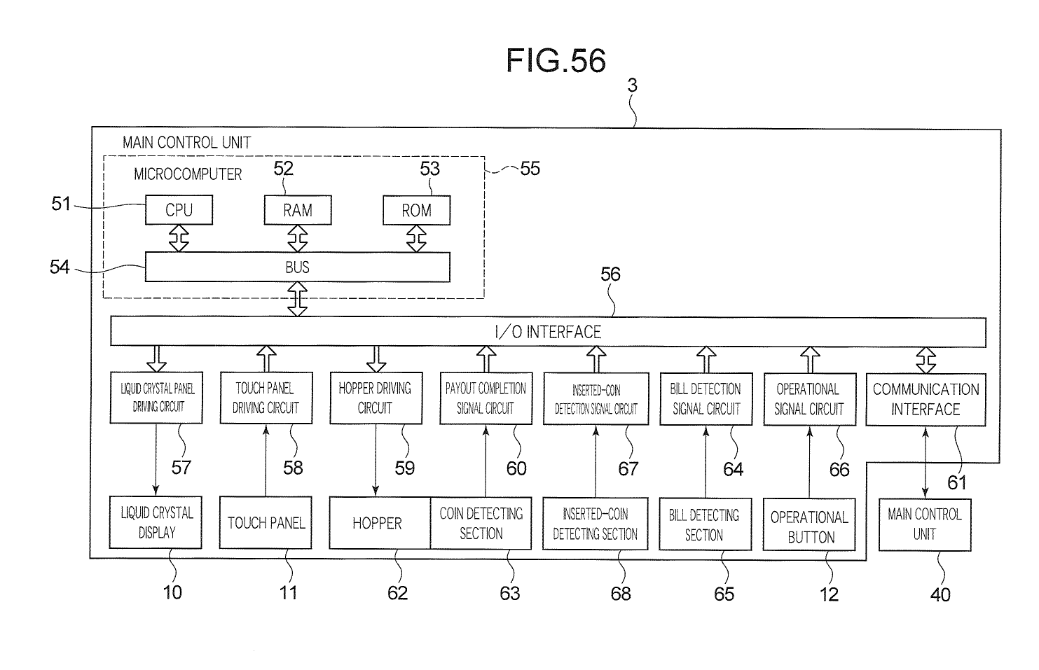

FIG. 56 is a block diagram depicting an internal configuration of each of the stations included in the game machine shown in FIG. 51. As shown in FIG. 56, stations 3 are basically constituted while microcomputers 55 made up of a CPU51, a RAM52, a ROM53, and a bus 54 for transferring data therebetween are employed as a base.

The ROM53 stores a variety of programs and data tables or the like, for performing processing required for controlling stations 3. In addition, the RAM52 temporarily stores the credit number currently stored in stations 3 and a variety of data computed by the CPU51.

In addition, the CPU51 is connected, via an V/O interface 56, to a liquid crystal panel driving circuit 57; a touch panel driving circuit 58; a hopper driving circuit 59; a payout complete signal circuit 60; an inserted-coin detection signal circuit 67; a bill detection signal circuit 64; an operation signal circuit 66; and a communication interface 61.

The liquid crystal display 10 is connected to the liquid crystal panel driving circuit 57; the touch panel 11 is connected to the touch panel driving circuit 58; a hopper 62 is connected to a hopper driving circuit 59; a coin detecting section 63 is connected to the payout complete signal circuit 60; an inserted-coin detecting section 68 is connected to the inserted-coin detection signal circuit 67; a bill detecting section 65 is connected to the bill detection signal circuit 64; and the operational button 12 is connected to the operation signal circuit 66, respectively.

The hopper 62 is provided inside the station 3 and serves to pay out coins from the coin payout opening 15, based upon a control signal output from the CPU51. The coin detecting section 63 is provided inside the coin payout opening 15, and transmits signals to the CPU51 in a case where it is detected that a predetermined number of coins have been paid out from the coin payout opening 15.

Upon detecting that coins have been inserted through the coin insertion slot 13, the inserted-coin detecting section 68 detects the amount of the detected coins, and then, transmits to the CPU51a detection signal indicative of the detected amount. The detected coins are stored in the RAM52 while a predetermined amount is handled as one credit.

At the time of acceptance of bills, the bill detecting section 65 detects the amount of the accepted bills, and then, transmits to the CPU51a detection signal indicating the detected amount. The detected bills are stored in the RAM52 while the predetermined amount is handled as one credit. The operation button 12 is intended for performing payout operation in a case where coin payout has been determined.

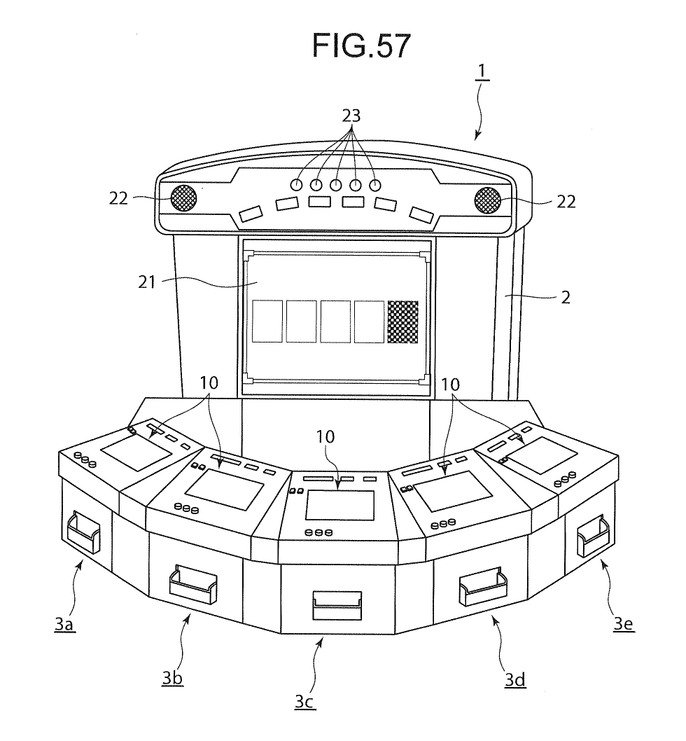

FIG. 57 is a view showing an exemplary image displayed on a front panel display of the game machine. As shown in FIG. 57, a game machine 1 is constituted of a main monitor 2 and five stations 3 (3a to 3e). When a side game is started, a display device 21, which is situated at the center of a main monitor 2, and liquid crystal displays 10 display a predetermined number of banker's cards from among the cards dealt to the banker; a predetermined number of player's cards included in a player; and special cards dealt from a plurality of other players. Then, based upon a combination of the displayed cards, a progressive payment is paid out to the player.

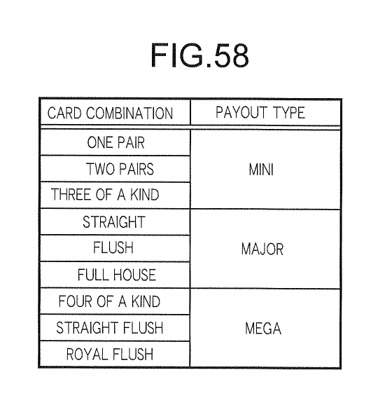

FIG. 58 is a view showing an exemplary combination payout determination table while in the side game according to the eighth embodiment. The combination payout table is stored in the ROM43 while various combinations and payout types are associated with each other. As shown in FIG. 58, in the case of a combination in which the cards after dealt while in the side game were determined, the payout type of payment is determined based upon the determined combination. Where a combination of the dealt cards is realized as “One Pair”, “Two Pairs”, or “Three of a Kind”, a payment corresponding to “MINI” is determined; where it is realized as “Straight”, “Flush”, or “Full House”, a payment corresponding to “MAJOR” is determined; or where it is realized as “Four of a Kind”, “Straight Flush”, or “Royal Flush”, a payment corresponding to “MEGA” is determined. In other words, credit is paid out based upon the determined payout type.

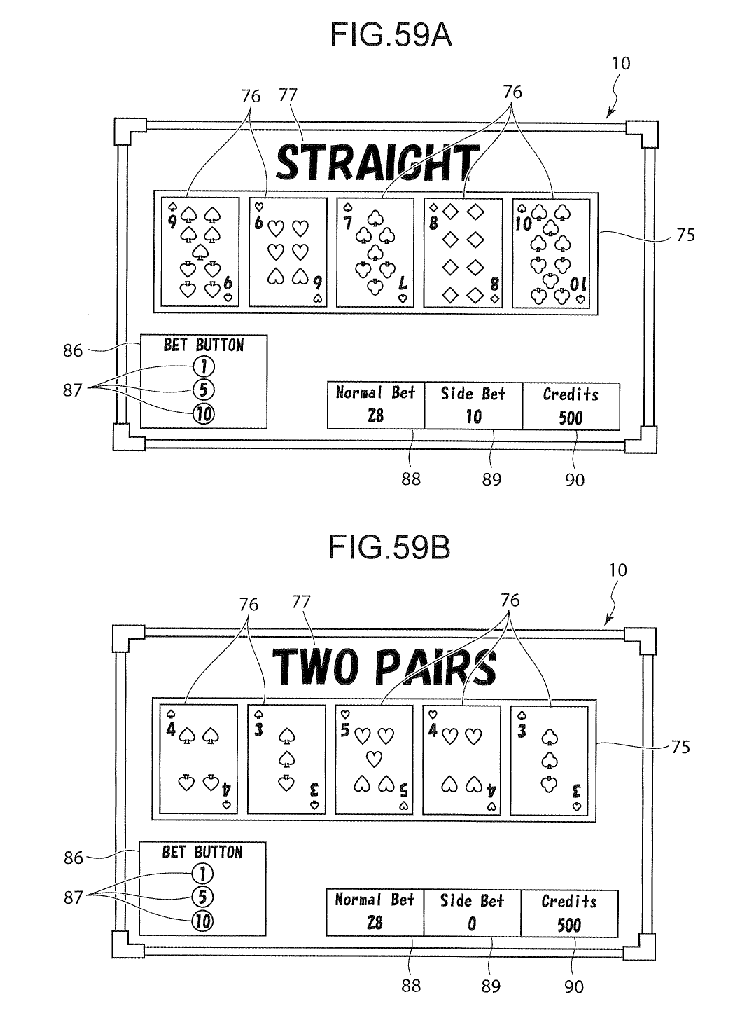

FIGS. 59A and 59B are views each showing an exemplary image displayed on the liquid crystal display included in each of the stations while in a side game according to the eighth embodiment. As shown in FIG. 59A, when the side game is started, a side game dealt-card display section 75 displays side-game cards 76 dealt at the time of commencement of the side game. Here, five cards “9 of spade”, “6 of heart”, “7 of club”, “8 of diamond”, and “10 of club”, which are indicative of a card combination “Straight”, are dealt; a card combination image 77, which is indicative of “Straight”, is displayed; and then, a payment corresponding to “Straight” is paid out.

Further, a BET button display section 86 is provided at the lower side of the side game dealt-card display section 75. At the lower side of the side game dealt-card display section 75, a normal BET number display section 88; a side BET number display section 89, which displays the number of side-betted coins; and a credit amount display section 90, are provided. Here, 10 coins are side-betted, and thus, while in a basic game, the liquid crystal display 10 displays special cards 70 dealt from among the cards displayed on the liquid crystal display 10 of another player.

As shown in FIG. 59B, when a side game is started, the liquid crystal display 10 displays the side game cards 76 dealt at the side game dealt-card display section 75 at the time of commencement of the side game. Here, five cards “4 of spade”, “3 of spade”, “5 of heart”, “4 of heart”, and “3 of club”, which are indicative of a card combination “Two Pairs”, is dealt, and then, a card combination display image 77 indicative of “Two Pairs” is displayed.

Further, a BET button display section 86 is provided at the lower side of the side game dealt-card display section 75. At the lower side of the side game dealt-card display section 75, a normal BET number display section 88; a side BET number display section 89, which displays the number of side-betted coins; and a credit amount display section 90, are provided. Here, no side-BET entry is accepted, and thus, while in a basic game, a special card 70 is not dealt from among the cards displayed on the liquid crystal display 10 of another player. Therefore, the special card 70 is not displayed on the liquid crystal display 10.

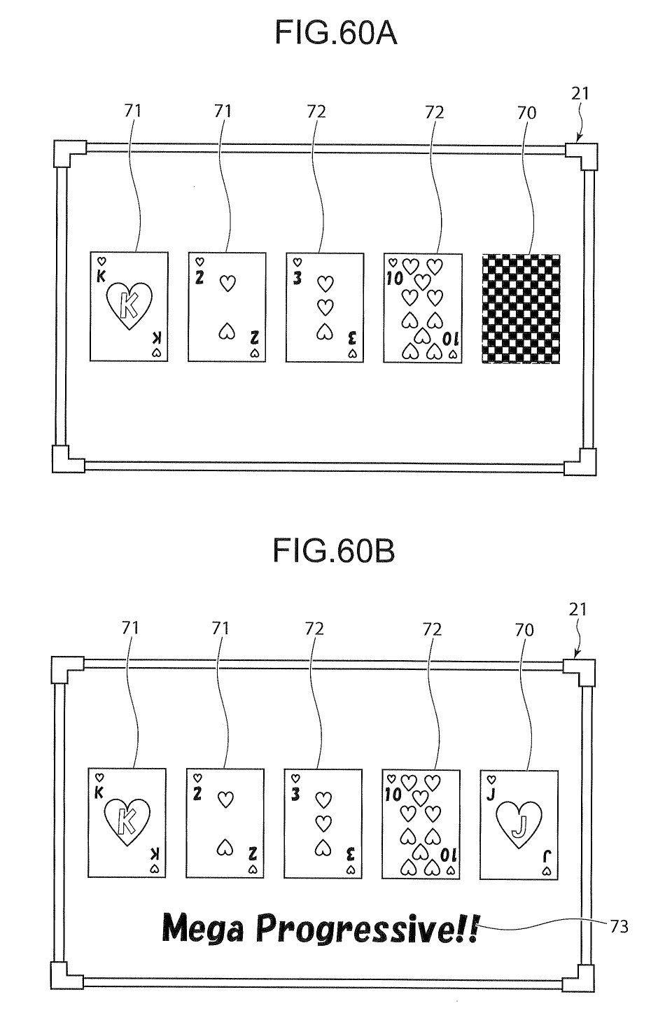

FIGS. 60A and 60B are views each showing an exemplary image displayed on the front panel display. As shown in FIG. 60A, the front panel display 21 displays a predetermined number of banker's cards 71 from among the cards dealt to the banker; a predetermined number of player's cards 72 from among the cards dealt to a player; and special cards 70 dealt from among the cards displayed on the liquid crystal display 10 of another player. Here, two banker's cards 72, “King of heart” and “2 of heart”; two player's cards 72, “3 of heart” and “10 of heart”; and one special card 70, “Jack of heart”, are displayed in a faced down state.

As shown in FIG. 60B, the special card 70, which have been displayed in a faced down state, is displayed in a faced up state. Here, since two banker's cards 72, “King of heart” and “2 of heart”; two player's cards 72, “3 of heart” and “10 of heart”; and one special card 70, are displayed which are indicative of a card combination “Flush”, one progressive payment is determined from among a plurality of progressive payments, based upon the card combination “Flush” (see FIG. 58). A progressive payment display 73, which is indicative of “Mega Progressive!!”, is displayed, and a determined payment is paid out.

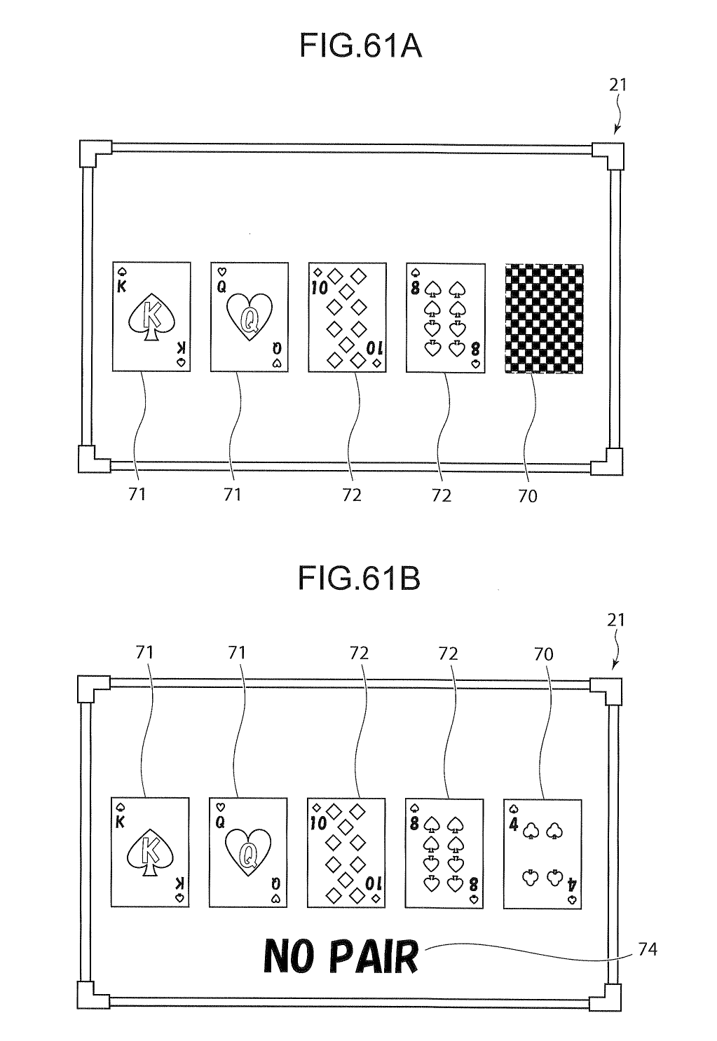

FIGS. 61A and 61B are views each showing an exemplary image displayed on a front panel display. As shown in FIG. 61A, the front panel display 21 displays a predetermined number of banker's cards 71 from among the cards dealt to the banker; a predetermined number of player's cards 72 from among the cards dealt to a player; and a special card 70 dealt to another player. Here, two banker's cards 72, “King of spade” and “Queen of heart”; two player's cards 72, “10 of diamond” and “8 of spade”, and a special card 70, are displayed in a faced down manner.

As shown in FIG. 61B, the special card 70, which has been displayed in a faced down manner, is displayed in a faced up manner. Here, while two banker's cards 72, “King of spade” and “Queen of heart”; two player's cards 72, “10 of diamond” and “8 of spade”, and a special card 70, are displayed, a predetermined combination is not included in card combinations. Thus, card combination display 74, which is indicative of “No Pair”, is displayed, and a progressive payment is not paid out.

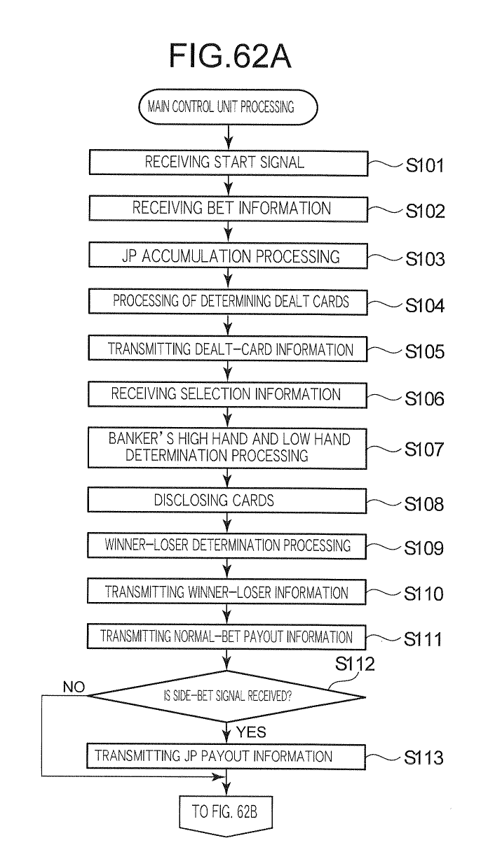

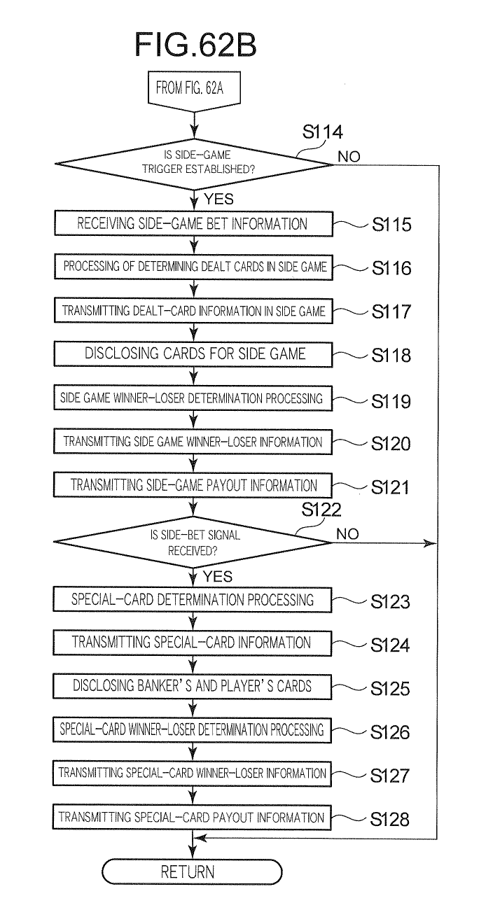

Next, the processing to be performed at the main control unit 40 and stations 3 will be described in detail. FIGS. 62A and 62B are flowcharts each showing main control unit processing to be executed at the main control unit included in the game machine. In this processing operation, at first, the CPU41 included in the main control unit 40 receives a start signal (step S101). Specifically, the CPU41 receives the start signal from any of the stations 3. The start signal serves as a trigger for conducting a PAIGOW poker game in the game machine 1.

Next, the CPU41 receives BET information from the stations 3 (see FIG. 51) (step S102). The BET information is pertinent to BETs, and includes: information indicative of whether or not a normal BET and a side BET have been performed; and information indicative of the amounts of the normal BET and the side BET.

Next, the CPU41 executes JP accumulation processing (step S103). Specifically, the CPU41 accumulatively stores, in the RAM42 (see FIG. 55), 50% (predetermined rate) of the side-betted credit as JP, based upon the BET information received at step S102.

Next, the CPU41 executes dealt-card determination processing (step S104). In this processing operation, the CPU41 determines seven cards to be dealt to each of the persons consisting of the players and banker from among one set of trump cards, with the use of random numbers. The seven cards determined to be dealt to the players at the step S104 are equivalent to the player's cards, and the seven cards determined to be dealt to the banker are equivalent to the banker's cards. Further, the front panel display 21 (see FIG. 51) included in the game machine 1 displays a card image indicative of the seven banker's cards in a faced down manner.

Next, the CPU41 transmits dealt-card information (step S105). Specifically, the CPU41 transmits the dealt-card information to stations 3. The dealt-card information includes the one which is indicative of the kinds of cards (suits (heart, clover, spade, and diamond)) that were determined to be dealt to the players and banker. At each of the stations 3, the liquid crystal display 10 displays the card image indicative of the seven player's cards, based upon the received dealt-card information, and then, accepts entry for dividing them into a group of 5 cards (high hand) and a group of two cards (low hand).

Next, the CPU41 receives selection information from the station 3 (step S1106). The selection information indicates which ones of the cards after dealt to each of the players have been selected as a high hand, and which ones of the cards have been selected as a low hand.

Next, the CPU41 executes processing of determining a banker's high hand and low hand (step S107). In this processing operation, the CPU41 executes processing of dividing the cards after dealt to the banker into a high hand and a low hand.

Next, the CPU41 discloses cards (step S108). Specifically, the CPU41 displays in a faced up manner on the front panel display 21 the card images indicative of the high hand and the low hand determined at the step S104.

Next, the CPU41 performs winner-loser determination processing (step S109). In this processing operation, the CPU41 executes processing of determining a winner or loser, based upon the selection information received at the step S106 and the high hand and the low hand determined at step S107. Namely, this CPU executes processing of determining a winner or loser after comparing the players' hands of the cards after dealt to the players and the banker's card hands. Specifically, it is judged as to which one of the players' hands is strong or weak after comparing the players' high hands with the banker's high hand. In addition, it is also judged as to which one is strong or weak after comparing the players' low hands with the banker's low hand. Further, the winner or loser is determined based upon the judgment results. Specifically, in a case where the player's high hand is stronger than the banker's high hand and in a case where the player's low hand is stronger than the banker's low hand, it is judged to be the player's win. In a case where the banker's high hand is stronger than the player's high hand and in a case where the banker's low hand is stronger than the player's low hand, it is judged to be the banker's win. Even if the player is stronger at one of the high and low hands, in a case where the banker is stronger at the other one, it is judged to be “draw”.

Next, the CPU41 transmits winner-loser information (step S110). Specifically, the CPU41 transmits to the station 3 the information indicative of the winner or loser determined at the step S109 (hereinafter, referred to as winner-loser information). Upon the receipt of the winner-loser information, based upon the received winner-loser information, the liquid crystal display 10 displays any one of the images inclusive of the messages “You Win”, “You Lose”, and “Draw”.

Next, the CPU41 performs processing of transmitting normal-BET payout information (step S111). In this processing operation, the CPU41 transmits the normal-BET payout information to the station 3. The normal-BET payout information is generally indicative of the amount of credit (currency values) to be paid out to BET. Specifically, in a case where the player has won, this CPU transmits information indicative of credit of which amount is twice of that of normal BET. In a case where the outcome of the game is “draw”, the CPU transmits information indicative of credit of which amount is equal to that of normal BET. In addition, in a case where the banker has won, the CPU transmits information indicative of the fact that an amount of given credit is 0.

Next, in FIG. 60, the CPU41 judges whether or not a side BET signal has been received (step S112). Specifically, the CPU41 judges whether or not a signal has been received indicative of the fact that the side BET has been performed. When the CPU41 judges that no side BET signal has been received (step S112: NO), the routine proceeds to step S114.

On the other hand, when it is judged that a side BET signal is received (step S112: YES), JP payout information is transmitted to the station 3 (step S113). The JP payout information is indicative of the amount of JP credit (currency value) to be paid out to the side BET. Specifically, in a case where the player has won, when a high hand is “Royal Flush”, the CPU41 transmits information indicative of credit equivalent to a total amount of JP. When the player's high hand is “Straight Flush”, this CPU transmits information indicative of credit equivalent to 50% of JP, and when the player's high hand is a hand other than the above, this CPU transmits information indicative of a credit equivalent to 10% of JP. In addition, in a case where the result is “draw”, this CPU transmits information indicative of a credit of which amount is equal to that of a side BET. Moreover, in a case where the banker has won, this CPU transmits the fact that the amount of credit given is 0.

While the embodiment of the present invention describes a case in which, when the player has won in a PAIGOW poker at the time of side BET, where the high hand is “Royal Flush”, 100% of JP is paid out, where the high hand is “Straight Flush”, 50% of JP is paid out, and where the high hand is a hand other than the above, 10% of JP is paid out. In the embodiment of the present invention, a correspondence relationship between the amount of JP paid out and a hand is not limitative thereto. In the present invention, further, in a case where the player has won in the PAIGOW poker at the time of side BET, all of the currency values accumulatively stored as JP may be paid out, regardless of the hand.

The embodiment of the present invention described a case in which a correspondence relationship between a player's hand and a payment (JP) to be paid out, in the PAIGOW poker at the time of side BET is preset. In the present invention, however, the correspondence relationship between the player's hand and the payment to be paid out may be randomly varied every time the PAIGOW poker is performed at the time of a side BET.

Further, while the embodiment of the present invention describes a case of paying out credit of which amount is equal to that of side BET in a case where the result is “draw”, the above payout of the credit may not be performed.

Next, in FIG. 62B, the CPU41 judges whether or not a side game trigger is established (step S114). Specifically, the CPU41 executes the programs stored in the RAM42, thereby sampling random number values from among the numeric range of predetermined random number values and judging whether or not a side game trigger is established based upon the sampled random number values. The CPU41 terminates main control unit processing when it executes the processing of step S114 upon judging that a side game trigger has not been established (step S114: NO). In another embodiment of the present invention, further, judgment of whether or not a side game trigger is established is made based upon whether or not a side BET has been performed in advance.

On the other hand, upon judging that a side-game trigger has been established (step S114: YES), the CPU41 receives side-game BET information from the station 3 (see FIG. 51) (step S115). BET information is pertinent to BETs, and includes information indicative of whether or not normal BET and side BET have been performed or information indicative of the amounts of the normal BET and side BET.

Next, the CPU41 executes processing of determining dealt cards while in a side game (step S116). In this processing operation, the CPU41 determines five cards dealt to each of the persons consisting of the players and banker, from one group of trump cards, with the use of random numbers. The five cards determined to be dealt to the player at step S116 are equivalent to the player's cards, and the five cards determined to be dealt to the banker are equivalent to the banker's cards. Further, the front panel display 21 (see FIG. 51) included in the game machine 1 displays a card image which is indicative of the five banker's cards in the faced down state.

Next, the CPU41 transmits information on dealt cards while in a side game (step S117). Specifically, the CPU41 transmits to the station 3 the information on dealt cards while in the side game. The side game dealt-card information includes information which is indicative of suits (heart, clover, spade, and diamond) of the cards determined to be dealt to players. At the station 3, based upon the received dealt-card information, the liquid crystal display 10 displays a card image which is indicative of five player's cards.

Next, the CPU41 discloses cards for the side game (step S118). Specifically, the CPU41 causes the front panel display 21 to display the five banker's card images determined at step S116 (see FIG. 50).

Next, the CPU41 performs side game winner-loser determination processing (step S19). In this processing operation, the CPU41 executes processing of determining a winner or loser, based upon the banker's cards disclosed at step S118 and the players' cards dealt to the players. Specifically, this CPU judges whether the banker's cards and the players' cards include a predetermined combination, and then, determines a winner or loser, based upon the judgment result.

Next, the CPU41 transmits side game winner-loser information (step S120). Specifically, the CPU41 transmits to a station 3 the winner-loser information indicative of a winner or loser of the side game determined at step S19. At the station 3, upon the receipt of the winner-loser information, the liquid crystal display 10 displays any one of the images which are inclusive of the messages “You Win”, “You Lose”, and “Draw”, based upon winner-loser information.

Next, the CPU41 transmits side-game payout information to the stations 3 (step S121). The side-game payout information is indicative of the amount of credit (currency value) to be paid out while in a side game. Specifically, this CPU determines a payout type corresponding to a card combination, and then, transmits information which is indicative of a determined credit.

Next, the CPU41 judges whether or not a side BET signal has been received (step S122). Specifically, this CPU judges whether or not a signal has been received which is indicative of the fact that a side BET is performed. When judging that no side BET signal has been received (step S122: NO), the CPU41 terminates main control unit processing.

On the other hand, when judging that the side BET signal has been received (step S122: YES), the CPU41 executes special-card determination processing (step S123). Specifically, the CPU41 determines, as special cards, the cards displayed on the liquid crystal displays 10 installed at the plurality of stations (3a to 3e).

Next, the CPU41 transmits special card information (step S124). Specifically, the CPU41 transmits the special card information to the station 3. The special card information includes information which is indicative of the suits (heart, clover, spade, and diamond) of the special cards determined to be dealt to the players. At the station 3, based upon the received special card information, the liquid crystal display 10 displays the special card image (see FIG. 59A).

Next, the CPU41 discloses the banker's and players' cards (step S125). Specifically, the CPU41 causes the front panel display 21 to display, in a faced up manner, an image which is indicative of: two of the player's cards and two of the banker's cards, respectively; and the special card determined at step S124 (FIGS. 60 and 61).

Next, the CPU41 performs special card winner-loser determination processing (step S126). In this processing operation, the CPU41 executes processing of determining a winner or loser, based upon: two of the player's cards and two of the banker's cards, respectively, disclosed at step S125; and the special card determined at step S124. Specifically, this CPU judges whether or not a predetermined combination is included in five cards consisting of the banker's cards 71, the player's cards 72, and the special card 70, and then, determines a winner or loser, based upon the judgment result.

Next, the CPU41 transmits the special card winner-loser information (step S127). Specifically, the CPU41 transmits, to the station 3, winner-loser information which is indicative of a winner or loser in the special card determined at step S126.

Next, the CPU41 transmits special-card payout information to the station 3 (step S128). The special card payout information is indicative of the quantity of credit (currency value) paid out to the players. Specifically, this CPU determines a jackpot payout type corresponding to a combination of cards disclosed at step S125 (see FIG. 58), and then, transmits information indicative of the credit corresponding to the determined jackpot payout type. When executing the processing of step S128, the CPU41 terminates main control unit processing.

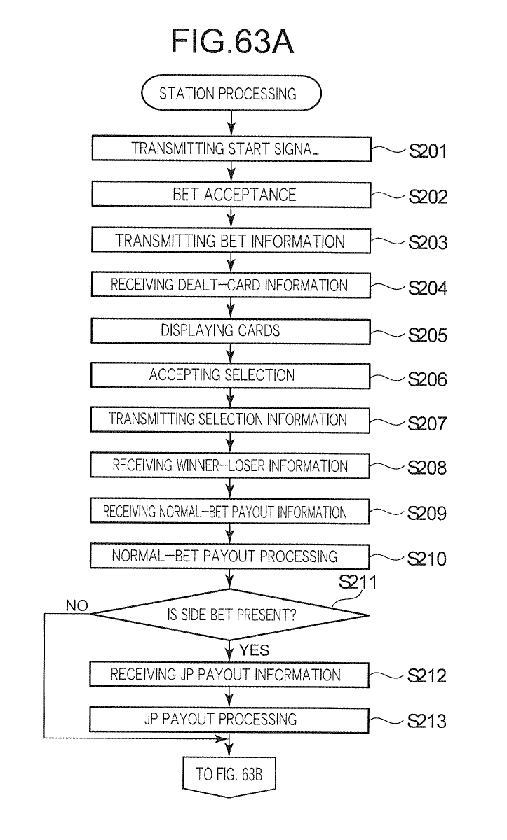

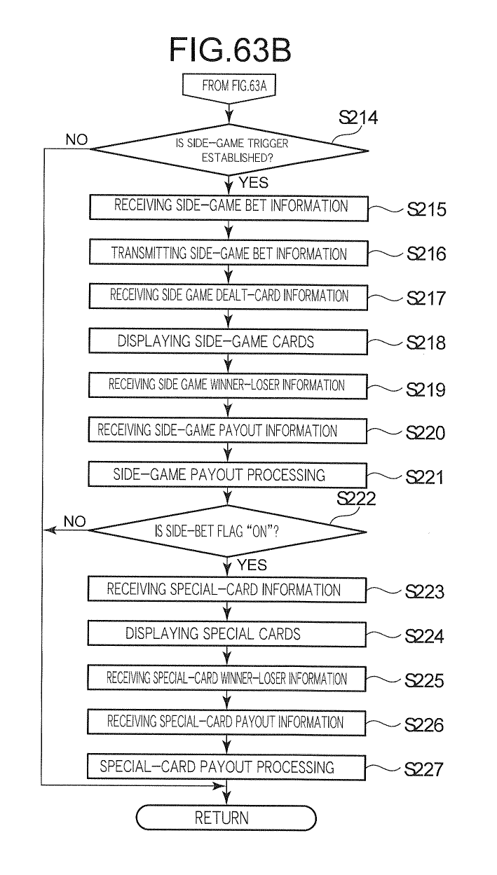

Next, the processing to be performed at the station 3 will be described in detail. FIGS. 63A and 63B are flowcharts each showing a subroutine of the station processing executed at each of the stations according to the eighth embodiment. In this processing operation, at first, the CPU51 included in the station 3 transmits a start signal to the main control unit 40 upon the receipt of signal indicative of the fact that a touch from the touch panel 11 has been sensed or that coin insertion has been detected from the entered-coin detecting section 68 (step S201). In this manner, at the main control unit 40, the processing operations shown in FIGS. 62A and 62B are conducted.

Next, the CPU51 accepts entries of the normal BET and side BET (step S202). This allows the player to enter the normal BET and the side BET via the touch panel 11 included in the station 3. Upon the receipt of a signal indicative of the fact that entry of the side BET has been made, the CPU51 sets a side-BET flag. This side-BET flag is set in a case where entry of the side BET has been made.

Next, the CPU51 transmits to the main control unit 40, BET information serving as information pertinent to an input BET (step S203). Upon the receipt of the BET information, the main control unit 40 determines cards to be dealt to the players and the banker (see step S104 of FIG. 62A).

Next, the CPU51 receives from the main control unit 40 the dealt-card information indicative of the cards after dealt to the players (step S204). Specifically, the CPU51 receives the dealt-card information transmitted at step S105 of FIG. 62A, and then, stores the received information in a RAM.

Next, the CPU51 displays cards (step S205). Specifically, the CPU51 displays a card image indicative of the seven player's cards at the dealt-card display section 83 of the liquid crystal display 10, based upon the dealt-card information received at step S204.

Next, the CPU51 accepts entry for selecting high hands and low hands (step S206). This allows the players to determine high hands and low hands from among the dealt cards by operating a high hand determination button 84 and a low hand determination button 85 via the touch panel 11.

Next, the CPU51 transmits to the main control unit 40 the selection information that is based upon selection of high hands and low hands (step S207). Upon the receipt of the selection information, the main control unit 40 determines a high hand and a low hand of the banker's cards, and then, executes processing of determining a winner or loser (see step S109 of FIG. 62A).

Next, the CPU51 receives winner-loser information from the main control unit 40 (step S208). Subsequently, the dealt-card display section 83 of the liquid crystal display 10 displays any one of the images inclusive of the messages “You Win”, “You Lose”, and “Draw”, during a predetermined period of time, based upon the received winner-loser information.

Next, the CPU51 receives normal-BET payout information from the main control unit 40 (step S209). Upon the receipt of the normal-BET payout information, the CPU51 stores in the RAM52 the credit data that is based upon the normal-BET payout information.

Next, the CPU51 receives normal-BET payout information, based upon the normal-BET payout information received at step S209 (step S210). In this normal-BET payout processing, in a case where a player has won, payout is performed, based upon information indicative of a credit of which amount is twice of that of the normal BET; and in a case where the result is “draw”, payout is performed, based upon information indicative of a credit of which amount is equal to that of the normal BET. In addition, in a case where the banker has won, information indicative of the fact that the amount of credit to be given is 0 is displayed.

Next, in FIG. 57B, the CPU51 judges whether or not entry of side BET has been made, while in the BET acceptance at step S202 (step S211). Specifically, the CPU51 judges whether or not a side-BET flag is set. When the CPU41 judges that entry of the side BET has not been made (step S211: NO), the routine proceeds to step S214.

On the other hand, upon judging that entry of the side BET has been made (step S211: YES), the CPU51 receives JP payout information (step S212). Specifically, the CPU51 receives JP payout information from the main control unit 40. Upon the receipt of the JP payout information, the CPU51 stores in the RAM52 the credit data that is based upon the JP payout information.

Next, the CPU51 executes JP payout processing (step S213). Specifically, the CPU51 pays out credit, based upon the JP payout information received at step S212.

Next, in FIG. 63B, the CPU51 judges whether or not a side-game trigger has been established (step S214). Specifically, the CPU51 judges whether or not the side-game trigger has been established at the main control unit 40. Upon judging that no side-game trigger has been established (step S214: NO), the CPU51 terminates station processing.

On the other hand, upon judging that the side-game trigger has been established (step S214: YES), the CPU51 accepts BET information (step S215). In this manner, the player can enter the normal BET and side BET via the touch panel 11 included in the station 3.

Next, the CPU51 transmits to the main control unit 40 the BET information pertinent to BETs for the entered side game (step S216). The main control unit 40 determines cards to be dealt to the player while in the side game upon the receipt of the side-game BET information (see step S117 of FIG. 62B).

Next, the CPU51 receives from the main control unit 40 the side game dealt-card information indicative of the cards after dealt to the players while in the side game (step S217). Specifically, the CPU51 receives the dealt-card information transmitted at step S117 of FIG. 62B.

Next, the CPU51 displays side game cards (step S218). Specifically, the CPU51 displays a card image indicative of the five player's side game cards at the side game dealt-card display section 75 of the liquid crystal display 10, based upon the side game card information received at step S218.

Next, the CPU51 receives the side game winner-loser information from the main control unit 40 (step S219). Next, the side game dealt-card display section 75 of the liquid crystal display 10 displays, for a predetermined duration, an image inclusive of any one of the messages “You Win”, “You Lose”, and “Draw”, based upon the received winner-loser information.

Next, the CPU51 receives the side-game payout information (step S220). Upon the receipt of the side-game payout information, the CPU51 stores in the RAM52 the credit data that is based upon the side-game payout information.

Next, the CPU51 executes side game payout processing, based upon the received side game payout information at step S220 (step S220). In this processing operation, where the player has won, payout is performed, based upon information which is indicative of the credit of which amount is twice of that of a normal BET; and where the result is “draw”, payout is performed, based upon information which is indicative of the credit of which amount is equal to that of the normal BET. Further, where the banker has won, information is displayed which is indicative of the fact that the amount of the credit to be paid out is 0.

Next, the CPU51 judges whether or not the side BET flag is ON (step S222). Specifically, the CPU51 judges whether or not the side BET flag is set. When judging that the side BET flag is not ON (step S222: NO), the CPU51 terminates station processing.

On the other hand, when judging that the side BET is ON (step S222: YES), the CPU51 receives special-card information (step S223). Specifically, the CPU51 receives the special-card information transmitted at step S124 of FIG. 62B.

Next, the CPU51 displays a special card (step S224). Specifically, the CPU51 causes the liquid crystal display to display a special card image, based upon the received special-card information at step S223 (see FIG. 59A).

Next, the CPU51 receives special-card winner-loser information (step S225). Specifically, the CPU51 causes the side game dealt-card display section 75 of the liquid crystal display 10 to display, for a predetermined period, a card combination image 77, which is indicative of any one of the card combinations “Royal Flush”, “Straight Flush”, “Four of a Kind”, “Full House”, “Flush”, “Straight”, “Three of a Kind”, “Two Pairs”, “One Pair”, and “No Pair”, based upon the received winner-loser information (see FIG. 59).

Next, the CPU51 receives special-card payout information from the main control unit 40 (step S226). Upon the receipt of the payout information, the CPU51 stores in a RAM52 the credit data that is based upon the payout information.

Next, the CPU51 performs special-card payout processing, based upon the received special-card payout processing information at step S225 (step S227). In this processing operation, in accordance with the above payout information, payout is executed based upon a card combination from among “Mini”, “Major”, and “Mega”. When terminating this processing operation, the CPU51 terminates station processing.

While the embodiment of the present invention described a case in which a side BET entry is accepted after a poker game is performed while in a side game, the liquid crystal display 10 displays a special card 70 dealt from among the cards displayed on the liquid crystal display 10 of another player, and then, based upon a card combination of two banker's cards, two player's cards, and one special card, one progressive payment is paid out from among a plurality of progressive payments, it is not limitative thereto. In a case where the side BET entry is accepted while in a basic game, on condition that the liquid crystal display 10 displays the special card 70 dealt from among the cards displayed on the liquid crystal display of another player, one progressive payment is paid out from among the plurality of progressive payments, based upon the card combination of two banker's cards, two player's cards, and one special card.

While the embodiment according to the present invention has been described, the description presents only some of the specific examples and is not intended to limit the present invention in any way and specific constructions of each means and the like can be properly changed in terms of design. Besides, the effects described in the embodiment of the present invention are only the most preferable effects generated from the present invention and the effects to be caused by the present invention is not limitative thereto.

1.-52. (canceled)

53. A game machine, comprising:
a plurality of first display devices provided corresponding to respective ones of a plurality of players;
a second display device provided in common to the plurality of players; and
a controller for controlling the first display devices and the second display device, the controller being programmed to:
(a) perform a basic game;
(b) display a predetermined number of players' cards on the first display devices and a plurality of banker's cards on the second display device, while in the basic game;
(c) pay out to a player a payment determined by comparing the players' cards and the banker's cards that are displayed in the step (b), while in the basic game;
(d) perform a side game in a case where a predetermined condition is met while in the basic game;
(e) display, on the first display devices, the plurality of cards dealt to the plurality of players, and display, on the second display device, the plurality of cards displayed on the first display device and possessed by the respective players, from among plural kinds of cards, while in the side game; and
(f) pay out to a player a payment determined by comparing the plurality of cards possessed by the players, the cards being displayed on the first display device, while in the side game.

54. The game machine according to claim 53, further comprising an input device for accepting an operation of a player, wherein:
the controller is programmed to accept, from the input device, entry of a side BET which is different from a normal BET, and wherein:
the controller accepts, from the input device, the entry of the side BET which is different from the normal BET, and pays out a payment to only a player having entered the side BET in the process (f).

55. The game machine according to claim 53, wherein:
the controller distributes and pays out a payment among all of the players having entered the side BETs, in the process (f).

56. The game machine according to claim 53, wherein:
the controller is programmed to: (h) execute a process of determining a player to whom a payment is given, from among the plurality of players; and wherein:
the controller, in the process (f), pays out a payment to the player determined in the process (h).

57. A game machine, comprising:
a plurality of first display devices provided corresponding to respective ones of a plurality of players;
a second display device provided in common by the plurality of players; and
a controller for controlling the first display devices and the second display device, the controller being programmed to:
(a) execute a basic game;
(b) display a predetermined number of players' cards on the first display devices and a predetermined number of banker's cards on the second display device while in the basic game;
(c) pay out to the players a payment determined by comparing the players' cards with the banker's cards displayed in the process (b) while in the basic game;
(d) execute a side game in a case where a predetermined condition is met while in the basic game;
(e) randomly determine a combination of cards, in which a payment is to be paid out, from among plural kinds of cards while in the side game, and then, display the randomly determined combination on at least either of each of the first display devices and the second display device;
(f) display, on the first display devices, a plurality of cards after dealt to the plurality of players from among plural kinds of cards, and then, display, on the second display device, the plurality of cards that are displayed on the first display devices and owned by the players, while in the side game; and
(g) pay out a payment, based upon a combination of the cards displayed in the process (e) in a case where the combination of the cards randomly determined and displayed in the process (e) is included in the plurality of cards owned by the players while in the side game.

58. The game machine according to claim 57, further comprising an input device for accepting operation of the players,
the controller being programmed to:
(h) accept entry of a side BET, which is different from a normal BET, from the input device, and then, pay out a payment to only players having entered the side BETs in the process (g).

59. The game machine according to claim 57, wherein:
the controller distributes and pays out a payment among all of the players having entered the side BET in the process (g).

60. The game machine according to claim 57, wherein:
the controller is programmed to (i) execute processing of determining a player to whom a payment is to be paid out, from among the plurality of players; and
the controller, in the process (g), pays out a payment to the players determined in the process (i).

61. The game machine according to claim 53, wherein:
the controller is further programmed to:
(g) display the players' cards on the first displays and the second display while in the side game;
(h) determine at least one special card dealt to each of the plurality of players, from the plural kinds of cards contained in the second card set data stored in the memory, and display the special cards dealt to each of the players on at least the first display devices of the corresponding players or the second display device; and
(i) pay out a payment to a player having a special card constituting a combination of the cards, in a case where combinations between the players' cards of the plurality of players displayed on the second display and the special cards of the players displayed on the second display include a predetermined card combination.

62. The game machine according to claim 61, wherein:
the controller is programmed to:
(j) determine a common card displayed in a predetermined region of the second display, from plural kinds of cards contained in the first card set; and
(k) display the determined common cards in the predetermined region of the second display device, and
the controller pays out a payment to a player having a special card which realizes a combination with a high payment, from among combinations of the cards, in a case where combinations between the special card and the common cards owned by the plurality of players include a predetermined card combination, in the process (i).

63. The game machine according to claim 61, further comprising an input device for accepting a side BET different from a normal BET from a player, wherein:
the controller determines the special cards dealt to both of a player not having accepted the side BET and a player having accepted the side BET, in the process (h); and
pays out a payment in order from a combination with a highest payment, from among combinations of the special card and the plurality of cards to the player having accepted the side BET from among the players having the special cards constituting combinations of the cards, in the process (i).

64. A game machine, comprising:
a plurality of display devices provided corresponding to respective ones of a plurality of players; and
a controller for controlling the display devices, the controller being programmed to:
(a) execute a basic game;
(b) display a predetermined number of player's cards on a first display device corresponding to a first player, and display a predetermined number of banker's cards on a banker's display device, from among the plurality of display devices, while in the basic game;
(c) execute a process of determining a winner or loser, by comparing hands of the player's cards with hands of the banker's cards, while in the basic game;
(d) execute a side game in a case where a predetermined condition is met while in the basic game;
(e) display a special card on the first display device, the special card being displayed while in the basic game performed by a second player on a second display device corresponding to the second player or provided in common to the plurality of players, from among the plurality of display devices, while in the side game; and
(f) perform a payout according to a combination, in a case where the combination of a predetermined number of cards, respectively, from among the player's cards and the banker's cards and the special card displayed on the first display device, is a predetermined combination.

65. The game machine according to claim 64, further comprising an input device for accepting a player's operation,
the controller being programmed to: (g) accept entry of a side BET which is different from a normal BET from the input device, and execute the side game, on condition that the entry of the side BET has been accepted from the input device, in the process (d).

66. The game machine according to claim 65, wherein:
the controller pays out one progressive payment from among a plurality of progressive payments, according to a kind of combination of: two of the player's cards and two of the banker's cards; and the special card displayed on the first display device, in the process (f).
